(19) United States
(12) Patent Application Publication
(10) Pub. No.: US 2019/0147721 A1
(43) Pub. Date: May 16, 2019

(54) PERSONAL EMERGENCY RESPONSE SYSTEM AND METHOD FOR IMPROVED SIGNAL INITIATION, TRANSMISSION, NOTIFICATION/ANNUNCIATION, AND LEVEL OF PERFORMANCE

(71) Applicant: LIVE CARE CORP., Brooklyn, NY (US)

(72) Inventors: PERI AVITAN, NEW YORK, NY (US); ROBERT J. BENETTI, ENCINITAS, CA (US); BRYAN T. BENETTTI, CARLSBAD, CA (US); ROBERT A. BENETTI, ENCINITAS, CA (US)

(21) Appl. No.: 15/608,972

(22) Filed: May 30, 2017

Related U.S. Application Data
(60) Provisional application No. 62/361,678, filed on Jul. 13, 2016.
(60) Provisional application No. 62/327,997, filed on Apr. 26, 2016.
(60) Provisional application No. 62/315,102, filed on Mar. 30, 2016.

(30) Foreign Application Priority Data
Mar. 29, 2017 (AU) PCTUS1724830

(51) Int. Cl. G08B 21/04; G06F 3/0488; G06F 3/0484; G09G 3/34; G06F 3/0482; H04R 3/04; G10L 21/0208

(52) U.S. Cl. CPC G08B 21/043; G08B 21/0446; G06F 3/04883; G06F 3/04845; G09G 2320/0626; G06F 3/0482; H04R 3/04; G10L 21/0208; G09G 3/34

(57) ABSTRACT

A portable medical emergency device capable of being worn around the neck of a user. The device has a touch screen, a microphone, a speaker, camera, GPS component, a mechanical button, and various processors and internal components that allow the device to remain m a dormant, low power mode until a pre-determined event occurs, and then interact with the user as needed to provide health care services.

The name of the U.S. Government agency and Government contract number (if the invention was made by an agency of the U.S. Government or under a contract with an agency of the U.S. Government):

N/A

LiveCare Corp.

Provisional Patent for an Emergency Call System

Authors: Peri Avitan, Robert J. Benetti, Bryan T. Benetti, and Robert A. Benetti

### OVERVIEW

Health Care Signaling Equipment (including Medical Alerts) Personal Emergency Response Equipment, Emergency Call Systems, and Hospital Signaling and Nurse Call Equipment comprise a wide range of individual components and systems that are used to electronically signal to another individual or caregiver, multiple individuals or caregivers, and/or a Central Station that they are in need of personal assistance or medical assistance for both routine and acute emergency situations in a wide range of environments, including:
Personal residences and their surrounding property.
During out of home excursions and travel.
During temporary or extended stays in assisted living and independent living facilities.
In hospitals and other acute care facilities.
Etc.

All of the above types of systems will be referred to herein as Emergency Call Systems (ECS).

An ECS is typically accompanied by a portable call initiation station (pendant) which may be handheld, body worn, or attached to a person's clothing. These pendants provide assistance request or emergency request signaling to the ECS and/or directly to a Central Station via wireless technology (RF, Wi-Fi, cellular, etc.). All of the various types of pendants will be referred to herein as ECS Pendants.

The various types of ECS and ECS Pendants are certified by domestic safety standards that are published by Underwriters Laboratory (UL) and similar international standards for various usages and operating environments:
a. UL 1637 Home Health Care Signaling Equipment.
b. UL 1698 Personal Emergency Response Equipment—(proposed standard)
c. UL 2560 Emergency Call Systems for Assisted Living and Independent Living Facilities.
d. UL 1069 Hospital Signaling and Nurse Call Equipment.

These standards have different safety and operational performance requirements for the various usage scenarios and operating environments. Please refer to FIG. 10 for the following discussion:

The dashed lines around the environments covered under UL 1637 and UL 1698 (proposed standard) represents that these environments are currently using ECS and/or ECS Pendants that communicate ECS signaling to another individual or individuals, caregivers, or a Central Station via the public switched telephone network (PSTN) or cellular network.

UL. 1637 Home Health Care Signaling Equipment

[The following was excerpted from UL 1637]

1 Scope

1.1 These requirements cover the individual units that comprise a home health care system intended for use in ordinary indoor residential locations.
[Note that this requirement specifically states “for use in ordinary indoor residential locations” with no allowance for outdoor use, or the multitude of complex environments that will be addressed in the proposed UL 1698 standard]

1.2 These requirements also cover a complete home health care system in which a signal initiating device (both routine monitoring and medical emergency signals) may be connected directly or indirectly to receiving equipment at a residence or to continuously monitored receiving equipment at a central supervising station. The system is arranged so that a predetermined change in the status of the signal initiating circuits or devices automatically causes transmission of a signal over a communication channel to receiving equipment at a residence, to a central supervising station, or to a private telephone number.
[Note that this requirement states: “transmission of a signal over a communication channel . . . ” with no definitive safety or performance requirements in the standard for communication over cellular networks which will be addressed in the proposed UL 1698 standard]

1.3 The components of the home health care system may include signal initiating devices, control units, transmitters, and digital communicators, all located at the residence, and the receiving, processing, and displaying equipment located at the central supervising station.
[Note that this requirement states: “may include signal initiating devices, control units, transmitters, and digital communicators, all located at the residence . . . ” with no definitive safety or performance requirements in the standard for devices used outside of the residence and communication over cellular networks which will be addressed in the proposed UL1698 standard]

UL 1698 Personal Emergency Response Equipment (Proposed)

[The following was excerpted from the proposed Scope for UL 1698]

Scope

Covers application, construction, and performance of equipment utilized in personal emergency response systems. The purpose of this standard is to define the means of signal initiation, transmission, notification and annunciation; level of performance; and the reliability of various types of personal emergency response systems. The standard also defines the features associated with these systems.
[This is a proposed UL standard that is currently under development and not yet published as of Mar. 29, 2016.
It is not specifically stated in the above Scope, however, the Scope will include the wide range of environments illustrated in FIG. 10, and include cellular communication and advanced locating technologies that includes GPS for: single and multilevel (aka multi-floor) personal residences, apartments, hotels, cities with high rise building, shopping malls, multistory buildings, multilevel and underground roadways and parking garages, rural areas, parks, recreation areas, traveling in vehicles, etc.]

UL 2560 Emergency Call Systems for Assisted Living and Independent Living Facilities
[Referring to FIG. 10 the solid line around the environments covered under UL 2560 represents that these environments are currently not using ECS Pendants for ECS signaling, two-way voice communication, and alarm clearing via PSTN, Internet, cellular network, or other method of communication to caregivers or a Central Station that are remotely located.]

[The following was excerpted from UL 2560]

1 Scope

1.1 These requirements cover the individual unit employed to form assisted and independent living emergency call systems (ECS) intended to provide audible and visual signaling between residents and assisted and independent living facility staff. Some examples include call initiation stations, call notification stations, and power supplies.
[Note that under the following section 40.2.1 b of UL 2560 (below) it states, “A required battery trouble call shall be transmitted to the receiver for a minimum of 7 days before the battery capacity of the transmitter has depleted to a level insufficient to maintain proper non-call operation of the transmitter.” There is also a battery life performance test under section 41.1.1 (see below) to ensure that the ECS Pedant meets this requirement. As such, by using a single low power RF transceiver and battery as in the current competitive product offerings it is not feasible to include two-way audio and/or videoconferencing capability into an ECS Pendant. The LiveCare™ ECS Pendant uses a novel dual transceiver/dual battery design that provides UL 2560 compliant ECS signaling and concurrent two-way audio and/or HIPAA compliant videoconferencing in the same ECS Pendant (see LiveCare™ ECS and LiveCare™ ECS Pendant, below)]

40.2.1 A primary battery is not prohibited from being used as the sole source of power for a low-power radio transmitter when all of the following conditions are met:
a) The capacity of the primary battery shall be monitored for integrity. The battery shall be monitored while loaded by:
   1) Transmission of the transmitter or
   2) A load equivalent to the load imposed by transmission.
b) A required battery trouble call shall be transmitted to the receiver for a minimum of 7 days before the battery capacity of the transmitter has depleted to a level insufficient to maintain proper non-call operation of the transmitter. It is acceptable for the battery trouble call at the call notification station to be initially delayed up to 24 hours.
c) The battery of a transmitter shall be capable of operating the transmitter in its normal supervisory mode and placing a single emergency call per day, each call remaining for 5 minutes before it is reset, for a published manufacturer specified length of time before the battery depletion threshold specified in (b) is reached.

41 Primary Batteries Test

41.1 Life Test

41.1.1 When a primary battery is used as the main source of power for a low power radio transmitter, it shall provide power to the unit under intended ambient conditions for the manufacturers specified battery life using the normal signaling performance as described in 40.2.1(c) and then operate the transmitter for a minimum of 7 days of trouble signal. Data on battery life, including discharge curves, shall be provided for the investigation to evaluate battery performance characteristics.

UL 1069 Hospital Signaling and Nurse Call Equipment
[Referring to FIG. 10 the solid line around the environments covered under UL 1069 represents that these environments are currently not using ECS Pendants for ECS signaling, two-way voice communication, and alarm clearing via the PSTN, internet, cellular network, or other method of communication to caregivers or a Central Station that are remotely located.]

1 Scope

1.1 These requirements cover the individual units employed to form a hospital nurse call system (NCS) intended to provide audible and visual communication between patients and hospital personnel. They also cover miscellaneous signaling equipment employed in hospitals. Some examples include bedside tables, annunciators, power supplies for nurse call systems, and gas monitoring units.
[Note that under the following section 49.2.1 b of UL 1069 (below) it states, “A required battery trouble call shall be transmitted to the receiver for a minimum of 7 days before the battery capacity of the transmitter has depleted to a level insufficient to maintain proper non-call operation of the transmitter.” There is also a battery life performance test under section 50.1.1 (see below) to ensure that the ECS Pedant meets this requirement. As such, by using a single low power RF transceiver and battery as in the current competitive product offerings it is not feasible to include two-way audio and/or videoconferencing capability into an ECS Pendant. The LiveCare™ ECS Pendant uses a novel dual transceiver/dual battery design that provides UL 2560 compliant ECS signaling and concurrent two-way audio and HIPAA compliant videoconferencing in the same ECS Pendant (see LiveCare™ ECS and LiveCare™ ECS Pendant, below)]

49.2 Primary Batteries

49.2.1 A primary battery is not prohibited from being used as the sole source of power for a low-power radio transmitter when all of the following conditions are met:
a) The capacity of the primary battery shall be monitored for integrity. The battery shall be monitored while loaded by:
   1) Transmission of the transmitter or
   2) A load equivalent to the load imposed by transmission.
b) A required battery trouble call shall be transmitted to the receiver for a minimum of 7 days before the battery capacity of the transmitter has depleted to a level insufficient to maintain proper non-call operation of the transmitter. It is acceptable for the battery trouble call at the Primary Nurse Control Station to be initially delayed up to 4 hours. The battery trouble annunciation shall be retransmitted at intervals not exceeding four hours until the battery is replaced.
c) The battery of a transmitter shall be capable of operating the transmitter for a published manufacturer specified length of time of normal annunciating service before the battery depletion threshold specified in (b) is reached.

50 Primary Batteries Test

50 added Oct. 12, 2007 issued Oct. 12, 2007

50.1 Life Test

50.1.1 When a primary battery is used as the main source of power for a low power radio transmitter, it shall provide power to the unit under intended ambient conditions for a manufacturer's published normal signaling service battery life and then operate the product for a minimum of 5 minutes of call, followed by 7 days of trouble signal. Data on battery life, including discharge curves, shall be provided for the investigation to evaluate battery performance characteristics.

Current ECS and ECS Pendant environments are shown in FIG. 10.

LiveCare™ ECS and LiveCare™ ECS Pendant

The LiveCare™ ECS and ECS Pendants incorporate novel design elements to provide both common and reconfigurable hardware and software that can provide domestic and international compliant ECS signaling for all usage scenarios and operating environments. In addition, the novel designs include advanced multiparty two-way audio conferencing for:
Communication with remote caregivers for ECS alarm clearing.
Consultations with remote caregivers.
Communication with remote family and friends.

The novel designs also include HIPAA compliant multiparty videoconferencing for:
Billable remote patient monitoring, performing audio and visual medical examinations, arid medical consultations.
Videoconferencing with remote family and friends as allowed in the particular environments.

Please refer to FIG. 11 for the following discussion:

The dashed lines around the environments covered under UL 1637, UL 1698 (proposed standard) UL 2560, and UL 1069 illustrate that the LiveCare™ ECS and ECS Pendants can communicate ECS signaling to other individuals, caregivers, or a Central Station receiving unit depending on the usage scenarios via the PSTN, Internet, cellular network, or by other communication methods. In addition, advanced multiparty two-way audio conferencing and HIPAA compliant multiparty videoconferencing is supported.

Simplified and Uniform Operation for Aging Seniors Across all Environments Seniors are constantly exposed to a barrage of emerging technologies that can overwhelm the aging brain, and are contending with diminishing manual dexterity and functionality of their nervous system and musculoskeletal physiology. The LiveCare™ ECS and ECS Pendants have a wide range of novel features and technical advancements to facilitate simplified uniform operation that improves the quality of life and extends independent living for as long as practical. The skill sets learned in their home and other environments will eventually transition with them into assisted living facilities and/or nursing homes, hospitals, or acute care facilities without having to relearn or simply give up on what can pose daunting mental and physical learning obstacles.

LiveCare™ ECS and LiveCare™ ECS Pendant environments are shown in FIG. 11.

Notable Features of the LiveCare™ ECS and LiveCare™ ECS Pendant

Notable Features address the following criteria:
Significant new/novel features.
Solves “long felt” market needs.
Compensates for the lack of important features on competitive products.
Achieves unexpectedly good results.

| # | Feature | Description And Feature-Associated Advantages |
|---|---|---|
| 1 | Medical Device Certification (the | The LiveCare ™ ECS and LiveCare ™ ECS Pendants are compliant with and |
| | LiveCare ™ ECS and LiveCare ™ ECS | certified by the following regulatory agencies as required: |
| | Pendants are not common cellphone or IT | Domestic and International Medical, Safety and EMC standards. |
| | peripherals) | MODS, FDA Class 1 medical device and associated global standards for |
| | | Remote Patient Monitoring. |
| | | FDA Class II medical device 510 K and associated global standards for |
| | | Active Patient Monitoring. |
| | | UL, AAMI and FCC: domestic certification. |
| | | EN/IEC: European/International. |
| | | CE/CB Scheme: International. |
| | | Continua International Certification. |
| | | Other regulatory certifications for global: medical, safety, and EMC |
| | | compliance. |
| 2 | LiveCare ™ ECS and LiveCare ™ ECS | The LiveCare ™ ECS and LiveCare ™ ECS Pendant incorporate novel |
| | Pendant that are herein described that are | design elements to provide both common and reconfigurable hardware and |
| | configurable and compliant with any | software that can provide domestic and international compliant ECS |
| | combination of the following domestic or | signaling for all usage scenarios and operating environments. In addition, |
| | equivalent international standards or their | the novel designs include advanced multiparty two-way audio |
| | derivative or successor standards: | conferencing for: |
| | UL 1637 Home Health Care Signaling | Communication with remote caregivers for ECS alarm clearing. |
| | Equipment | Consultations with remote caregivers. |
| | UL 1698 Personal Emergency Response | Communication with remote family and friends. |
| | Equipment | Multiparty two-way audio conferencing allows a remote caregiver to |
| | UL 2560 Emergency Call Systems for | quickly respond to an ECS event to determine if there is an acute |
| | Assisted Living and Independent | emergency or if the individual simply needs nonemergency assistance |
| | Living Facilities. | (drinking water, assistance standing or sitting, pain medications, assistance |
| | UL 1069 Hospital Signaling and Nurse | with personal hygiene, etc.). A responsible remote caregiver is also |
| | Call Equipment. | allowed by the standards to authorize that the ECS alarm be cleared if they |
| | Multiparty two-way audio | can determine through two-way audio communication that there isn't an |
| | conferencing. | acute emergency situation. This is especially important during the evening |
| | Multiparty HIPAA compliant | shift hours in assisted living facilities where an on-site nurse is not |
| | videoconferencing for use as a Class 1 | required, but must be available to respond to ECS signaling. This can |
| | MDDS device. | significantly reduce false alarms, and unnecessary travel. Multiparty two- |
| | | way audio conferencing can significantly improve user satisfaction with |
| | | improved response times, and reduce fatigue and stress while optimizing |
| | | the efficiency of facility staff. |
| | | Multiparty two-way audio conferencing can also permit translators to |
| | | participate on a call to significantly reduce travel, coordination of |
| | | schedules, etc. |
| | | The novel design also includes HIPAA compliant multiparty |
| | | videoconferencing for: |
| | | Billable remote patient monitoring, performing audio and visual medical |
| | | examinations, and medical consultations. |
| | | Videoconferencing with remote family and friends as allowed in the |
| | | particular environments. |
| | | Multiparty two-way videoconferencing is not required in the standards, but |
| | | provided in some embodiments. Multiparty two-way videoconferencing |
| | | allows remote caregivers, attending physicians, and medical specialists to |
| | | examine and consult with private individuals, assisted living residents, and |
| | | hospital or acute care patients without having to travel to the specific |
| | | location. Due to recently enacted legislation, this type of remote telehealth |
| | | service is also becoming a billable service for the physicians. As with |
| | | multiparty two-way audio conferencing, multiparty videoconferencing |
| | | improves customer satisfaction by having quick access to their physician or |
| | | specialist, and improves staff efficiency by reducing travel within and to |
| | | facilities. |
| | | An added benefit of providing audio and video conferencing is the ability to |
| | | visit with friends and family which can significantly improve user well- |
| | | being and satisfaction. |
| | | Novel Design: |
| | | Concurrent ECS signaling and multiparty two-way audio and video |
| | | conferencing requires a novel design to ensure adequate battery |
| | | performance that is required in the standards. ECS signaling requires long- |
| | | lasting batteries that can provide continued signaling up to 7 days after a |
| | | low battery condition has been detected. However, as every cell phone user |
| | | has experienced, several hours of audio communication or |
| | | videoconferencing can rapidly deplete batteries in less than 24 hours. As |
| | | such, LiveCare engineering has developed a novel dual radio transceiver |
| | | architecture with dual batteries to provide low power ECS signaling and a |
| | | separate wireless transceiver on a higher capacity rechargeable battery for |
| | | audio and video conferencing that can be recharged daily while the patient |
| | | sleeps. The larger capacity rechargeable battery also provides the ability to |
| | | provide a wide range of other features not normally available in a low |
| | | power ECS signaling pendant. |
| 3 | The LiveCare ™ ECS Pendant can also be | Novel senior cell phone with advanced cellular ECS signaling, multiparty |
| | used as a stand-alone senior cell phone | two-way audio conferencing, multiparty videoconferencing, and all of the |
| | with cellular ECS signaling and all of the | advanced features herein described. |
| | advanced features herein described. | |
| 4 | Simplified and Uniform Operation for | Seniors are constantly exposed to a barrage of emerging technologies that can |
| | Aging Seniors across all Environments | overwhelm the aging brain, and diminishing dexterity and functionality of |
| | | their nervous system and musculoskeletal physiology. The LiveCare ™ ECS |
| | | and ECS Pendants have a wide range of novel features and technical |
| | | advancements to facilitate simplified uniform operation that improves the |
| | | quality of life and extends independent living for as long as practical. The |
| | | skill sets learned in their home and outdoor environments will eventually |
| | | transition with them into assisted living facilities and/or nursing homes, |
| | | hospitals, or other acute care facilities without having to relearn or simply |
| | | give up on what otherwise can be daunting mental and physical learning |
| | | obstacles. Accordingly, the following features are incorporated into some |
| | | embodiments of the present invention: |
| | | Intuitive menu structures with simple voice or touchscreen activation. |
| | | Voice controlled and one button touchscreen calling for a preprogrammed |
| | | caregiver, friend, or family member. |
| | | Uniform menu structures to the degree allowed in the usage environments. |
| | | Automatic and voice controlled “Walking Light ™” |
| | | 24/7/365 assistance by voice control or help button activation depending on |
| | | usage environment. |
| | | Other advanced features herein described. |
| 5 | Accessibility features | For increased readability and reduced eyestrain. |
| 5a | ADA compliant character size and | Improves LCD visibility in indirect and direct sunlight, with a |
| | contrast adjustments | photosensor incorporated for automatic brightness control. |
| 5b | High intensity LED backlight for LCD | Controlled access for individuals authorized by the user. |
| | touchscreen with automatic brightness | |
| | control. | |
| 5c | Auto answer for voice and video calls | |
| | with no user intervention required. | |
| | Automatic and voice controlled | |
| | “Walking Light ™” | |
| | “Reading Light” | |
| | Wireless Hearing Aid Interface | |
| | Additional accessibility features herein | |
| | described. | |
| 6 | Advanced Telehealth features for remote | Multiparty HIPAA compliant videoconferencing for billable physician |
| | patient monitoring, examinations, and | services. |
| | consultations | User auto-answer for authorized users to simplify physician access to the |
| | | individual or patient. |
| | | Remote front/back camera selection control by the caregiver. |
| | | Remote inspection light intensity controls by the caregiver. |
| | | Novel physician point-of-view viewing for the user that is selected by the |
| | | caregiver. This allows the user to see on the LCD screen what the remote |
| | | caregivers sees for rapid positioning of the camera and real-time |
| | | consultation on observed symptoms such as: swelling, redness, infection, |
| | | etc. |
| | | Remote still frame and audio/video clip recording and file saving/archiving, |
| | | and file transfer control by the caregiver. |
| 7 | Always On and Always Ready ™ | Always turned on and ready to use with automatic boot-up, error recovery, |
| | | recovery from loss of Internet server, recovery from battery shutdown due |
| | | to excessive discharge, etc. |
| 8 | Hands-free voice controlled and | No mouse, keyboard, or joystick are required by the patient that may not |
| | touchscreen monitor | have sufficient reading or writing skills, physical capabilities, or mental |
| | | capabilities to operate a smart phone, tablet computer, laptop, or other |
| | | controlling/connecting device. |
| | | Industrial touchscreen for repeated heavy duty use. |
| 9 | Advanced audio system for clear | The audio teleconferencing features must be automatically adaptive and of |
| | communication. | sufficient fidelity and volume for clear communication over the distance |
| | | from the LiveCare ™ ECS Station to a patient in a bed, and in potentially a |
| | | high and variable ambient noise environment. |
| | | Hi-fidelity amplified speakers. |
| | | Automatic, local, and remote volume control based on ambient noise |
| | | monitoring, face recognition, infrared distance |
| | | measurements to the patient's head to adjust the audio volume. |
| | | Directional microphones with ambient noise monitoring and noise |
| | | cancellation for clear audio communication with remote |
| | | caregivers, translators, family, and friends. |
| | | Optional wireless headset with noise canceling microphone. |
| | | Wireless hearing aid interface. |
| | | Volume control via Tap Control ™ and Grunt Control ™ (see below) touch |
| | | screen, or remote volume control to ensure unstrained, clear |
| | | communication. |
| 10 | Multilingual voice recognition with | Due to significant difference in the quality of speech with Post-Acute Care |
| | vocabulary training | and Chronic Disease patients, vocabulary training is individualized for |
| | | each patient. |
| 11 | Weak or degraded voice and slurred | The voice of an elder becomes weaker and/or degrades over time. Patients |
| | speech recognition | may have weak or slurred speech from fatigue, illness, injury, medication |
| | | side effects, surgery, or stroke. |
| | | Directional microphones with ambient noise monitoring and active noise |
| | | cancellation to improve signal to noise on the weak or degraded sounds. |
| | | Optional wireless headset with noise canceling microphone. |
| | | Advanced speech recognition algorithms and custom vocabulary training. |
| | | Monitor displays video and audio prompts during vocabulary training. |
| | | Animated on-screen character provides encouragement and directions. |
| 12 | Tap Control ™ and Grunt Control ™ | Voice impaired individuals can interact with the system by tapping on an |
| | | object or desk, or vocally grunting (short and long guttural sounds) to |
| | | create audio feedback for the system. On-screen prompts guide the user on |
| | | their choices to interact with the system. |
| | | An animated on-screen character (see below) provides encouragement and |
| | | directions. |
| 13 | Hands-free multiparty videoconferencing | Voice control, Tap Control ™, or Grunt Control ™ |
| | | Hands-free call initiation and to answering calls for audioconference and |
| | | videoconferences. |
| | | Hands-free auto answer for authorized callers. |
| | | Optional wireless headset with noise canceling microphone. |
| | | Videoconference with caregiver and patient for billable medical services. |
| | | Several performance parameters (e.g. video resolution) can be |
| | | automatically adjusted during degraded Internet connectivity bandwidth |
| | | and/or during cellular Internet connection to maintain adequate |
| | | communication, or to limit data throughput for cost savings if required |
| 14 | Personalized animated on-screen character | An animated character on the computer monitor greets and interacts with |
| | to interact with the patient to answer | the patient, including animated eyes, eyelids, eyebrows, mouth, and |
| | questions, provide companionship, | numerous facial expressions: nurturing, happy, sad, laughing, concerned, |
| | training, read a book, entertain, etc. | etc. |
| | | The character's head and eyes track the face of the patient via face |
| | | recognition software and the RGB and 3D and infrared cameras to provide |
| | | a natural appearing interaction. |
| | | The character's mouth and facial features animate while talking. |
| | | While listening to the patient or visitors, the character will blink eyes |
| | | occasionally, and respond to directional sounds in a natural manner. |
| | | During inactivity, the character will look around, blink eyes, and respond to |
| | | directional sounds in a natural manner. |
| | | Includes a wide selection of preprogrammed animated male and female |
| | | characters, including, caregivers of several nationalities, children, teens, |
| | | adults, elderly, animals, etc. |
| | | A photograph of a patient's friend, relative, or pet can be animated by |
| | | LiveCare ™ ECS at a minimal cost for children, Alzheimer and dementia |
| | | patients to provide a comforting familiar face for interaction and |
| | | companionship. The animation file is downloaded to the LiveCare ™ ECS |
| | | Station without caregiver involvement. |
| 15 | Speech rehabilitation, training, and | Directional microphones with ambient noise monitoring and active noise |
| | monitoring of physician prescribed words | cancellation to improve signal to noise in high ambient noise environments. |
| | and phrases and associated training | Automatic active audio filters to attenuate unwanted or interfering audio |
| | schedule. | frequencies for optimal speech recognition. |
| | | Advanced speech recognition algorithms to score pronunciation accuracy |
| | | and sound intensity. |
| | | Monitor displays training progress. |
| | | On-screen animated character provides directions encouragement, and |
| | | humor. |
| | | Concurrent medical device monitoring if indicated. |
| | | Scoring algorithm to monitor daily progress for post review by medical |
| | | professional. |
| | | Automatic audio/video capture for post review and analysis by medical |
| | | professional. |
| 16 | Patient hearing screening | Hi-fidelity amplified speakers. |
| | | Automatic volume control based on ambient noise monitoring, face |
| | | recognition, and 3D infrared camera distance measurements to the patient's |
| | | head to adjust the audio volume for screening hearing tests. |
| | | Test tones can also be produced that are monitored by the directional |
| | | microphones to adjust the audio volume based on room acoustics and |
| | | ambient noise level. |
| | | Optional wireless headset with noise canceling microphone. |
| | | Scoring algorithm to monitor daily progress for post review by medical |
| | | professionals. |
| 17 | Vision screening and strength training | Face recognition algorithms, and 3D infrared camera distance |
| | | measurements to the patient's head to adjust the size of test images and |
| | | characters on the computer monitor for vision screening and strength |
| | | training. |
| | | Monitor displays video and audio prompts during the tests. Animated |
| | | character provides encouragement and directions. Scoring algorithm to |
| | | monitor daily progress for post review by medical professional. |
| 18 | Physical therapy rehabilitation and | 3D infrared camera and body/limb recognition software to monitor range of |
| | monitoring of physician or physical | motion and movement repetitions as per physician or physical therapist |
| | therapist prescribed exercises. | prescribed exercises. |
| | | Concurrent medical device monitoring, e.g. pulse rate, blood pressure, |
| | | oxygen saturation, respiration, ECG, etc. |
| | | Interface with strength building appliances. |
| | | Monitor displays training progress. |
| | | On-screen animated character provides directions encouragement, and |
| | | humor. |
| | | Scoring algorithm to monitor daily progress for post review by medical |
| | | professionals. |
| | | Automatic audio/video capture for post review and analysis by medical |
| | | professional. |
| 19 | Unusual Physical Activity Monitor | The 3D infrared projector/camera can clearly see the patient in complete |
| | | darkness or lighted conditions. |
| | | Threshold can be set to provide Nurse Call System, text messages, or email |
| | | alerts for unusual body movements, spasms, etc. during sleep and waking |
| | | activities. |
| | | Concurrent medical device monitoring if indicated. |
| | | Scoring algorithm to monitor daily unusual physical activity for post review |
| | | by medical professional. |
| | | Automatic audio/video capture for post review and analysis by medical |
| | | professional. |
| 20 | Patient Cognition Monitoring | Animated character can interact with and question the patient on a |
| | | therapist's prescribed routine schedule for expected answers, and provide |
| | | progress reports and alerts for responses exceeding therapist recommended |
| | | thresholds. |
| | | Scoring algorithm to monitor daily progress for post review by medical |
| | | professional. |
| | | Automatic audio/video capture for post review and analysis by medical |
| | | professional. |
| 21 | Patient Cognition Rehabilitation and | Protocols for post-surgery, anti-aging, Alzheimer, dementia, etc. |
| | Training | Animated character can interact with and question the patient on a |
| | | therapist's prescribed routine schedule, and provide progress reports and |
| | | alerts for responses exceeding therapist recommended thresholds. |
| | | Scoring algorithm to monitor daily progress for post review by medical |
| | | professional. |
| | | Automatic audio/video capture for post review and analysis by medical |
| | | professional. |
| 22 | LiveCare ™ ECS Sentinel | The 3D infrared projector/camera can clearly see the patient in complete |
| | | darkness or low light conditions during sleep. |
| | | If the patient wakes up and sits up (or other prescribed position) the |
| | | animated character can automatically activate and interact with and |
| | | question the patient to determine the mental state or other prescribe |
| | | response. |
| | | Based on physician presets the LiveCare ™ ECS Sentinel software can turn |
| | | on a night light for the patient to go to the bathroom, push an alert to the |
| | | Nurse Call System, take other prescribed actions, or tell the patient a |
| | | “bedtime” story, play soothing music, initiate Relaxation Training (see item |
| | | 18, below) to encourage restful sleep. |
| | | Concurrent medical device monitoring if indicated. |
| | | Scoring algorithm to monitor nocturnal patterns for post review by medical |
| | | professional. |
| | | Automatic audio/video capture for post review and analysis by medical |
| | | professional. |
| | | The system studies the behavior of the patient over time, and incorporates |
| | | this behavioral knowledge into the decision and scoring algorithm. |
| 23 | Relaxation and Anti-Anxiety Training | Wireless pulse rate sensor to monitor heart rate variability (HRV). |
| | | Animated character provides encouragement and directions to the patient. |
| | | Animated breathing pattern display with soothing audio instructions to |
| | | achieve a calm rhythmic breathing pattern. |
| | | On-screen progress indicators for real-time pulse rate, HRV, and associated |
| | | coherence scores. |
| | | Concurrent medical device monitoring if indicated. |
| | | Scoring algorithm to monitor HRV patterns and coherence scores for post |
| | | review by medical professional. |
| | | Automatic audio/video capture for post review and analysis by medical |
| | | professional. |
| 24 | Integrated examination lamp (luminaire) | Natural color rendering for a variety of examinations. |
| | with multiple locally and remotely | Uniform lighting of the examination field to minimize shadows. |
| | controlled dimming levels | Locally or remotely controlled color temperature and natural rendering of |
| | | tissue colors (surface and deep structures) for the specific examination |
| | | requirements by using a combination of LED colors. |
| | | Low heat radiation (infrared radiation). |
| | | Independent pan and tilt controls |
| | | Option for removing the lamp to mount on an optional stand for optimal |
| | | placement. |
| 25 | Integrated pan-tilt-zoom camera with auto | High-Definition (HD) camera with xlO or higher lossless zoom capability |
| | face tracking and remote control. | for close-up tissue inspections and eye examinations. |
| | | Auto tracking patient face or remotely controlled by the physician or |
| | | caregiver. |
| 26 | Optional pan-tilt monitor or charging base | Allows optimal monitor or display viewing angle for the patient in |
| | with auto face tracking and remote control. | reclining, sitting and standing positions |
| 27 | Interface to Nurse Call Systems | Push alerts as indicated (above). |
| | Distressed human sounds and unusual | Distressed human sounds and unusual ambient sound monitoring and |
| | ambient sound monitoring and ECS | automatic analysis for unattended ECS signaling, including but not limited |
| | signaling | to: |
| | | Crying |
| | | Moaning |
| | | Wailing |
| | | Gagging |
| | | Preprogrammed physician advised patterns |
| | | Shouting |
| | | Crashes, gunshots, explosions, vehicle crashes, strange dog barking, |
| | | personal assaults, etc. |
| 28 | Novel automatic and voice controlled | The National Institute of Health (NIH) reports the following on the NIH |
| | “Walking Light ™” feature for walking in | Senior Health website |
| | dimly lit areas | http://nihseniorhealth.gov/falls/aboutfalls/01.html |
| | | “More than one in three people age 65 years or older falls each year. The risk |
| | | of falling -- and fall-related problems -- rises with age. Each year, more |
| | | than 1.6 million older U.S. adults go to emergency departments for fall- |
| | | related injuries. Among older adults, falls are the number one cause of |
| | | fractures, hospital admissions for trauma, loss of independence, and injury |
| | | deaths.” |
| | | The NIH specifically recommends “to make sure that you have adequate light |
| | | is dark areas.” Aging seniors on fixed incomes routinely try to save money |
| | | by turning off lights at night. The nocturnal walk to and from the bathroom |
| | | or kitchen can lead to treacherous consequences. |
| | | Automatic walking and/or standing detection turns on down facing and |
| | | forward facing illumination with automatic brightness control. |
| 29 | Novel voice controlled “Reading Light ™” | Novel “Reading Light” with automatic and voice controlled brightness. |
| 30 | One button and voice controlled call for | 24/7/365 Technical Help line monitoring by LiveCare ™ ECS to assist the |
| | technical help. | caregiver in device connectivity, configuration, operation, and problem |
| | | resolution. |
| | | Facilitates nurse efficiency and training. |
| | | Full escalation from receptionist, trainer, support technician or engineer as |
| | | required. |

LiveCare™ ECS and LiveCare™ ECS Pendant Additional Features

The LiveCare™ ECS and LiveCare™ ECS Pendants are classified under Medical Device Data Systems (MODS) FDA Class I medical devices for remote patient monitoring as per:
DEPARTMENT OF HEALTH AND HUMAN SERVICES
Food and Drug Administration
21 CFR Part 880
[Docket No. FDA-2008-N-0106] (formerly Docket No. 2007N-0484)
Medical Devices; Medical Device Data Systems

The LiveCare™ ECS and LiveCare™ ECS Pendants are used to interface a wide range of wired and wireless biometric sensors and medical devices for remote patient monitoring in the Post-Acute Care and Chronic Disease Management markets in: nursing homes, assisted living homes, long term care, patient residences, and other similar environments. In addition, the LiveCare™ ECS and LiveCare™ ECS Pendants incorporate multiparty two-way audio and/or videoconferencing and other advanced features to facilitate billable doctor/patient consultations; remote nurse, caregiver, and family visitations; and embedded artificial intelligence for patient management and medical compliance.

Several performance parameters (e.g. video resolution) can be automatically adjusted during degraded Internet connectivity bandwidth and/or during cellular Internet connection to maintain adequate communications, or to limit data throughput for cost savings if required. The LiveCare™ ECS and LiveCare™ ECS Pendants can also interface to facility automation networks via ZigBee, Z-Wave, other wireless technologies, and/or the LAN.

The LiveCare™ ECS and LiveCare™ ECS Pendants are also intended for use as a FDA Class II medical device for “Active Patient Monitoring” under a FDA 510K submittal for use in hospital ICU and other critical medial environments.

Wireless charging base and example accessories are shown in FIGS. 12A-12F.

Industrywide Problem for Remote Patient Monitoring

There are numerous single parameter and multi-parameter biometric sensors and medical devices for remote patient monitoring. However, many different companies having incompatible proprietary firmware, software, and/or connecting hardware or software throughout their architectures from the remote medical device via the Internet Cloud to the caregiver's application software. In addition, the current gateways and hubs that interface the biometric sensors and medical devices to the Cloud were designed for remote patient monitoring in patient residences. As such, these devices are not suitable in multi-bed nursing homes to connect (pair) peripheral Bluetooth devices with multiple hubs that are in close proximity to each other and to other peripherals.

Typical problematic architecture is shown in FIG. 13.

Potential Problems of Connecting Peripheral Bluetooth Device with Multiple Hubs in Nursing Homes and Assisted Living Facilities

FIG. 14 illustrates the potential problems in nursing homes with connecting (pairing) peripheral Bluetooth devices with multiple hubs that in close proximity to each other and to other peripherals. The Bluetooth RF signals can travel up to 30 feet through air and walls which can complicate setup and assurance that the correct medical device is associated with a specific patient.

LiveCare™ ECS and LiveCare™ ECS Pendants Interface to a wide range of Biometric Sensors

The LiveCare™ ECS and LiveCare™ ECS Pendant are novel medical grade devices that interfaces a wide range wired and wireless biometric sensors and medical devices to the Cloud via redundant communication pathways. They include advanced features to allow use in multi-bed facilities or residences. The biometric sensors and medical devices that can be interfaced to the LiveCare™ ECS or LiveCare™ ECS Pendant include, but are not limited to the following:
Physical and/or Mental Activity Monitors
Blood Pressure Cuffs and Sensors
Blood Glucose Sensors and Systems (Glucometers)
Single and multi-lead ECG Patch
5 Lead ECG
12 Lead ECG
Dermascopes
Endoscopes
Ophthalmoscope
Otoscopes
Pulse Oximeters
Spirometers
Stethoscopes
Ultrasound Sensors and Systems
Weight Scales
Weight Scales and Body Composition Scales and Systems

Interfacing medical devices to the Cloud with the LiveCare™ ECS and LiveCare™ ECS Pendant are shown in FIG. 15.

LiveCare™ ECS and LiveCare™ ECS Pendants interface a wide range of OEM medical sensors and medical devices via multiple Cloud Portals as shown in FIG. 16.

Example Devices that interface with the LiveCare™ ECS or LiveCare™ ECS Pendant are shown in FIG. 17.

LiveCare™ ECS and LiveCare™ ECS Pendant integration with nurse call systems; standard nurse call system and current options as shown in FIG. 18.

LiveCare™ ECS and LiveCare™ ECS Pendant integration with medical devices and a nurse call system is shown in FIG. 19.

LiveCare™ ECS Pendant Concept Designs are shown in FIG. 20.

LiveCare™ ECS Pendant Concept, Skilled & Homecare are shown in FIG. 21.

LiveCare™ ECS Pendant Concept, Skilled is shown in FIG. 22.

LiveCare™ ECS Pendant Concept, Homecare is shown in FIG. 23.

LiveCare Corp.

Provisional Patent for an Emergency Call System

Authors: Peri Avitan, Robert J. Benetti, Bryan T. Benetti, and Robert A. Benetti

Overview

Health Care Signaling Equipment (including Medical Alerts) Personal Emergency Response Equipment, Emergency Call Systems, and Hospital Signaling and Nurse Call Equipment comprise a wide range of individual components and systems that are used to electronically signal to another individual or caregiver, multiple individuals or caregivers, and/or a Central Station that they are in need of personal assistance or medical assistance for both routine and acute emergency situations in a wide range of environments, including:
Personal residences and their surrounding property.
During out of home excursions and travel.
During temporary or extended stays in assisted living and independent living facilities.
In hospitals and other acute care facilities.
Etc.

All of the above types of systems will be referred to herein as Emergency Call Systems (ECS).

An ECS is typically accompanied by a portable call initiation station (pendant) which may be handheld, body worn, or attached to a person's clothing. These pendants provide assistance request or emergency request signaling to the ECS and/or directly to a Central Station via wireless technology (RF, Wi-Fi, cellular, etc.). All of the various types of pendants will be referred to herein as ECS Pendants.

The various types of ECS and ECS Pendants are certified by domestic safety standards that are published by Underwriters Laboratory (UL) and similar international standards for various usages and operating environments:
a. UL 1637 Home Health Care Signaling Equipment.
b. UL 1698 Personal Emergency Response Equipment—(proposed standard)
c. UL 2560 Emergency Call Systems for Assisted Living and Independent Living Facilities.
d. UL 1069 Hospital Signaling and Nurse Call Equipment.

These standards have different safety and operational performance requirements for the various usage scenarios and operating environments. Please refer to FIG. 10 for the following discussion:

The dashed lines around the environments covered under UL 1637 and UL 1698 (proposed standard) represents that these environments are currently using ECS and/or ECS Pendants that communicate ECS signaling to another individual or individuals, caregivers, or a Central Station via the public switched telephone network (PSTN) or cellular network.

UL. 1637 Home Health Care Signaling Equipment

[The following was excerpted from UL 1637]

1 Scope

1.1 These requirements cover the individual units that comprise a home health care system intended for use in ordinary indoor residential locations.
[Note that this requirement specifically states “for use in ordinary indoor residential locations” with no allowance for outdoor use, or the multitude of complex environments that will be addressed in the proposed UL 1698 standard]

1.2 These requirements also cover a complete home health care system in which a signal initiating device (both routine monitoring and medical emergency signals) may be connected directly or indirectly to receiving equipment at a residence or to continuously monitored receiving equipment at a central supervising station. The system is arranged so that a predetermined change in the status of the signal initiating circuits or devices automatically causes transmission of a signal over a communication channel to receiving equipment at a residence, to a central supervising station, or to a private telephone number.
[Note that this requirement states: “transmission of a signal over a communication channel . . . ” with no definitive safety or performance requirements in the standard for communication over cellular networks which will be addressed in the proposed UL 1698 standard]

1.3 The components of the home health care system may include signal initiating devices, control units, transmitters, and digital communicators, all located at the residence, and the receiving, processing, and displaying equipment located at the central supervising station.
[Note that this requirement states: “may include signal initiating devices, control units, transmitters, and digital communicators, all located at the residence . . . ” with no definitive safety or performance requirements in the standard for devices used outside of the residence and communication over cellular networks which will be addressed in the proposed UL1698 standard]

UL 1698 Personal Emergency Response Equipment (proposed)
[The following was excerpted from the proposed scope for UL 1698]

Scope

Covers application, construction, and performance of equipment utilized in personal emergency response systems. The purpose of this standard is to define the means of signal initiation, transmission, notification and annunciation; level of performance; and the reliability of various types of personal emergency response systems. The standard also defines the features associated with these systems.
[This is a proposed UL standard that is currently under development and not yet published as of Mar. 29, 2016.
It is not specifically stated in the above Scope, however, the Scope will include the wide range of environments illustrated in FIG. 10, and include cellular communication and advanced locating technologies that includes GPS for: single and multilevel (aka multi-floor) personal residences, apartments, hotels, cities with high rise building, shopping malls, multistory buildings, multilevel and underground roadways and parking garages, rural areas, parks, recreation areas, traveling in vehicles, etc.]

UL 2560 Emergency Call Systems for Assisted Living and independent Living Facilities
[Referring to FIG. 10 the solid line around the environments covered under UL 2560 represents that these environments are currently not using ECS Pendants for ECS signaling, two-way voice communication, and alarm clearing via PSTN, Internet, cellular network, or other method of communication to caregivers or a Central Station that are remotely located.]
[The following was excerpted from UL 2560]

1 Scope

1.1 These requirements cover the individual unit employed to form assisted and independent living emergency call systems (ECS) intended to provide audible and visual signaling between residents and assisted and independent living facility staff. Some examples include call initiation stations, call notification stations, and power supplies.
[Note that under the following section 40.2.1 b of UL 2560 (below) it states, “A required battery trouble call shall be transmitted to the receiver for a minimum of 7 days before the battery capacity of the transmitter has depleted to a level insufficient to maintain proper non-call operation of the transmitter.” There is also a battery life performance test under section 41.1.1 (see below) to ensure that the ECS Pedant meets this requirement. As such, by using a single low power RF transceiver and battery as in the current competitive product offerings it is not feasible to include two-way audio and/or videoconferencing capability into an ECS Pendant. The LiveCare™ ECS Pendant uses a novel dual transceiver/dual battery design that provides UL 2560 compliant ECS signaling and concurrent two-way audio and/or HIPAA compliant videoconferencing in the same ECS Pendant (see LiveCare™ ECS and LiveCare™ ECS Pendant, below)]

40.2.1 A primary battery is not prohibited from being used as the sole source of power for a low-power radio transmitter when all of the following conditions are met:
a) The capacity of the primary battery shall be monitored for integrity. The battery shall be monitored while loaded by:
   1) Transmission of the transmitter or
   2) A load equivalent to the load imposed by transmission.
b) A required battery trouble call shall be transmitted to the receiver for a minimum of 7 days before the battery capacity of the transmitter has depleted to a level insufficient to maintain proper non-call operation of the transmitter. It is acceptable for the battery trouble call at the call notification station to be initially delayed up to 24 hours.
c) The battery of a transmitter shall be capable of operating the transmitter in its normal supervisory mode and placing a single emergency call per day, each call remaining for 5 minutes before it is reset, for a published manufacturer specified length of time before the battery depletion threshold specified in (b) is reached.

41 Primary Batteries Test

41.1 Life Test

41.1.1 When a primary battery is used as the main source of power for a low power radio transmitter, it shall provide power to the unit under intended ambient conditions for the manufacturers specified battery life using the normal signaling performance as described in 40.2.1(c) and then operate the transmitter for a minimum of 7 days of trouble signal. Data on battery life, including discharge curves, shall be provided for the investigation to evaluate battery performance characteristics.

UL 1069 Hospital Signaling and Nurse Call Equipment
[Referring to FIG. 10 the solid line around the environments covered under UL 1069 represents that these environments are currently not using ECS Pendants for ECS signaling, two-way voice communication, and alarm clearing via the PSTN, internet, cellular network, or other method of communication to caregivers or a Central Station that are remotely located.]

Scope

1.1 These requirements cover the individual units employed to form a hospital nurse call system (NCS) intended to provide audible and visual communication between patients and hospital personnel. They also cover miscellaneous signaling equipment employed in hospitals. Some examples include bedside tables, annunciators, power supplies for nurse call systems, and gas monitoring units.

[Note that under the following section 49.2.1 b of UL 1069 (below) it states, “A required battery trouble call shall be transmitted to the receiver for a minimum of 7 days before the battery capacity of the transmitter has depleted to a level insufficient to maintain proper non-call operation of the transmitter.” There is also a battery life performance test under section 50.1.1 (see below) to ensure that the ECS Pedant meets this requirement. As such, by using a single low power RF transceiver and battery as in the current competitive product offerings it is not feasible to include two-way audio and/or videoconferencing capability into an ECS Pendant. The LiveCare™ ECS Pendant uses a novel dual transceiver/dual battery design that provides UL 2560 compliant ECS signaling and concurrent two-way audio and HIPAA compliant videoconferencing in the same ECS Pendant (see LiveCare™ ECS and LiveCare™ ECS Pendant, below)]

49.2 Primary Batteries

49.2.1 A primary battery is not prohibited from being used as the sole source of power for a low-power radio transmitter when all of the following conditions are met:
a) The capacity of the primary battery shall be monitored for integrity. The battery shall be monitored while loaded by:
   1) Transmission of the transmitter or
   2) A load equivalent to the load imposed by transmission.
b) A required battery trouble call shall be transmitted to the receiver for a minimum of 7 days before the battery capacity of the transmitter has depleted to a level insufficient to maintain proper non-call operation of the transmitter. It is acceptable for the battery trouble call at the Primary Nurse Control Station to be initially delayed up to 4 hours. The battery trouble annunciation shall be retransmitted at intervals not exceeding four hours until the battery is replaced.
c) The battery of a transmitter shall be capable of operating the transmitter for a published manufacturer specified length of time of normal annunciating service before the battery depletion threshold specified in (b) is reached.

50 Primary Batteries Test

50 added Oct. 12, 2007 issued Oct. 12, 2007

50.1 Life Test

50.1.1 When a primary battery is used as the main source of power for a low power radio transmitter, it shall provide power to the unit under intended ambient conditions for a manufacturer's published normal signaling service battery life and then operate the product for a minimum of 5 minutes of call, followed by 7 days of trouble signal. Data on battery life, including discharge curves, shall be provided for the investigation to evaluate battery performance characteristics.

Current ECS and ECS Pendant environments are shown in FIG. 10

LiveCare™ ECS and LiveCare™ ECS Pendant

The LiveCare™ ECS and ECS Pendants incorporate novel design elements to provide both common and reconfigurable hardware and software that can provide domestic and international compliant ECS signaling for all usage scenarios and operating environments. In addition, the novel designs include advanced multiparty two-way audio conferencing for:
Communication with remote caregivers for ECS alarm clearing.
Consultations with remote caregivers.
Communication with remote family and friends.

The novel designs also include HIPAA compliant multiparty videoconferencing for:
Billable remote patient monitoring, performing audio and visual medical examinations, arid medical consultations.
Videoconferencing with remote family and friends as allowed in the particular environments.

Please refer to FIG. 11 for the following discussion:

The dashed lines around the environments covered under UL 1637, UL 1698 (proposed standard) UL 2560, and UL 1069 illustrate that the LiveCare™ ECS and ECS Pendants can communicate ECS signaling to other individuals, caregivers, or a Central Station receiving unit depending on the usage scenarios via the PSTN, Internet, cellular network, or by other communication methods. In addition, advanced multiparty two-way audio conferencing and HIPAA compliant multiparty videoconferencing is supported.

Simplified and Uniform Operation for Aging Seniors Across all Environments

Seniors are constantly exposed to a barrage of emerging technologies that can overwhelm the aging brain, and are contending with diminishing manual dexterity and functionality of their nervous system and musculoskeletal physiology. The LiveCare™ ECS and ECS Pendants have a wide range of novel features and technical advancements to facilitate simplified uniform operation that improves the quality of life and extends independent living for as long as practical. The skill sets learned in their home and other environments will eventually transition with them into assisted living facilities and/or nursing homes, hospitals, or acute care facilities without having to relearn or simply give up on what can pose daunting mental and physical learning obstacles.

LiveCare™ ECS and LiveCare™ ECS Pendant environments are shown in FIG. 11.

Notable Features of the LiveCare™ ECS and LiveCare™ ECS Pendant

Notable Features address the following criteria:
Significant new/novel features.
Solves “long felt” market needs.
Compensates for the lack of important features on competitive products.
Achieves unexpectedly good results.

| # | Feature | Description And Feature-Associated Advantages |
|---|---|---|
| 1 | Medical Device Certification (the | The LiveCare ™ ECS and LiveCare ™ ECS Pendants are compliant with and |
| | LiveCare ™ ECS and LiveCare ™ ECS | certified by the following regulatory agencies as required: |
| | Pendants are not common cellphone or IT | Domestic and International Medical, Safety and EMC standards. |
| | peripherals) | MDDS, FDA Class 1 medical device and associated global standards |
| | | for Remote Patient Monitoring. |
| | | FDA Class II medical device 510 K and associated global standards for |
| | | Active Patient Monitoring. |
| | | UL, AAMI and FCC: domestic certification. |
| | | EN/IEC: European/lnternational. |
| | | CE/CB Scheme: International. |
| | | Continua International Certification. |
| | | Other regulatory certifications for global: medical, safety, and EMC |
| | | compliance. |
| 2 | LiveCare ™ ECS and LiveCare ™ ECS | The LiveCare ™ ECS and LiveCare ™ ECS Pendant incorporate novel |
| | Pendant that are herein described that are | design elements to provide both common and reconfigurable hardware and |
| | configurable and compliant with any | software that can provide domestic and international compliant ECS |
| | combination of the following domestic or | signaling for all usage scenarios and operating environments. In addition, |
| | equivalent international standards or their | the novel designs include advanced multiparty two-way audio conferencing |
| | derivative or successor standards: | for: |
| | UL 1637 Home Health Care Signaling | Communication with remote caregivers for ECS alarm clearing. |
| | Equipment | Consultations with remote caregivers. |
| | UL 1698 Personal Emergency Response | Communication with remote family and friends. |
| | Equipment | Multiparty two-way audio conferencing allows a remote caregiver and/or |
| | UL 2560 Emergency Call Systems for | Central Station to quickly respond to an ECS event to determine if there is |
| | Assisted Living and Independent Living | an acute emergency or if the individual simply needs nonemergency |
| | Facilities. | assistance (drinking water, assistance standing or sitting, pain medications, |
| | UL 1069 Hospital Signaling and Nurse | assistance with personal hygiene, etc.). A responsible remote caregiver is |
| | Call Equipment. | also allowed by the standards to authorize that the ECS alarm be cleared if |
| | Multiparty two-way audio conferencing. | they can determine through two-way audio communication that there isn't an |
| | Multiparty HIPAA compliant | acute emergency situation. This is especially important during the evening |
| | videoconferencing for use as a Class 1 | shift hours in assisted living facilities where an on-site nurse is not required, |
| | MDDS device. | but must be available to respond to ECS signaling. This can significantly |
| | Other non-certified uses and | reduce false alarms, and unnecessary travel. Multiparty two-way audio |
| | environments. | conferencing can significantly improve user satisfaction with improved |
| | | response times, and reduce fatigue and stress while optimizing the efficiency |
| | | of facility staff. |
| | | Multiparty two-way audio conferencing can also permit translators to |
| | | participate on a conference call to significantly reduce travel, coordination |
| | | of schedules, etc. |
| | | The novel design also includes HIPAA compliant multiparty |
| | | videoconferencing for: |
| | | Billable remote patient monitoring, performing audio and visual medical |
| | | examinations, and medical consultations. |
| | | Videoconferencing with remote family and friends as allowed in the |
| | | particular environments. |
| | | Multiparty two-way videoconferencing is not required in the standards, but |
| | | provided in some embodiments. Multiparty two-way videoconferencing |
| | | allows remote caregivers, attending physicians, and medical specialists to |
| | | examine and consult with private individuals, assisted living residents, |
| | | and hospital or acute care patients without having to travel to the specific |
| | | location. Due to recently enacted legislation, this type of remote telehealth |
| | | service is also becoming a billable service for the physicians. As with |
| | | multiparty two-way audio conferencing, multiparty videoconferencing |
| | | improves customer satisfaction by having quick access to their physician |
| | | or specialist, and improves staff efficiency by reducing travel within and |
| | | to facilities. |
| | | An added benefit of providing audio and video conferencing is the ability |
| | | to visit with friends and family which can significantly improve user well- |
| | | being and satisfaction. |
| | | Novel Designs: |
| | | Concurrent ECS signaling and multiparty two-way audio and video |
| | | conferencing requires a novel design to ensure adequate battery |
| | | performance that is required in the standards. ECS signaling |
| | | requires long-lasting batteries that can provide continued signaling |
| | | up to 7 days after a low battery condition has been detected. |
| | | However, as every cell phone user has experienced, several hours of |
| | | audio communication or videoconferencing can rapidly deplete |
| | | batteries in less than 24 hours. As such, LiveCare engineering has |
| | | developed a novel dual radio transceiver architecture with dual |
| | | batteries to provide low power ECS signaling that is powered from a |
| | | primary or secondary battery, and a separate wireless transceiver on |
| | | a higher capacity rechargeable battery for audio and video |
| | | conferencing that can be recharged daily while the patient sleeps. |
| | | The larger capacity rechargeable battery also provides the ability to |
| | | provide a wide range of other features not normally available in a |
| | | low power ECS signaling pendant such as a touchscreen, “Walking |
| | | LightTM”, “Reading LightTM”, high power audio amplifier, etc. |
| | | LiveCare engineering has also developed a novel architecture with ECS |
| | | signaling and multiparty two-way audio and video conferencing that |
| | | operates from a single high capacity rechargeable battery. Advanced battery |
| | | fuel gauge monitoring with associated battery aging analysis software |
| | | allows concurrent ECS signaling and multiparty two-way audio and video |
| | | conferencing (and other high power features) wherein two-way |
| | | videoconferencing and other non-critical function are suspended at low |
| | | battery reserve levels to allow continued signaling with continued two-way |
| | | audio conferencing. At lower battery discharge levels, two-way audio |
| | | conferencing and other noncritical functions are suspended to allow |
| | | continued signaling up to 7 days after a lower battery condition has been |
| | | detected. |
| | | Automatic user, caregiver, and/or Central Station notifications at the |
| | | various battery discharge states. |
| 3 | The LiveCare ™ ECS Pendant can also be | Novel senior cell phone with advanced cellular ECS signaling, multiparty |
| | used as a stand-alone senior cell phone | two-way audio conferencing, multiparty videoconferencing, and all of the |
| | with cellular ECS signaling and all of the | advanced features herein described. |
| | advanced features herein described. | |
| 4 | Simplified and Uniform Operation for | Seniors are constantly exposed to a barrage of emerging technologies that can |
| | Aging Seniors across all Environments | overwhelm the aging brain, and diminishing dexterity and functionality of |
| | | their nervous system and musculoskeletal physiology. The LiveCare ™ ECS |
| | | and ECS Pendants have a wide range of novel features and technical |
| | | advancements to facilitate simplified uniform operation that improves the |
| | | quality of life and extends independent living for as long as practical. The |
| | | skill sets learned in their home and outdoor environments will eventually |
| | | transition with them into assisted living facilities and/or nursing homes, |
| | | hospitals, or other acute care facilities without having to relearn or simply |
| | | give up on what otherwise can be daunting mental and physical learning |
| | | obstacles. Accordingly, the following features are incorporated into some |
| | | embodiments of the present invention: |
| | | Intuitive menu structures with simple voice or touchscreen activation. |
| | | Voice controlled and one button touchscreen calling for a preprogrammed |
| | | caregiver, friend, or family member. |
| | | Uniform menu structures to the degree allowed in the usage environments. |
| | | Automatic and voice controlled “Walking Light ™” and/or “Reading |
| | | Light ™”. |
| | | Local or remote suppression of local camera picture-in-picture for “camera |
| | | shy” seniors. |
| | | Local or remote suppression of local camera picture-in-picture for |
| | | permitting unobstructed viewing of the remote video feed or remote |
| | | screen shared image. |
| | | Advanced face and eye tracking with visual feedback to ensure that the |
| | | individuals face is in view during suppression of local camera picture-in- |
| | | picture. The user positions the LiveCare ™ ECS Pendant in front of their |
| | | face until a visual indicator illuminates to indicate that the remote caregiver |
| | | can see their face in the camera view. |
| | | 24/7/365 assistance by voice control or help button activation depending |
| | | on usage environment. |
| | | Other advanced features herein described. |
| 5 | Accessibility features | For increased readability and reduced eyestrain. |
| 5a | ADA compliant character size and | Improves LCD visibility in indirect and direct sunlight, with a photosensor |
| | contrast adjustments | incorporated for automatic brightness control. |
| 5b | High intensity LED backlight for LCD | Controlled access for individuals authorized by the user. |
| | touchscreen with automatic brightness | For hearing impaired individuals and high ambient noise |
| | control. | environments. |
| 5c | Auto answer for voice and video calls | |
| | with no user intervention required. | |
| | High power audio amplifier and | |
| | speaker. | |
| | Automatic and voice controlled | |
| | “Walking Light ™” | |
| | “Reading Light ™” | |
| | Wireless Hearing Aid Interface | |
| | Additional accessibility features herein | |
| | described. | |
| 6 | Advanced Telehealth features for remote | Multiparty HIPAA compliant videoconferencing for billable physician |
| | patient monitoring, examinations, and | services. |
| | consultations | User auto-answer for authorized users to simplify physician access to the |
| | | individual or patient. |
| | | Remote front/back camera selection control by the caregiver. |
| | | Remote inspection light intensity controls by the caregiver. |
| | | Novel physician point-of-view viewing for the user that is selected by the |
| | | caregiver. This allows the user to see on the LCD screen what the remote |
| | | caregivers sees for rapid positioning of the camera and real-time |
| | | consultation on observed symptoms such as: swelling, redness, infection, |
| | | etc. |
| | | Remote suppression of local camera picture-in-picture for unobstructed |
| | | viewing of the remote video feed or remote screen shared image. Advanced |
| | | face and eye tracking with visual feedback to ensure that the individuals |
| | | face is in view during suppression of local camera picture-in-picture. The |
| | | user positions the LiveCare ™ ECS Pendant in front of their face until a |
| | | visual indicator illuminates to indicate that the remote caregiver can see |
| | | their face in the camera view. |
| | | Remote still frame and audio/video clip recording and file saving/archiving, |
| | | and file transfer control by the caregiver. |
| 7 | Always On and Always Ready ™ | Always turned on and ready to use with automatic boot-up, error recovery, |
| | | recovery from loss of Internet server, recovery from battery shutdown due |
| | | to excessive discharge, etc. |
| 8 | Hands-free voice controlled and | No mouse, keyboard, or joystick are required by the patient that may not |
| | touchscreen monitor | have sufficient reading or writing skills, physical capabilities, or mental |
| | | capabilities to operate a smart phone, tablet computer, laptop, or other |
| | | controlling/connecting device. |
| | | Industrial touchscreen for repeated heavy duty use. |
| 9 | Advanced audio system for clear | The audio teleconferencing features must be automatically adaptive and of |
| | communication. | sufficient fidelity and volume for clear communication over the distance |
| | | from the LiveCare ™ ECS Station to a patient in a bed, and in potentially a |
| | | high and variable ambient noise environment. |
| | | Hi-fidelity amplified speakers. |
| | | Automatic, local, and remote volume control based on ambient noise |
| | | monitoring, face recognition, infrared distance measurements to the |
| | | patient's head to adjust the audio volume. |
| | | Directional microphones with ambient noise monitoring and noise |
| | | cancellation for clear audio communication with remote caregivers, |
| | | translators, family, and friends. |
| | | Microphones are more susceptible to damage from high humidity or water |
| | | damage. Redundant microphones are incorporated for high reliability voice |
| | | commands features, two-way audio conferencing, and videoconferencing. |
| | | Optional wireless headset with noise canceling microphone. |
| | | Wireless hearing aid interface. |
| | | Volume control via Tap Control ™ and Grunt Control ™ (see below) touch |
| | | screen, or remote volume control to ensure unstrained, clear |
| | | communication. |
| | | High power audio amplifier and compatible speaker or speakers for hearing |
| | | impaired individuals and high ambient noise environments. |
| | | Speakers are more susceptible to damage from high humidity or water |
| | | damage. Redundant audio amplifiers and/or speakers are incorporated for |
| | | high reliability audio notifications, speech functions, two-way audio |
| | | conferencing, and videoconferencing. |
| 10 | Multilingual voice recognition with | Due to significant difference in the quality of speech with Post-Acute Care |
| | vocabulary training | and Chronic Disease patients, vocabulary training is individualized for each |
| | | patient. |
| 11 | Weak or degraded voice and slurred | The voice of an elder becomes weaker and/or degrades overtime. Patients |
| | speech recognition | may have weak or slurred speech from fatigue, illness, injury, medication |
| | | side effects, surgery, or stroke. |
| | | Directional microphones with ambient noise monitoring and active noise |
| | | cancellation to improve signal to noise on the weak or degraded sounds. |
| | | Optional wireless headset with noise canceling microphone. |
| | | Advanced speech recognition algorithms and custom vocabulary training. |
| | | Monitor displays video and audio prompts during vocabulary training. |
| | | Animated on-screen character provides encouragement and directions. |
| 12 | Tap Control ™ and Grunt Control ™ | Voice impaired individuals can interact with the system by tapping on an |
| | | object or desk, or vocally grunting (short and long guttural sounds) to |
| | | create audio feedback for the system. On-screen prompts guide the user on |
| | | their choices to interact with the system. |
| | | An animated on-screen character (see below) provides encouragement and |
| | | directions. |
| 13 | Hands-free multiparty videoconferencing | Voice control, Tap Control ™, or Grunt Control ™ |
| | | Hands-free call initiation and to answering calls for audioconference and |
| | | videoconferences. |
| | | Hands-free auto answer for authorized callers. |
| | | Optional wireless headset with noise canceling microphone. |
| | | Videoconference with caregiver and patient for billable medical services. |
| | | Several performance parameters (e.g. video resolution) can be automatically |
| | | adjusted during degraded Internet connectivity bandwidth and/or during |
| | | cellular Internet connection to maintain adequate communication, or to |
| | | limit data throughput for cost savings if required. |
| 14 | Personalized animated on-screen | An animated character on the computer monitor greets and interacts with the |
| | character to interact with the patient to | patient, including animated eyes, eyelids, eyebrows, mouth, and numerous |
| | answer questions, provide | facial expressions: nurturing, happy, sad, laughing, concerned, etc. |
| | companionship, training, read a book, | The character's head and eyes track the face of the patient via face |
| | entertain, etc. | recognition software and the RGB and 3D and infrared cameras to provide |
| | | a natural appearing interaction. |
| | | The character's mouth and facial features animate while talking. |
| | | While listening to the patient or visitors, the character will blink eyes |
| | | occasionally, and respond to directional sounds in a natural manner. |
| | | During inactivity, the character will look around, blink eyes, and respond to |
| | | directional sounds in a natural manner. |
| | | Includes a wide selection of preprogrammed animated male and female |
| | | characters, including, caregivers of several nationalities, children, teens, |
| | | adults, elderly, animals, etc. |
| | | A photograph of a patients friend, relative, or pet can be animated by |
| | | LiveCare ™ ECS at a minimal cost for children, Alzheimer and dementia |
| | | patients to provide a comforting familiar face for interaction and |
| | | companionship. The animation file is downloaded to the LiveCare ™ ECS |
| | | Station without caregiver involvement. |
| 15 | Speech rehabilitation, training, and | Directional microphones with ambient noise monitoring and active noise |
| | monitoring of physician prescribed words | cancellation to improve signal to noise in high ambient noise environments. |
| | and phrases and associated training | Automatic active audio filters to attenuate unwanted or interfering audio |
| | schedule. | frequencies for optimal speech recognition. |
| | | Advanced speech recognition algorithms to score pronunciation accuracy |
| | | and sound intensity. |
| | | Monitor displays training progress. |
| | | On-screen animated character provides directions encouragement, and |
| | | humor. |
| | | Concurrent medical device monitoring if indicated. |
| | | Scoring algorithm to monitor daily progress for post review by medical |
| | | professional. |
| | | Automatic audio/video capture for post review and analysis by medical |
| | | professional. |
| 16 | Patient hearing screening | Hi-fidelity amplified speakers. |
| | | Automatic volume control based on ambient noise monitoring, face |
| | | recognition, and 3D infrared camera distance measurements to the patient's |
| | | head to adjust the audio volume for screening hearing tests. |
| | | Test tones can also be produced that are monitored by the directional |
| | | microphones to adjust the audio volume based on room acoustics and |
| | | ambient noise level. |
| | | Optional wireless headset with noise canceling microphone. |
| | | Scoring algorithm to monitor daily progress for post review by medical |
| | | professionals. |
| 17 | Vision screening and strength training | Face recognition algorithms, and 3D infrared camera distance measurements |
| | | to the patient's head to adjust the size of test images and characters on the |
| | | computer monitor for vision screening and strength training. |
| | | Monitor displays video and audio prompts during the tests. |
| | | Animated character provides encouragement and directions. |
| | | Scoring algorithm to monitor daily progress for post review by medical |
| | | professional. |
| 18 | Physical therapy rehabilitation and | 3D infrared camera and body/limb recognition software to monitor range of |
| | monitoring of physician or physical | motion and movement repetitions as per physician or physical therapist |
| | therapist prescribed exercises. | prescribed exercises. |
| | | Concurrent medical device monitoring, e.g. pulse rate, blood pressure, |
| | | oxygen saturation, respiration, ECG, etc. |
| | | Interface with strength building appliances. |
| | | Monitor displays training progress. |
| | | On-screen animated character provides directions encouragement, and |
| | | humor. |
| | | Scoring algorithm to monitor daily progress for post review by medical |
| | | professionals. |
| | | Automatic audio/video capture for post review and analysis by medical |
| | | professional. |
| 19 | Unusual Physical Activity Monitor | The 3D infrared projector/camera can clearly see the patient in complete |
| | | darkness or lighted conditions. |
| | | Threshold can be set to provide Nurse Call System, text messages, or email |
| | | alerts for unusual body movements, spasms, etc. during sleep and waking |
| | | activities. |
| | | Concurrent medical device monitoring if indicated. |
| | | Scoring algorithm to monitor daily unusual physical activity for post review |
| | | by medical professional. |
| | | Automatic audio/video capture for post review and analysis by medical |
| | | professional. |
| 20 | Patient Cognition Monitoring | Animated character can interact with and question the patient on a |
| | | therapist's prescribed routine schedule for expected answers, and provide |
| | | progress reports and alerts for responses exceeding therapist recommended |
| | | thresholds. |
| | | Scoring algorithm to monitor daily progress for post review by medical |
| | | professional. |
| | | Automatic audio/video capture for post review and analysis by medical |
| | | professional. |
| 21 | Patient Cognition Rehabilitation and | Protocols for post-surgery, anti-aging, Alzheimer, dementia, etc. |
| | Training | Animated character can interact with and question the patient on a |
| | | therapist's prescribed routine schedule, and provide progress reports and |
| | | alerts for responses exceeding therapist recommended thresholds. |
| | | Scoring algorithm to monitor daily progress for post review by medical |
| | | professional. |
| | | Automatic audio/video capture for post review and analysis by medical |
| | | professional. |
| 22 | LiveCare ™ ECS Sentinel | The 3D infrared projector/camera can clearly see the patient in complete |
| | | darkness or low light conditions during sleep. |
| | | If the patient wakes up and sits up (or other prescribed position) the |
| | | animated character can automatically activate and interact with and |
| | | question the patient to determine the mental state or other prescribe |
| | | response. |
| | | Based on physician presets the LiveCare ™ ECS Sentinel software can turn |
| | | on a night light for the patient to go to the bathroom, push an alert to the |
| | | Nurse Call System, take other prescribed actions, or tell the patient a |
| | | “bedtime” story, play soothing music, initiate Relaxation Training (see item |
| | | 18, below) to encourage restful sleep. |
| | | Concurrent medical device monitoring if indicated. |
| | | Scoring algorithm to monitor nocturnal patterns for post review by medical |
| | | professional. |
| | | Automatic audio/video capture for post review and analysis by medical |
| | | professional. |
| | | The system studies the behavior of the patient over time, and incorporates |
| | | this behavioral knowledge into the decision and scoring algorithm. |
| 23 | Relaxation and Anti-Anxiety Training | Wireless pulse rate sensor to monitor heart rate variability (HRV). |
| | | Animated character provides encouragement and directions to the patient. |
| | | Animated breathing pattern display with soothing audio instructions to |
| | | achieve a calm rhythmic breathing pattern. |
| | | On-screen progress indicators for real-time pulse rate, HRV, and associated |
| | | coherence scores. |
| | | Concurrent medical device monitoring if indicated. |
| | | Scoring algorithm to monitor HRV patterns and coherence scores for post |
| | | review by medical professional. |
| | | Automatic audio/video capture for post review and analysis by medical |
| | | professional. |
| 24 | Integrated examination lamp (luminaire) | Natural color rendering for a variety of examinations. |
| | with multiple locally and remotely | Uniform lighting of the examination field to minimize shadows. |
| | controlled dimming levels | Locally or remotely controlled color temperature and natural |
| | | rendering of tissue colors (surface and deep structures) for the specific |
| | | examination requirements by using a combination of LED colors. |
| | | Low heat radiation (infrared radiation). |
| | | Independent pan and tilt controls |
| | | Option for removing the lamp to mount on an optional stand for optimal |
| | | placement. |
| 25 | Integrated pan-tilt-zoom camera with auto | High-Definition (HD) camera with x10 or higher lossless zoom capability |
| | face tracking and remote control, | for close-up tissue inspections and eye examinations. |
| | | Auto tracking patient face or remotely controlled by the physician or |
| | | caregiver. |
| 26 | Optional pan-tilt monitor or charging base | Allows optimal monitor or display viewing angle for the patient in reclining, |
| | with auto face tracking and remote | sitting and standing positions |
| | control. | |
| 27 | Interface to Nurse Call Systems | Push alerts as indicated (above). |
| | Distressed human sounds and unusual | Distressed human sounds and unusual ambient sound monitoring and |
| | ambient sound monitoring and ECS | automatic analysis for unattended ECS signaling, including but not limited |
| | signaling. | to: |
| | | Crying |
| | | Moaning |
| | | Wailing |
| | | Gagging |
| | | Preprogrammed physician advised patterns |
| | | Shouting |
| | | Crashes, gunshots, explosions, vehicle crashes, strange dog barking, |
| | | personal assaults, etc. |
| 28 | Local or remotely operated “Walking | The National Institute of Health (NIH) reports the following on the NIH |
| | Light ™” for walking in dimly lit areas, or | Senior Health website |
| | to aid vision in dimly lit areas. Provides | http://nihseniorhealth.gov/falls/aboutfalls/01.html |
| | manual, automatic, and/or voice | “More than one in three people age 65 years or older falls each year. The risk |
| | controlled on/off and adjustable | of falling - and fall - related problems-rises with age. Each year, more than |
| | brightness illumination control. | 1.6 million older U.S. adults go to emergency departments for fall-related |
| | | injuries. Among older adults, falls are the number one cause of fractures, |
| | | hospital admissions for trauma, loss of independence, and injury deaths.” |
| | | The NIH specifically recommends “to make sure that you have adequate light |
| | | is dark areas.” Aging seniors on fixed incomes routinely try to save money |
| | | by turning off lights at night. The nocturnal walk to and from the bathroom, |
| | | kitchen, put out the pet, etc. can lead to treacherous consequences. |
| | | Local or remotely operated “Walking Light ™” to aid walking in dimly lit |
| | | areas, or to aid vision in dimly lit areas. |
| | | Manual, automatic, and/or voice controlled on/off and adjustable brightness |
| | | illumination control. |
| | | Hands-free “Walking Light ™” that is suspended from the neck of the user |
| | | or worn with a belt clip, or other attachment means to the user's garments. |
| | | This allows the user both hands to balance and/or touch or grab surfaces to |
| | | maintain stability, use a walking cane, or walker. |
| | | Provides illumination pointing down and ahead of the user to see the user's |
| | | feet and the walking space in immediately in front of and ahead of the user. |
| | | Can be handheld for directing illumination in dimly lit areas or on dimly lit |
| | | surfaces. |
| | | Can be remotely operated via the Internet and/or cellular network for remote |
| | | assistance by a caregiver or other person assisting the user, |
| | | On/off light control and/or continuously variable light illumination control. |
| | | Automatic walking and/or standing detection and ambient light sensors turn |
| | | on the “Walking Light ™” in dimly lit environments. |
| | | Automatic battery capacity notification to notify the user and/or remote |
| | | caregiver of remaining illumination time (including audio annunciation). |
| | | Automatic battery fuel gauge can reduce other ECS features and/or reduce |
| | | the illumination level (with user permission) if the battery is critically low |
| | | to preserve battery life. |
| | | LiveCare ™ ECS Pendants can also interface to facility automation networks |
| | | via ZigBee, Z-Wave, other wireless technologies, and/or the LAN to |
| | | automatically control facility lighting is individual walks through their |
| | | house. |
| 29 | Local or remotely operated “Reading | Manual and/or voice controlled operation and brightness control. |
| | Light ™” for reading in dimly lit | Can be remotely operated via the Internet and/or cellular network for remote |
| | environments, | assistance by a caregiver or other person assisting the user. |
| | | Automatic battery capacity notification to notify the user and/or remote |
| | | caregiver of remaining illumination time (including audio annunciation). |
| | | Automatic battery fuel gauge can reduce other ECS features and/or reduce |
| | | the illumination level (with user permission) if the battery is critically low |
| | | to preserve battery life. |
| 30 | One button and voice controlled call for | 24/7/365 Technical Help line monitoring by LiveCare ™ ECS to assist the |
| | technical help. | caregiver in device connectivity, configuration, operation, and problem |
| | | resolution. |
| | | Facilitates nurse efficiency and training. |
| | | Full escalation from receptionist, trainer, support technician or engineer as |
| | | required. |

LiveCare™ ECS and LiveCare™ ECS Pendant Additional Features

The LiveCare™ ECS and LiveCare™ ECS Pendants are classified under Medical Device Data Systems (MDDS) FDA Class I medical devices for remote patient monitoring as per:
DEPARTMENT OF HEALTH AND HUMAN SERVICES
Food and Drug Administration
21 CFR Part 880
[Docket No. FDA-2008-N-0106] (formerly Docket No. 2007N-0484)
Medical Devices; Medical Device Data Systems

The LiveCare™ ECS and LiveCare™ ECS Pendants are used to interface a wide range of wired and wireless biometric sensors and medical devices for remote patient monitoring in the Post-Acute Care and Chronic Disease Management markets in: nursing homes, assisted living homes, long term care, patient residences, and other similar environments. In addition, the LiveCare™ ECS and LiveCare™ ECS Pendants incorporate multiparty two-way audio and/or videoconferencing and other advanced features to facilitate billable doctor/patient consultations; remote nurse, caregiver, and family visitations; and embedded artificial intelligence for patient management and medical compliance.

Several performance parameters (e.g. video resolution) can be automatically adjusted during degraded Internet connectivity bandwidth and/or during cellular Internet connection to maintain adequate communications, or to limit data throughput for cost savings if required. The LiveCare™ ECS and LiveCare™ ECS Pendants can also interface to facility automation networks via ZigBee, Z-Wave, other wireless technologies, and/or the LAN.

The LiveCare™ ECS and LiveCare™ ECS Pendants are also intended for use as a FDA Class II medical device for “Active Patient Monitoring” under a FDA 510K submittal for use in hospital ICU and other critical medial environments.

Wireless charging base and example accessories are shown in FIGS. 12A-12F.

Industrywide Problem for Remote Patient Monitoring

There are numerous single parameter and multi-parameter biometric sensors and medical devices for remote patient monitoring. However, many different companies having incompatible proprietary firmware, software, and/or connecting hardware or software throughout their architectures from the remote medical device via the Internet Cloud to the caregiver's application software. In addition, the current gateways and hubs that interface the biometric sensors and medical devices to the Cloud were designed for remote patient monitoring in patient residences. As such, these devices are not suitable in multi-bed nursing homes to connect (pair) peripheral Bluetooth devices with multiple hubs that are in close proximity to each other and to other peripherals.

Typical problematic architecture is shown in FIG. 13.

Potential Problems of Connecting Peripheral Bluetooth Device with Multiple Hubs in Nursing Homes and Assisted Living Facilities

FIG. 14 illustrates the potential problems in nursing homes with connecting (pairing) peripheral Bluetooth devices with multiple hubs that in close proximity to each other and to other peripherals. The Bluetooth RF signals can travel up to 30 feet through air and walls which can complicate setup and assurance that the correct medical device is associated with a specific patient.

LiveCare™ ECS and LiveCare™ ECS Pendants Interface to a wide range of Biometric Sensors

The LiveCare™ ECS and LiveCare™ ECS Pendant are novel medical grade devices that interfaces a wide range wired and wireless biometric sensors and medical devices to the Cloud via redundant communication pathways. They include advanced features to allow use in multi-bed facilities or residences. The biometric sensors and medical devices that can be interfaced to the LiveCare™ ECS or LiveCare™ ECS Pendant include, but are not limited to the following:
Physical and/or Mental Activity Monitors
Blood Pressure Cuffs and Sensors
Blood Glucose Sensors and Systems (Glucometers)
Single and multi-lead ECG Patch
5 Lead ECG
12 Lead ECG
Dermascopes
Endoscopes
Ophthalmoscope
Otoscopes
Pulse Oximeters
Spirometers
Stethoscopes
Ultrasound Sensors and Systems
Weight Scales
Weight Scales and Body Composition Scales and Systems
   Interfacing medical devices to the Cloud with the LiveCare™ ECS and LiveCare™ ECS Pendant are shown in FIG. 15.

LiveCare™ ECS and LiveCare™ ECS Pendants interface a wide range of OEM medical sensors and medical devices via multiple Cloud Portals as shown in FIG. 16.

Example Devices that interface with the LiveCare™ ECS or LiveCare™ ECS Pendant are shown in FIG. 17.

LiveCare™ ECS and LiveCare™ ECS Pendant integration with nurse call systems; standard nurse call system and current options as shown in FIG. 18.

LiveCare™ ECS and LiveCare™ ECS Pendant integration with medical devices and a nurse call system is shown in FIG. 19.

LiveCare™ ECS Pendant Concept Designs are shown in FIG. 20.

LiveCare™ ECS Pendant Concept, Skilled & Homecare are shown in FIG. 21.

LiveCare™ ECS Pendant Concept, Skilled is shown in FIG. 22.

LiveCare™ ECS Pendant Concept, Homecare is shown in FIG. 23.

LiveCare Corp.

Provisional Patent for an Emergency Call System

Authors: Peri Avitan, Robert J. Benetti, Bryan T. Benetti, and Robert A. Benetti

Overview

Health Care Signaling Equipment (including Medical Alerts) Personal Emergency Response Equipment, Emergency Call Systems, and Hospital Signaling and Nurse Call Equipment comprise a wide range of individual components and systems that are used to electronically signal to another individual or caregiver, multiple individuals or caregivers, and/or a Central Station that they are in need of personal assistance or medical assistance for both routine and acute emergency situations in a wide range of environments, including:
Personal residences and their surrounding property.
During out of home excursions and travel.
During temporary or extended stays in assisted living and independent living facilities.
In hospitals and other acute care facilities.
Etc.

All of the above types of systems will be referred to herein as Emergency Call Systems (ECS).

An ECS is typically accompanied by a portable call initiation station (pendant) which may be handheld, body worn, or attached to a person's clothing. These pendants provide assistance request or emergency request signaling to the ECS and/or directly to a preprogrammed phone number or Central Station via wireless technology (RF, Wi-Fi, cellular, etc.). All of the various types of pendants will be referred to herein as ECS Pendants.

The various types of ECS and ECS Pendants are certified by domestic safety standards that are published by Underwriters Laboratory (UL) and similar international standards for various usages and operating environments:
a. UL 1637 Home Health Care Signaling Equipment.
b. UL 1698 Personal Emergency Response Equipment—(proposed standard)
c. UL 2560 Emergency Call Systems for Assisted Living and Independent Living Facilities.
d. UL 1069 Hospital Signaling and Nurse Call Equipment.

These standards have different safety and operational performance requirements for the various usage scenarios and operating environments. Please refer to FIG. 10 for the following discussion:

The dashed lines around the environments covered under UL 1637 and UL 1698 (proposed standard) represents that these environments are currently using ECS and/or ECS Pendants that communicate ECS signaling to another individual or individuals, caregivers, or a Central Station via the public switched telephone network (PSTN) or cellular network.

UL. 1637 Home Health Care Signaling Equipment
[The following was excerpted from UL 1637]

1 Scope

1.1 These requirements cover the individual units that comprise a home health care system intended for use in ordinary indoor residential locations.
[Note that this requirement specifically states “for use in ordinary indoor residential locations” with no allowance for outdoor use, or the multitude of complex environments that will be addressed in the proposed UL 1698 standard]

1.2 These requirements also cover a complete home health care system in which a signal initiating device (both routine monitoring and medical emergency signals) may be connected directly or indirectly to receiving equipment at a residence or to continuously monitored receiving equipment at a central supervising station. The system is arranged so that a predetermined change in the status of the signal initiating circuits or devices automatically causes transmission of a signal over a communication channel to receiving equipment at a residence, to a central supervising station, or to a private telephone number.
[Note that this requirement states: “transmission of a signal over a communication channel . . . ” with no definitive safety or performance requirements in the standard for communication over cellular networks which will be addressed in the proposed UL 1698 standard]

1.3 The components of the home health care system may include signal initiating devices, control units, transmitters, and digital communicators, all located at the residence, and the receiving, processing, and displaying equipment located at the central supervising station.
[Note that this requirement states: “may include signal initiating devices, control units, transmitters, and digital communicators, all located at the residence . . . ” with no definitive safety or performance requirements in the standard for devices used outside of the residence and communication over cellular networks which will be addressed in the proposed UL1698 standard]

UL 1698 Personal Emergency Response Equipment (proposed)
[The following was excerpted from the proposed Scope for UL 1698]

Scope

Covers application, construction, and performance of equipment utilized in personal emergency response systems. The purpose of this standard is to define the means of signal initiation, transmission, notification and annunciation; level of performance; and the reliability of various types of personal emergency response systems. The standard also defines the features associated with these systems.
[This is a proposed UL standard that is currently under development and not yet published as of Mar. 29, 2016.
It is not specifically stated in the above Scope, however, the Scope will include the wide range of environments illustrated in FIG. 10 and include cellular communication and advanced locating technologies that includes GPS for: single and multilevel (aka multi-floor) personal residences, apartments, hotels, cities with high rise building, shopping malls, multistory buildings, multilevel and underground roadways and parking garages, rural areas, parks, recreation areas, traveling in vehicles, etc.]

UL 2560 Emergency Call Systems for Assisted Living and Independent Living Facilities
[Referring to FIG. 10 the solid line around the environments covered under UL 2560 represents that these environments are currently not using ECS Pendants for ECS signaling, two-way voice communication, and alarm clearing via PSTN, Internet, cellular network, or other method of communication to caregivers or a Central Station that are remotely located.]

[The following was excerpted from UL 2560]

1 Scope

1.1 These requirements cover the individual unit employed to form assisted and independent living emergency call systems (ECS) intended to provide audible and visual signaling between residents and assisted and independent living facility staff. Some examples include call initiation stations, call notification stations, and power supplies.
[Note that under the following section 40.2.1 b of UL 2560 (below) it states, “A required battery trouble call shall be transmitted to the receiver for a minimum of 7 days before the battery capacity of the transmitter has depleted to a level insufficient to maintain proper non-call operation of the transmitter.” There is also a battery life performance test under section 41.1.1 (see below) to ensure that the ECS Pedant meets this requirement. As such, by using a single low power RF transceiver and battery as in the current competitive product offerings it is not feasible to include two-way audio and/or videoconferencing capability into an ECS Pendant. The LiveCare™ ECS Pendant uses a novel dual transceiver/dual battery design and/or a novel battery management system that provides UL 2560 compliant ECS signaling and concurrent two-way audio and/or HIPAA compliant videoconferencing in the same ECS Pendant (see LiveCare™ ECS and LiveCare™ ECS Pendant, below)]

40.2.1 A primary battery is not prohibited from being used as the sole source of power for a low-power radio transmitter when all of the following conditions are met:
a) The capacity of the primary battery shall be monitored for integrity. The battery shall be monitored while loaded by:
   1) Transmission of the transmitter or
   2) A load equivalent to the load imposed by transmission.
b) A required battery trouble call shall be transmitted to the receiver for a minimum of 7 days before the battery capacity of the transmitter has depleted to a level insufficient to maintain proper non-call operation of the transmitter. It is acceptable for the battery trouble call at the call notification station to be initially delayed up to 24 hours.
c) The battery of a transmitter shall be capable of operating the transmitter in its normal supervisory mode and placing a single emergency call per day, each call remaining for 5 minutes before it is reset, for a published manufacturer specified length of time before the battery depletion threshold specified in (b) is reached.

41 Primary Batteries Test

41.1 Life Test

41.1.1 When a primary battery is used as the main source of power for a low power radio transmitter, it shall provide power to the unit under intended ambient conditions for the manufacturers specified battery life using the normal signaling performance as described in 40.2.1(c) and then operate the transmitter for a minimum of 7 days of trouble signal. Data on battery life, including discharge curves, shall be provided for the investigation to evaluate battery performance characteristics.

UL 1069 Hospital Signaling and Nurse Call Equipment
[Referring to FIG. 10 the solid line around the environments covered under UL 1069 represents that these environments are currently not using ECS Pendants for ECS signaling, two-way voice communication, and alarm clearing via the PSTN, internet, cellular network, or other method of communication to caregivers or a Central Station that are remotely located.]

1 Scope

1.1 These requirements cover the individual units employed to form a hospital nurse call system (NCS) intended to provide audible and visual communication between patients and hospital personnel. They also cover miscellaneous signaling equipment employed in hospitals. Some examples include bedside tables, annunciators, power supplies for nurse call systems, and gas monitoring units.

[Note that under the following section 49.2.1 b of UL 1069 (below) it states, “A required battery trouble call shall be transmitted to the receiver for a minimum of 7 days before the battery capacity of the transmitter has depleted to a level insufficient to maintain proper non-call operation of the transmitter.” There is also a battery life performance test under section 50.1.1 (see below) to ensure that the ECS Pedant meets this requirement. As such, by using a single low power RF transceiver and battery as in the current competitive product offerings it is not feasible to include two-way audio and/or videoconferencing capability into an ECS Pendant. The LiveCare™ ECS Pendant uses a novel dual transceiver/dual battery design and/or a novel battery management system that provides UL 1069 compliant ECS signaling and concurrent two-way audio and HIPAA compliant videoconferencing in the same ECS Pendant (see LiveCare™ ECS and LiveCare™ ECS Pendant, below)]

49.2 Primary Batteries

49.2.1 A primary battery is not prohibited from being used as the sole source of power for a low-power radio transmitter when all of the following conditions are met:
a) The capacity of the primary battery shall be monitored for integrity. The battery shall be monitored while loaded by:
   1) Transmission of the transmitter or
   2) A load equivalent to the load imposed by transmission.
b) A required battery trouble call shall be transmitted to the receiver for a minimum of 7 days before the battery capacity of the transmitter has depleted to a level insufficient to maintain proper non-call operation of the transmitter.
It is acceptable for the battery trouble call at the Primary Nurse Control Station to be initially delayed up to 4 hours. The battery trouble annunciation shall be retransmitted at intervals not exceeding four hours until the battery is replaced.
c) The battery of a transmitter shall be capable of operating the transmitter for a published manufacturer specified length of time of normal annunciating service before the battery depletion threshold specified in (b) is reached.

50 Primary Batteries Test

50 added Oct. 12, 2007 issued Oct. 12, 2007

50.1 Life Test

50.1.1 When a primary battery is used as the main source of power for a low power radio transmitter, it shall provide power to the unit under intended ambient conditions for a manufacturer's published normal signaling service battery life and then operate the product for a minimum of 5 minutes of call, followed by 7 days of trouble signal. Data on battery life, including discharge curves, shall be provided for the investigation to evaluate battery performance characteristics.

Current ECS and ECS Pendant Environments are shown in FIG. 10.

LiveCare™ ECS and LiveCare™ ECS Pendant

The LiveCare™ ECS and ECS Pendants incorporate novel design elements to provide both common and reconfigurable hardware and software that can provide domestic and international compliant ECS signaling for all usage scenarios and operating environments. In addition, the novel designs include advanced multiparty two-way audio conferencing for:
Communication with remote caregivers for ECS alarm clearing.
Consultations with remote caregivers.
Communication with remote family and friends.

The novel designs also include non-HIPAA compliant and/or HIPAA compliant two-way and/or multiparty videoconferencing for:
Billable remote patient monitoring, performing audio and visual medical examinations, arid medical consultations.
Videoconferencing with remote family and friends as allowed in the particular environments.

Please refer to FIG. 11 for the following discussion:

The dashed lines around the environments covered under UL 1637, UL 1698 (proposed standard) UL 2560, and UL 1069 illustrate that the LiveCare™ ECS and LiveCare™ ECS Pendants can communicate ECS signaling to other individuals, caregivers, or a Central Station receiving unit depending on the usage scenarios via the PSTN, Internet, cellular network, or by other communication methods. In addition, advanced multiparty two-way audio conferencing and non-HIPAA compliant and/or HIPAA compliant multiparty videoconferencing is supported.

Simplified and Uniform Operation for Aging Seniors Across all Environments

Seniors are constantly exposed to a barrage of emerging technologies that can overwhelm the aging brain, and are contending with diminishing manual dexterity and functionality of their nervous system and musculoskeletal physiology. The LiveCare™ ECS and LiveCare™ ECS Pendants have a wide range of novel features and technical advancements to facilitate simplified uniform operation that improves the quality of life and extends independent living for as long as practical. The skill sets learned in their home and other environments will eventually transition with them into assisted living facilities and/or nursing homes, hospitals, or acute care facilities without having to relearn or simply give up on what can pose daunting mental and physical learning obstacles.

LiveCare™ ECS and LiveCare™ ECS Pendant environments are shown in FIG. 11.

Notable Features of the LiveCare™ ECS and LiveCare™ ECS Pendant

Notable Features address the following criteria:
Significant new/novel features.
Solves “long felt” market needs.
Compensates for the lack of important features on competitive products.
Achieves unexpectedly good results.

| # | Feature | Description And Feature-Associated Advantages |
|---|---|---|
| 1 | Medical Device Certification (the | The LiveCare ™ ECS and LiveCare ™ ECS Pendants are compliant with and |
| | LiveCare ™ ECS and LiveCare ™ ECS | certified by the following regulatory agencies as required: |
| | Pendants are not common cellphone or IT | Domestic and International Medical, Safety and EMC standards |
| | peripherals) | MDDS, FDA Class 1 medical device and associated global standards for |
| | | Remote Patient Monitoring. |
| | | FDA Class II medical device 510 K and associated global standards for |
| | | Active Patient Monitoring. |
| | | UL, AAMI and FCC: domestic certification |
| | | EN/IEC: European/lnternational. |
| | | CE/CB Scheme: International. |
| | | Continua International Certification. |
| | | Other regulatory certifications for global: medical, safety, and EMC |
| | | compliance. |
| 2 | LiveCare ™ ECS and LiveCare ™ ECS | The LiveCare ™ ECS and LiveCare ™ ECS Pendant incorporate novel |
| | Pendant that are herein described that are | design elements to provide both common and reconfigurable hardware and |
| | configurable and compliant with any | software that can provide domestic and international compliant ECS |
| | combination of the following domestic or | signaling for all usage scenarios and operating environments. In addition, the |
| | equivalent international standards or their | novel designs include advanced multiparty two-way audio conferencing for: |
| | derivative or successor standards: | Communication with remote caregivers for ECS alarm clearing. |
| | UL 1637 Home Health Care Signaling | Consultations with remote caregivers. |
| | Equipment | Communication with remote family and friends. |
| | UL 1698 Personal Emergency Response | Multiparty two-way audio conferencing allows a remote caregiver and/or |
| | Equipment | Central Station to quickly respond to an ECS event to determine if there is |
| | UL 2560 Emergency Call Systems for | an acute emergency or if the individual simply needs nonemergency |
| | Assisted Living and Independent Living | assistance (drinking water, assistance standing or sitting, pain medications, |
| | Facilities, | assistance with personal hygiene, etc.). A responsible remote caregiver is |
| | UL 1069 Hospital Signaling and Nurse | also allowed by the standards to authorize that the ECS alarm be cleared if |
| | Call Equipment. | they can determine through two-way audio communication and/or video |
| | Multiparty two-way audio conferencing. | conferencing that there isn't an acute emergency situation. This is especially |
| | Multiparty HIPAA compliant | important during the evening shift hours in assisted living facilities where an |
| | videoconferencing for use as a Class 1 | on-site nurse is not required, but must be available to respond to ECS |
| | MDDS device. | signaling. This can significantly reduce false alarms, and unnecessary travel. |
| | Other non-certified uses and | Multiparty two-way audio conferencing and/or video conferencing can |
| | environments. | significantly improve user satisfaction with improved response times, and |
| | | reduce fatigue and stress while optimizing the efficiency of facility staff. |
| | | Multiparty two-way audio conferencing and/or video conferencing can also |
| | | permit translators to participate on a conference call to significantly reduce |
| | | travel, coordination of schedules, etc. |
| | | The novel design also includes non-HIPAA compliant and/or HIPAA |
| | | compliant multiparty videoconferencing for: |
| | | Billable remote patient monitoring, performing audio and visual medical |
| | | examinations, and medical consultations. |
| | | Videoconferencing with remote family and friends as allowed in the |
| | | particular environments. |
| | | Multiparty two-way videoconferencing is not required in the standards, but |
| | | provided in some embodiments. Multiparty two-way videoconferencing |
| | | allows remote caregivers, attending physicians, and medical specialists to |
| | | examine and consult with private individuals, assisted living residents, and |
| | | hospital or acute care patients without having to travel to the specific |
| | | location. Due to recently enacted legislation, this type of remote telehealth |
| | | service is also becoming a billable service for the physicians. As with |
| | | multiparty two-way audio conferencing, multiparty videoconferencing |
| | | improves customer satisfaction by having quick access to their physician or |
| | | specialist, and improves staff efficiency by reducing travel within and to |
| | | facilities. |
| | | An added benefit of providing audio and video conferencing is the ability to |
| | | visit with friends and family which can significantly improve user well- |
| | | being and satisfaction |
| | | Novel Designs: |
| | | Concurrent ECS signaling and multiparty two-way audio and/or video |
| | | conferencing requires a novel design to ensure adequate battery performance |
| | | that is required in the standards. ECS signaling requires long-lasting batteries |
| | | that can provide continued signaling up to 7 days after a low battery |
| | | condition has been detected. However, as every cell phone user has |
| | | experienced, several hours of audio communication or videoconferencing |
| | | can rapidly deplete batteries in less than 24 hours. As such, LiveCare |
| | | engineering has developed a novel dual radio transceiver architecture with |
| | | dual batteries to provide low power ECS signaling that is powered from a |
| | | primary or secondary battery, and a separate wireless transceiver and |
| | | associated subsystems that are powered by a higher capacity rechargeable |
| | | battery for audio and video conferencing that can be recharged daily while |
| | | the patient sleeps. The larger capacity rechargeable battery also provides the |
| | | ability to provide a wide range of other features not normally available in a |
| | | low power ECS signaling pendant such as a backlit touchscreen, “Walking |
| | | Light ™”, “Reading Light ™”, high power audio amplifier, etc. An ECS |
| | | signaling subsystem secondary battery is recharged any time the larger |
| | | capacity battery is being recharged to significantly improve the effective |
| | | battery life of the ECS signaling battery. The ECS signaling subsystem can |
| | | be powered by rechargeable super capacitor, ultra-capacitor, or other energy |
| | | storage system as the associated regulatory standard permits. |
| | | LiveCare engineering has also developed a novel architecture with ECS |
| | | signaling and multiparty two-way audio and video conferencing that |
| | | operates from a single high capacity rechargeable battery. Advanced battery |
| | | fuel gauge monitoring with associated battery aging analysis software allows |
| | | concurrent ECS signaling and multiparty two-way audio and video |
| | | conferencing (and other high power features) wherein two-way |
| | | videoconferencing and other non-critical function are suspended at low |
| | | battery reserve levels to allow continued signaling with continued two-way |
| | | audio conferencing. At lower battery discharge levels, two-way audio |
| | | conferencing and other noncritical functions are suspended to allow |
| | | continued signaling up to 7 days or as stipulated by the respective standard |
| | | after a lower battery condition has been detected. |
| | | Automatic user, caregiver, and/or Central Station notifications at the various |
| | | battery discharge states. |
| 3 | The LiveCare ™ ECS Pendant can also be | Novel senior cell phone with advanced cellular ECS signaling, multiparty |
| | used as a stand-alone senior cell phone with | two-way audio conferencing, multiparty videoconferencing, and all of the |
| | cellular ECS signaling and all of the | advanced features herein described. |
| | advanced features herein described. | |
| 4 | Simplified and Uniform Operation for | Seniors are constantly exposed to a barrage of emerging technologies that can |
| | Aging Seniors across all Environments | overwhelm the aging brain, and diminishing dexterity and functionality of |
| | | their nervous system and musculoskeletal physiology. The LiveCare ™ ECS |
| | | and LiveCare ™ ECS Pendants have a wide range of novel features and |
| | | technical advancements to facilitate simplified uniform operation that |
| | | improves the quality of life and extends independent living for as long as |
| | | practical. The skill sets learned in their home and outdoor environments will |
| | | eventually transition with them into assisted living facilities and/or nursing |
| | | homes, hospitals, or other acute care facilities without having to relearn or |
| | | simply give up on what otherwise can be daunting mental and physical |
| | | learning obstacles. Accordingly, the following features are incorporated into |
| | | some embodiments of the present invention: |
| | | Intuitive menu structures with simple voice or touchscreen activation. |
| | | Voice controlled and one button touchscreen calling for a preprogrammed |
| | | caregiver, friend, or family member. |
| | | Uniform menu structures to the degree allowed in the usage environments. |
| | | Automatic and voice controlled “Walking Light ™” and/or “Reading |
| | | Light ™”. |
| | | Local or remote suppression of local camera picture-in-picture for “camera |
| | | shy” seniors. |
| | | Local or remote suppression of local camera picture-in-picture for |
| | | permitting unobstructed viewing of the remote video feed or remote screen |
| | | shared image. |
| | | Advanced face and eye tracking with visual feedback to ensure that the |
| | | individuals face is in view during suppression of local camera picture-in- |
| | | picture. The user positions the LiveCare ™ ECS Pendant in front of their face |
| | | until a visual indicator illuminates to indicate that the remote caregiver can |
| | | see their face in the camera view. |
| | | 24/7/365 assistance by voice control or help button activation depending on |
| | | usage environment. |
| | | Other advanced features herein described. |
| 5 | Accessibility features | For increased readability and reduced eyestrain. |
| 5a | ADA compliant character size and | Improves LCD visibility in indirect and direct sunlight, with a |
| | contrast adjustments | photosensor incorporated for automatic brightness control. |
| 5b | High intensity LED backlight for LCD | Controlled access for individuals authorized by the user. |
| | touchscreen with automatic brightness | For hearing impaired individuals and high ambient noise |
| | control. | environments. |
| 5c | Auto answer for voice and video calls | |
| | with no user intervention required. | |
| | High power audio amplifier and speaker. | |
| | Automatic and voice controlled “Walking | |
| | Light ™” | |
| | “Reading Light ™” | |
| | Wireless Hearing Aid Interface | |
| | Additional accessibility features herein | |
| | described. | |
| 6 | Advanced Telehealth features for remote | Multiparty HIPAA compliant videoconferencing for billable physician |
| | patient monitoring, examinations, and | services. |
| | consultations | User auto-answer for authorized users to simplify physician access to the |
| | | individual or patient. |
| | | Remote front/back camera selection control by the caregiver. |
| | | Remote inspection light intensity controls by the caregiver. |
| | | Novel physician point-of-view viewing for the user that is selected by the |
| | | caregiver. This allows the user to see on the LCD screen what the remote |
| | | caregivers sees for rapid positioning of the camera and real-time consultation |
| | | on observed symptoms such as: swelling, redness, infection, etc. |
| | | Remote suppression of local camera picture-in-picture for unobstructed |
| | | viewing of the remote video feed or remote screen shared image. Advanced |
| | | face and eye tracking with visual feedback to ensure that the individuals face |
| | | is in view’ during suppression of local camera picture-in-picture. The user |
| | | positions the LiveCare ™ ECS Pendant in front of their face until a visual |
| | | indicator illuminates to indicate that the remote caregiver can see their face |
| | | in the camera view. |
| | | Remote still frame and audio/video clip recording and file saving/archiving, |
| | | and file transfer control by the caregiver. |
| 7 | Always On and Always Ready ™ | Always turned on and ready to use with automatic boot-up, error recovery, |
| | | recovery from loss of Internet server, recovery from battery shutdown due to |
| | | excessive battery discharge, etc. |
| 8 | Hands-free voice controlled and touchscreen | No mouse, keyboard, or joystick are required by the patient that may not |
| | monitor | have sufficient reading or writing skills, physical capabilities, or mental |
| | | capabilities to operate a smart phone, tablet computer, laptop, or other |
| | | controlling/connecting device. |
| | | Industrial touchscreen for repeated heavy duty use. |
| 9 | Advanced audio system for clear | The audio teleconferencing features must be automatically adaptive and of |
| | communication, | sufficient fidelity and volume for clear communication over the distance |
| | | from the LiveCare ™ ECS Station to a patient in a bed, and in potentially a |
| | | high and variable ambient noise environment. |
| | | Hi-fidelity amplified speakers. |
| | | Automatic, local, and remote volume control based on ambient noise |
| | | monitoring, face recognition, infrared distance measurements to the patient's |
| | | head to adjust the audio volume. |
| | | Directional microphones with ambient noise monitoring and noise |
| | | cancellation for clear audio communication with remote caregivers, |
| | | translators, family, and friends. |
| | | Microphones are more susceptible to damage from high humidity or water |
| | | damage. Redundant microphones are incorporated for high reliability voice |
| | | commands features, two-way audio conferencing, and videoconferencing. |
| | | Optional wireless headset with noise canceling microphone. |
| | | Wireless hearing aid interface. |
| | | Volume control via Tap Control ™ and Grunt Control ™ (see below) touch |
| | | screen, or remote volume control to ensure unstrained, clear communication. |
| | | High power audio amplifier and compatible speaker or speakers for hearing |
| | | impaired individuals and high ambient noise environments. |
| | | Speakers are more susceptible to damage from high humidity or water |
| | | damage. Redundant audio amplifiers and/or speakers are incorporated for |
| | | high reliability audio notifications, speech functions, two-way audio |
| | | conferencing, and videoconferencing. |
| 10 | Multilingual voice recognition with | Due to significant difference in the quality of speech with Post-Acute Care, |
| | vocabulary training | Chronic Disease patients, and aging individuals, vocabulary training is |
| | | individualized for each patient. |
| 11 | Weak or degraded voice and slurred speech | The voice of an elder becomes weaker and/or degrades overtime. Patients |
| | recognition | may have weak or slurred speech from fatigue, illness, injury, medication |
| | | side effects, surgery, or stroke. |
| | | Directional microphones with ambient noise monitoring and active noise |
| | | cancellation to improve signal to noise on the weak or degraded sounds. |
| | | Optional wireless headset with noise canceling microphone. |
| | | Advanced speech recognition algorithms and custom vocabulary training. |
| | | Monitor displays video and audio prompts during vocabulary training. |
| | | Animated on-screen character provides encouragement and directions. |
| 12 | Tap Control ™ and Grunt Control ™ | Voice impaired individuals can interact with the system by tapping on an |
| | | object or desk, or vocally grunting (short and long guttural sounds) to create |
| | | audio feedback for the system. On-screen prompts guide the user on their |
| | | choices to interact with the system. |
| | | An animated on-screen character (see below) provides encouragement and |
| | | directions. |
| 13 | Hands-free multiparty videoconferencing | Voice control, Tap Control ™, or Grunt Control ™ |
| | | Hands-free call initiation and to answering calls for audioconference and |
| | | videoconferences. |
| | | Hands-free auto answer for authorized callers. |
| | | Optional wireless headset with noise canceling microphone. |
| | | Videoconference with caregiver and patient for billable medical services. |
| | | Several performance parameters (e.g. video resolution) can be automatically |
| | | adjusted during degraded Internet connectivity bandwidth and/or during |
| | | cellular Internet connection to maintain adequate communication, or to limit |
| | | data throughput for cost savings if required. |
| 14 | Personalized animated on-screen character | An animated character on the computer monitor greets and interacts with |
| | to interact with the patient to answer | the patient, including animated eyes, eyelids, eyebrows, mouth, and |
| | questions, provide companionship, training, | numerous facial expressions: nurturing, happy, sad, laughing, concerned, etc. |
| | read a book, entertain, etc. | The character's head and eyes track the face of the patient via face |
| | | recognition software to provide a natural appearing interaction. |
| | | The character's mouth and facial features animate while talking. |
| | | While listening to the patient or visitors, the character will blink eyes |
| | | occasionally, and respond to directional sounds in a natural manner. |
| | | During inactivity, the character will look around, blink eyes, and respond to |
| | | directional sounds in a natural manner. |
| | | Includes a wide selection of preprogrammed animated male and female |
| | | characters, including, caregivers of several nationalities, children, teens, |
| | | adults, elderly, animals, etc. |
| | | A photograph of a patient's friend, relative, or pet can be animated by |
| | | LiveCare ™ ECS at a minimal cost for children, Alzheimer and dementia |
| | | patients, and other users to provide a comforting familiar face for interaction |
| | | and companionship. The animation file is downloaded to the LiveCare ™ |
| | | ECS Station without caregiver involvement. |
| 15 | Speech rehabilitation, training, and | Directional microphones with ambient noise monitoring and active noise |
| | monitoring of physician prescribed words | cancellation to improve signal to noise in high ambient noise environments. |
| | and phrases and associated training | Automatic active audio filters to attenuate unwanted or interfering audio |
| | schedule. | frequencies for optimal speech recognition. |
| | | Advanced speech recognition algorithms to score pronunciation accuracy |
| | | and sound intensity. |
| | | Monitor displays training progress. |
| | | On-screen animated character provides directions encouragement, and |
| | | humor. |
| | | Concurrent medical device monitoring if indicated. |
| | | Scoring algorithm to monitor daily progress for post review by medical |
| | | professional. |
| | | Automatic audio/video capture for post review and analysis by medical |
| | | professional. |
| 16 | Patient hearing screening | Hi-fidelity amplified speakers. |
| | | Automatic volume control based on ambient noise monitoring, face |
| | | recognition, and 3D infrared camera and/or distance measurements to the |
| | | patient's head to adjust the audio volume for screening hearing tests. |
| | | Test tones can also be produced that are monitored by the directional |
| | | microphones to adjust the audio volume based on room acoustics and |
| | | ambient noise level. |
| | | Optional wireless headset with noise canceling microphone. |
| | | Scoring algorithm to monitor daily progress for post review by medical |
| | | professionals. |
| 17 | Vision screening and strength training | Face recognition algorithms, and 3D infrared camera and/or distance |
| | | measurements to the patient's head to adjust the size of test images and |
| | | characters on the computer monitor for vision screening and strength |
| | | training. |
| | | Monitor displays video and audio prompts during the tests. |
| | | Animated character provides encouragement and directions. |
| | | Scoring algorithm to monitor daily progress for post review by medical |
| | | professional. |
| 18 | Physical therapy rehabilitation and | 3D infrared camera and body/limb recognition software to monitor range of |
| | monitoring of physician or physical | motion and movement repetitions as per physician or physical therapist |
| | therapist prescribed exercises. | prescribed exercises. |
| | | Concurrent medical device monitoring, e.g. pulse rate, blood pressure, |
| | | oxygen saturation, respiration, ECG, etc. |
| | | Interface with strength building appliances. |
| | | Monitor displays training progress. |
| | | On-screen animated character provides directions encouragement, and |
| | | humor. |
| | | Scoring algorithm to monitor daily progress for post review by medical |
| | | professionals. |
| | | Automatic audio/video capture for post review and analysis by medical |
| | | professional. |
| 19 | Unusual Physical Activity Monitor | The 3D infrared projector/camera can clearly see the patient in complete |
| | | darkness or lighted conditions. |
| | | Threshold can be set to provide Nurse Call System, text messages, or email |
| | | alerts for unusual body movements, spasms, etc. during sleep and waking |
| | | activities. |
| | | Concurrent medical device monitoring if indicated. |
| | | Scoring algorithm to monitor daily unusual physical activity for post review |
| | | by medical professional. |
| | | Automatic audio/video capture for post review and analysis by medical |
| | | professional. |
| 20 | Patient Cognition Monitoring | Animated character can interact with and question the patient on a |
| | | therapist's prescribed routine schedule for expected answers, and provide |
| | | progress reports and alerts for responses exceeding therapist recommended |
| | | thresholds. |
| | | Scoring algorithm to monitor daily progress for post review by medical |
| | | professional. |
| | | Automatic audio/video capture for post review and analysis by medical |
| | | professional. |
| 21 | Patient Cognition Rehabilitation and | Protocols for post-surgery, anti-aging, Alzheimer, dementia, etc. |
| | Training | Animated character can interact with and question the patient on a |
| | | therapist's prescribed routine schedule, and provide progress reports and |
| | | alerts for responses exceeding therapist recommended thresholds. |
| | | Scoring algorithm to monitor daily progress for post review by medical |
| | | professional. |
| | | Automatic audio/video capture for post review and analysis by medical |
| | | professional. |
| 22 | LiveCare ™ ECS Sentinel | The 3D infrared projector/camera can clearly see the patient in complete |
| | | darkness or low light conditions during sleep. |
| | | If the patient wakes up and sits up (or other prescribed position) the |
| | | animated character can automatically activate and interact with and question |
| | | the patient to determine the mental state or other prescribe response. |
| | | Based on physician presets the LiveCare ™ ECS Sentinel software can turn |
| | | on a night light for the patient to go to the bathroom, push an alert to the |
| | | Nurse Call System, take other prescribed actions, or tell the patient a |
| | | “bedtime” story, play soothing music, initiate Relaxation Training (see item |
| | | 18, below) to encourage restful sleep. |
| | | Concurrent medical device monitoring if indicated. |
| | | Scoring algorithm to monitor nocturnal patterns for post review by medical |
| | | professional. |
| | | Automatic audio/video capture for post review and analysis by medical |
| | | professional. |
| | | The system studies the behavior of the patient over time, and incorporates |
| | | this behavioral knowledge into the decision and scoring algorithm. |
| 23 | Relaxation and Anti-Anxiety Training | Wireless pulse rate sensor to monitor heart rate variability (HRV). |
| | | Animated character provides encouragement and directions to the patient. |
| | | Animated breathing pattern display with soothing audio instructions to |
| | | achieve a calm rhythmic breathing pattern. |
| | | On-screen progress indicators for real-time pulse rate, HRV, and associated |
| | | coherence scores. |
| | | Concurrent medical device monitoring if indicated. |
| | | Scoring algorithm to monitor HRV patterns and coherence scores for post |
| | | review by medical professional. |
| | | Automatic audio/video capture for post review and analysis by medical |
| | | professional. |
| 24 | Exam Light ™. Integrated examination lamp | Natural color rendering for a variety of examinations. |
| | (luminaire) with multiple locally and | Uniform lighting of the examination field to minimize shadows. |
| | remotely controlled dimming levels. Refer | Locally or remotely controlled light intensity and/or color temperature for |
| | to FIGS. 11, 12, 13 and 15 (below). | natural rendering of tissue colors (surface and deep structures) for the |
| | | specific examination requirements. |
| | | Low heat radiation (infrared radiation) to prevent burns or uncomfortably |
| | | high temperatures to the user. |
| | | Independent pan and tilt controls |
| | | Option for removing the lamp to mount on an optional stand for optimal |
| | | placement. |
| 25 | Integrated pan-tilt-zoom camera with auto | High-Definition (HD) camera with xlO or higher lossless zoom capability |
| | face tracking and remote control. | for close-up tissue inspections and eye examinations. |
| | | Auto tracking patient face or remotely controlled by the physician or |
| | | caregiver. |
| 26 | Optional pan-tilt monitor or charging base | Allows optimal monitor or display viewing angle for the patient in |
| | with auto face tracking and remote control. | reclining, sitting and standing positions |
| 27 | Interface to Nurse Call Systems | Push alerts as indicated (above). |
| 28 | Distressed human sounds and unusual | Distressed human sounds and unusual ambient sound monitoring and |
| | ambient sound monitoring and unattended | automatic analysis for unattended ECS signaling, including but not limited |
| | ECS signaling. | to: |
| | | Crying |
| | | Moaning |
| | | Wailing |
| | | Gagging |
| | | Preprogrammed physician advised patterns |
| | | Shouting |
| | | Crashes, gunshots, explosions, vehicle crashes, strange dog barking, |
| | | personal assaults, etc. |
| 29 | Local or remotely operated “Walking | The National Institute of Health (N1H) reports the following on the NIH |
| | Light ™” for walking in dimly lit or unlit | Senior Health website |
| | areas, or to aid vision in dimly lit or unlit | http://nihseniorhealth.gov/falls/aboutfalls/01.html |
| | areas. Provides manual, automatic, and/or | “More than one in three people age 65 years or older falls each year. The risk |
| | voice controlled on/off and adjustable | of falling - and fall-related problems - rises with age. Each year, more than |
| | brightness illumination control. Refer to | 1.6 million older U.S. adults go to emergency departments for fall-related |
| | FIGS. 11, 12, 13 and 15 (below). | injuries. Among older adults, falls are the number one cause of fractures, |
| | | hospital admissions for trauma, loss of independence, and injury deaths.” |
| | | The NIH specifically recommends “to make sure that you have adequate light |
| | | is dark areas.” Aging seniors on fixed incomes routinely try to save money |
| | | by turning off lights at night. The nocturnal walk to and from the bathroom, |
| | | kitchen, put out the pet, etc. can lead to treacherous consequences. |
| | | Local or remotely operated “Walking Light ™” to aid walking in dimly lit |
| | | areas, or to aid vision in dimly lit areas. |
| | | Manual, automatic, and/or voice controlled on/off and adjustable brightness |
| | | illumination control. |
| | | Hands-free “Walking Light ™” that is suspended from the neck of the user |
| | | or worn with a belt clip, or other attachment means to the user's garments. |
| | | This allows the user both hands to balance and/or touch or grab surfaces to |
| | | maintain stability, use a walking cane, or walker. |
| | | Projects light over a wide dispersion angle to improve visibility and reduce |
| | | vertigo during walking caused by the appearance of ‘moving’ shadows in the |
| | | visual field due to motion of the LiveCare ™ ECS Pendant while the patients |
| | | walks or moves. |
| | | The Walking Light ™ and Reading Light ™ (below) provide illumination for |
| | | a remote individual or caregiver on a videoconference with the user to see or |
| | | examine the user under any ambient lighting conditions. |
| | | Can be handheld for directing illumination in dimly lit areas or on dimly lit |
| | | surfaces. |
| | | Can be remotely operated via the Internet and/or cellular network for remote |
| | | assistance by a caregiver or other person assisting the user. |
| | | On/off light control and/or continuously variable light illumination control. |
| | | Automatic walking and/or standing detection and ambient light sensors turn |
| | | on the “Walking Light ™” in dimly lit environments. |
| | | Automatic battery capacity notification to notify the user and/or remote |
| | | caregiver of remaining illumination time (including audio annunciation). |
| | | Automatic battery fuel gauge can reduce other ECS features and/or reduce |
| | | the illumination level (with user permission) if the battery is critically low to |
| | | preserve battery life. |
| | | LiveCare ™ ECS Pendants can also interface to facility automation |
| | | networks via ZigBee, Z-Wave, other wireless technologies, and/or the LAN |
| | | to automatically control facility lighting as the user walks through their |
| | | house. |
| | | Hands-free “Walking Light ™” that is suspended from the neck of the user |
| | | and is optimally positioned near the waist area of the user: |
| | | Comfortable reach location for the Help button considering the limited |
| | | range of motion and manual dexterity of senior or infirm individuals. |
| | | Natural distance to reach with minimal upper arm and hand exertion. |
| | | Light path is not obstructed or misdirected by the abdomen of an obese |
| | | person |
| | | Light can shine directly at and in front of feet, Necklace or lanyard neck |
| | | strap allows sufficient slack for a person to hold the LiveCare ™ ECS |
| | | Pendant at an optimal distance for viewing the display and/or using their |
| | | fingers to touch the touch sensitive screen. |
| | | Natural length for resting hands on lap or legs to view and or use the |
| | | touchscreen. |
| | | Decreases susceptibility for electrical interference with pacemaker and/or |
| | | ECG patch electrodes in the vicinity of the chest or abdomen. |
| 30 | Local or remotely operated “Reading | Manual and/or voice controlled operation and brightness control. |
| | Light ™” for reading in dimly lit | Can be remotely operated via the Internet and/or cellular network for remote |
| | environments. Refer to FIGS. 11, 12, 13 | assistance by a caregiver or other person assisting the user. |
| | and 15 (below). | Automatic battery capacity notification to notify the user and/or remote |
| | | caregiver of remaining illumination time (including audio annunciation). |
| | | Automatic battery fuel gauge can reduce other ECS features and/or reduce |
| | | the illumination level (with user permission) if the battery is critically low to |
| | | preserve battery life. |
| 31 | One button and voice controlled call for | 24/7/365 Technical Help line monitoring by LiveCare ™ ECS to assist the |
| | technical help. | caregiver in device connectivity, configuration, operation, and problem |
| | | resolution. |
| | | Facilitates nurse efficiency and training. |
| | | Full escalation from receptionist, trainer, support technician or engineer as |
| | | required. |
| 32 | Walking Collision Avoidance | Advanced real-time walking collision avoidance circuitry and software to |
| | | alert user that they are approaching collision with an object (wall, other |
| | | person, etc.). |
| | | Distance sensor and automatic low light sensor and accelerometer or other |
| | | motion detection hardware, and associated software algorithm to enable |
| | | collision avoidance in dimly lit environments while walking. |
| | | Can be configured for automatic collision avoidance anytime the user is |
| | | walking to assist mentally and/or visually impaired individuals. |
| 33 | Remote Device Setup & Configuration | Modern smartphones can require extensive setup and configuration settings to |
| | | configure the smartphone for use by a senior. The LiveCare ™ ECS and |
| | | LiveCare ™ ECS Pendant allow remote programming and setup by a remote |
| | | Call Center, caregiver, authorized family member or friend. |
| 34 | Remote Video Monitoring and Recording to | |
| | allow an authorized caregiver, family | |
| | member, or friend to record video or take | |
| | photos. | |
| 35 | HIPAA compliant caregiver or physician | |
| | consultation audio and/or video recording. | |
| 36 | Services Feature with automated signaling | Touchscreen button (or buttons) or voice operated call from the LiveCare ™ |
| | to a Home Care or Home Health Care | ECS or LiveCare ™ ECS Pendant that automatically signals a Home Care |
| | Agency or other service providers | Agency, Home Health Care Agency, other service provider and/or Central |
| | (including Assisted Living and Nurse Call | Station that personal service is requested by a user. These requests and |
| | Stations). | resulting services may or may not be medically reimbursable. A LiveCare or |
| | | service provider computer and display system with LiveCare software |
| | | automatically manages and displays these requests. Request that are not |
| | | adequately acknowledged, assigned and/or resolved within preset time limits |
| | | may be routed to a Central Station for reassignment or resolution. HIPAA |
| | | compliant cloud-based servers can store all personal history, contact history, |
| | | and service requests for immediate access by the service providers. |
| | | The aforementioned service providers help adults, seniors, and pediatric |
| | | clients that may be recovering after a hospital or facility stay, or need |
| | | additional support to remain safely at home and avoid unnecessary |
| | | hospitalization. Medicare-certified services may include short-term nursing, |
| | | rehabilitative, therapeutic, and assistive home health care. These services |
| | | may be provided by registered nurses (RNs), licensed practical nurses |
| | | (LPN's), physical therapists (PTs), occupational therapists (OTs), speech |
| | | language pathologists (SLPs), home health aides (HHAs), medical social |
| | | workers (MSWs), or other authorized caregivers through the Medicare |
| | | Home Health benefit. |
| | | Services requests may include but are not limited to the following categories: |
| | | Housekeeping |
| | | Nurse |
| | | Food |
| | | Doctor |
| | | Example services for these categories may include: |
| | | Housekeeping - Certified Nursing Assistant (CNA) |
| | | Change bedding. |
| | | Clean house. |
| | | Laundry. |
| | | Bathing support. |
| | | Change diaper. |
| | | Nurse - Registered Nurse (RN) |
| | | Wound dressing. |
| | | Medical Therapies. |
| | | Administer medications. |
| | | Bloodwork. |
| | | Food |
| | | Food delivery. |
| | | Doctor |
| | | Prescriptions. |
| | | Medical consultations. |
| 37 | Services Feature with professional (non- | One click or voice operated call to a local and/or national Call Services |
| | medical) support | Center that provides personal concierge and companion services 24/7/365 |
| | | via two-way audio and/or videoconferencing. |
| | | Secure Cloud-based servers store all provided personal history, and contact |
| | | history for immediate access by a LiveCare or third party Services |
| | | Representative (SR). |
| | | The SR provides a wide range of professional (non-medical) personal services |
| | | that may include but are not limited to: |
| | | On demand and/or routine visitations via two-way audio and/or |
| | | videoconferencing. |
| | | Provide friendly chat and companionship. |
| | | Plays a board game, card game, or electronic game with the user. |
| | | Administer routine cognitive and memory training as per caregiver |
| | | instructions. |
| | | Etc. |
| 38 | Automatic videoconferencing downgrading, | During a videoconference, if the displayed video degrades as reported by |
| | including downgrading to an audio only | communication diagnostics, the videoconference display resolution is |
| | call. | automatically adjusted to maintain the videoconference session. If the |
| | | communication diagnostic indicates that there is inadequate quality to |
| | | maintain the videoconference, the call can be selectively automatically |
| | | downgraded to an audio-only call. The videoconference is automatically |
| | | reinitiated if communication diagnostics report favorable conditions. If the |
| | | audio signal degrades as reported by communication diagnostics, the call can |
| | | be selectively automatically terminated and reconnected via a cellular voice |
| | | call (if previously authorized) to maintain communications. |
| | | The Family Application will have a GUI button that can terminate a video call |
| | | (Wi-Fi or Cellular) and switch to and reconnect via a cellular voice call. |
| 39 | Wireless Inductive Charger for LiveCare ™ | Wireless Inductive Charger that is magnetically attached and aligned to the |
| | ECS Pendant | LiveCare ™ ECS Pendant for safely charging the LiveCare ™ ECS Pendant |
| | | while being worn and operated. |
| 40 | Smoke and Carbon Monoxide (CO) | Integrated Smoke Detector and CO Detector with audible and visual alerts |
| | Detection | for the user and Central Station monitoring. |
| 41 | Novel Integrated necklace (or lanyard) with | The width of the attachment feature on the LiveCare ™ ECS Pendant is |
| | pull detection circuitry for emergency | optimized to naturally orient the LiveCare ™ ECS Pendant to face forward |
| | signaling (refer to FIG. 11, 12, 13, 14 and | while sitting and walking: |
| | 15, below) | Positions Walking Light ™ to illuminate in front of the user. |
| | | Positions the Call for help button forward for ease in locating by the user. |
| | | Positions the Microphone and Amplified Speaker for optimal audio quality |
| | | and speaker volume. |
| | | The length of the necklace or lanyard is adjusted at an optimal location on the |
| | | user to provide: |
| | | Unobstructed light from the Walking Light ™ for maximum visibility in |
| | | dimly lit and unlit areas. |
| | | Easy distance to reach for users with limited range of motion or physical |
| | | strength to lift arms. |
| | | Large distance over which the user can adjust the viewing distance to read |
| | | controls and the Touch Screen Display. |
| | | Decrease susceptibility for electrical interference with pacemaker and/or ECG |
| | | patch electrodes in the vicinity of the chest or abdomen. |
| 42 | Novel necklace (or lanyard) pull detection | The user may have difficulty locating the Call for Help button in an |
| | circuitry that initiates an emergency call for | emergency situation. |
| | help if the LiveCare ™ ECS Pendant is | The LiveCare ™ ECS Pendant inciudes integrated necklace (or lanyard) pull |
| | pulled away from the necklace or lanyard, | detection circuitry that initiates an emergency call for help if the LiveCare ™ |
| | and/or if the pulling force on the | ECS Pendant is pulled away from the necklace or lanyard. |
| | LiveCare ™ ECS Pendant exceeds a preset | Additional embodiments include integrated sensors to detect a pulling force |
| | limit. | on the LiveCare ™ ECS Pendant that exceeds a preset limit that initiates an |
| | | emergency call. |
| 43 | Integration to an existing facility “wired” | LiveCare ™ ECS and LiveCare ™ ECS Pendants provide emergency call |
| | Nurse Call Emergency System (such as | requests to the Nurse Call Station (also refer to Item 2, above). |
| | Jeron Provider 680 and 790 | Signal non-emergency service requests to the front nursing station, Central |
| | www.Jeron.com) | Operator Station, or Remote Central Station such as Housekeeping, Food, |
| | | Pain, Water or Nurse (also refer to Item 36, above). |
| | | Provide wireless 2-way voice communication between the patient/resident |
| | | to the nursing station from anywhere in the facility (also refer to Item 2, |
| | | above). |
| | | Integration with the patient information system (HL7, etc.). |
| | | Integrations with the local Electronic Medical Record (EMR). |
| | | LiveCare ™ ECS Pendants include integrated fall detection circuitry and |
| | | software to signal an emergency call due to falling. |
| | | Ability to signal emergency call requests anywhere in indoor or outdoor |
| | | areas. |
| 44 | Integration to facility Emergency Call | LiveCare ™ ECS and LiveCare ™ ECS Pendants can be integrated with |
| | Systems for Assisted Living and | wired and wireless emergency call signaling hardware and systems. |
| | Independent Living Facilities (UL 2560 or | Integration with bed/puil stations located in the residents living area. |
| | equivalent) and Hospital Signaling and | Integration with local, central, and remote nursing stations, front desk |
| | Nurse Call Equipment (UL 1069 or | operators, and remote Central Stations. |
| | equivalent). | |
| 45 | Advanced location technologies and | LiveCare ™ ECS Pendants incorporate advanced GPS, Wi-Fi and other |
| | integration with facility Wandering | location technologies to precisely locate a user or resident that wanders |
| | Prevention Systems, remote caregivers, and | outside of a predetermined area or facility. |
| | remote Central Stations | Provides two-way and/or multiparty audio communication with the |
| | | wandering user or resident to help redirect or detain them at the current |
| | | location to mitigate endangerment to the individual. |
| | | Provides two-way and/or multiparty video conferencing with the wandering |
| | | user or resident to visually confirm their current location and facilitate |
| | | personal communication to help redirect or detain them at the current |
| | | location to mitigate endangerment to the individual. |
| 46 | Advanced pendant position/situational | Pressure and/or deformation sensors can detect and alert when the pendant |
| | detection | is trapped underneath the wearer. |
| | | Vibration detection (alone or combined with pressure and/or deformation |
| | | sensor event) can detect and alert patient cry for help or other vibrational |
| | | information including elevated heart rate. |
| | | Motion sensor can alert if pendant ceases movement for predetermined |
| | | period of time. |

LiveCare™ ECS and LiveCare™ ECS Pendant Additional Features

Embodiments of the LiveCare™ ECS and LiveCare™ ECS Pendants may be classified under Medical Device Data Systems (MDDS) FDA Class I medical devices for remote patient monitoring as per:
DEPARTMENT OF HEALTH AND HUMAN SERVICES
Food and Drug Administration
21 CFR Part 880
[Docket No. FDA-2008-N-0106] (formerly Docket No. 2007N-0484)
Medical Devices; Medical Device Data Systems

The LiveCare™ ECS and LiveCare™ ECS Pendants are used to interface a wide range of wired and wireless biometric sensors and medical devices for remote patient monitoring in the Post-Acute Care and Chronic Disease Management markets in: nursing homes, assisted living homes, long term care, patient residences, and other similar environments. In addition, the LiveCare™ ECS and LiveCare™ ECS Pendants incorporate multiparty two-way audio and/or videoconferencing and other advanced features to facilitate billable doctor/patient consultations; remote nurse, caregiver, and family visitations; and embedded artificial intelligence for patient management and medical compliance.

Several performance parameters (e.g. video resolution) can be automatically adjusted during degraded Internet connectivity bandwidth and/or during cellular Internet connection to maintain adequate communications, or to limit data throughput for cost savings if required. The LiveCare™ ECS and LiveCare™ ECS Pendants can also interface to facility automation networks via ZigBee, Z-Wave, other wireless technologies, and/or the LAN.

Embodiments of the LiveCare™ ECS and LiveCare™ ECS Pendants are also intended for use as a FDA Class II medical device for “Active Patient Monitoring” under a FDA 510K submittal for use in hospital ICU and other critical medial environments.

Wireless charging base and example accessories are shown in FIGS. 12A-12F.

Industrywide Problem for Remote Patient Monitoring

There are numerous single parameter and multi-parameter biometric sensors and medical devices for remote patient monitoring. However, many different companies having incompatible proprietary firmware, software, and/or connecting hardware or software throughout their architectures from the remote medical device via the Internet Cloud to the caregiver's application software. In addition, the current gateways and hubs that interface the biometric sensors and medical devices to the Cloud were designed for remote patient monitoring in patient residences. As such, these devices are not suitable in multi-bed nursing homes to connect (pair) peripheral Bluetooth devices with multiple hubs that are in close proximity to each other and to other peripherals.

Typical problematic architecture is shown in FIG. 13.

Potential Problems of Connecting Peripheral Bluetooth Device with Multiple Hubs in Nursing Homes and Assisted Living Facilities

FIG. 14 illustrates the potential problems in nursing homes with connecting (pairing) peripheral Bluetooth devices with multiple hubs that in close proximity to each other and to other peripherals. The Bluetooth RF signals can travel up to 30 feet through air and walls which can complicate setup and assurance that the correct medical device is associated with a specific patient.

LiveCare™ ECS and LiveCare™ ECS Pendants Interface to a Wide Range of Biometric Sensors

The LiveCare™ ECS and LiveCare™ ECS Pendant are novel medical grade devices that interfaces a wide range wired and wireless biometric sensors and medical devices to the Cloud via redundant communication pathways. They include advanced features to allow use in multi-bed facilities or residences. The biometric sensors and medical devices that can be interfaced to the LiveCare™ ECS or LiveCare™ ECS Pendant include, but are not limited to the following:
Physical and/or Mental Activity Monitors
Blood Pressure Cuffs and Sensors
Blood Glucose Sensors and Systems (Glucometers)
Single and multi-lead ECG Patch
5 Lead ECG
12 Lead ECG
Dermascopes
Endoscopes
Ophthalmoscope
Otoscopes
Pulse Oximeters
Spirometers
Stethoscopes
Ultrasound Sensors and Systems
Weight Scales
Weight Scales and Body Composition Scales and Systems

Interfacing medical devices to the Cloud with the LiveCare™ ECS and LiveCare™ ECS Pendant are shown in FIG. 15.

LiveCare™ ECS and LiveCare™ ECS Pendants interface a wide range of OEM medical sensors and medical devices via multiple Cloud Portals as shown in FIG. 16.

Example Devices that interface with the LiveCare™ ECS or LiveCare™ ECS Pendant are shown in FIG. 17.

LiveCare™ ECS and LiveCare™ ECS Pendant integration with nurse call systems; standard nurse call system and current options as shown in FIG. 24.

LiveCare™ ECS and LiveCare™ ECS Pendant integration with medical devices and a nurse call system is shown in FIG. 19.

LiveCare™ ECS Pendant Concept Designs are shown in FIG. 20.

LiveCare™ ECS Pendant Concept, Skilled & Homecare are shown in FIG. 21.

LiveCare™ ECS Pendant Concept, Skilled is shown in FIG. 22.

LiveCare™ ECS Pendant Concept, Homecare is shown in FIG. 23.

LiveCare™ ECS Pendant displayed in the orientation while suspended from the neck of the user with a necklace or lanyard is shown in FIG. 25.

Desirable location and height for wearing the LiveCare™ ECS Pendant is shown in FIG. 26.

Undesirable location and height for wearing LiveCare™ ECS Pendant is shown in FIG. 27.

Woman wearing graphically simulated LiveCare™ ECS Pendant with necklace is shown in FIG. 28.

LiveCare™ ECS Pendant displayed in the orientation when held in the hand and operated by the user is shown in FIG. 29.

LiveCare Corp.

Provisional Patent for an Emergency Call System with Integrated Biometric Sensors and Monitoring

Authors: Peri Avitan, Robert J. Benetti, Bryan T. Benetti, and Robert A. Benetti

Contents

Overview

Health Care Signaling Equipment (including Medical Alerts) Personal Emergency Response Equipment, Emergency Call Systems, and Hospital Signaling and Nurse Call Equipment comprise a wide range of individual components and systems that are used to electronically signal to another individual or caregiver, multiple individuals or caregivers, and/or a Central Station that they are in need of personal assistance or medical assistance for both routine and acute emergency situations in a wide range of environments, including:
Personal residences and their surrounding property.
During out of home excursions and travel.
During temporary or extended stays in assisted living and independent living facilities.
In hospitals and other acute care facilities.
Etc.

All of the above types of systems will be referred to herein as Emergency Call Systems (ECS).

An ECS is typically accompanied by a portable call initiation station (pendant) which may be handheld, body worn, or attached to a person's clothing. These pendants provide assistance request or emergency request signaling to the ECS and/or directly to a preprogrammed phone number or Central Station via wireless technology (RF, Wi-Fi, cellular, etc.).

All of the various types of pendants will be referred to herein as ECS Pendants.

The various types of ECS and ECS Pendants are certified by domestic safety standards that are published by Underwriters Laboratory (UL) and similar international standards for various usages and operating environments:
a. UL 1637 Home Health Care Signaling Equipment.
b. UL 1698 Personal Emergency Response Equipment—(proposed standard)
c. UL 2560 Emergency Call Systems for Assisted Living and Independent Living Facilities.
d. UL 1069 Hospital Signaling and Nurse Call Equipment.

These standards have different safety and operational performance requirements for the various usage scenarios and operating environments. Please refer to FIG. 10 for the following discussion:

The dashed lines around the environments covered under UL 1637 and UL 1698 (proposed standard) represents that these environments are currently using ECS and/or ECS Pendants that communicate ECS signaling to another individual or individuals, caregivers, or a Central Station via the public switched telephone network (PSTN) or cellular network.

UL. 1637 Home Health Care Signaling Equipment
[The following was excerpted from UL 1637]

1 Scope

1.1 These requirements cover the individual units that comprise a home health care system intended for use in ordinary indoor residential locations.
[Note that this requirement specifically states “for use in ordinary indoor residential locations” with no allowance for outdoor use, or the multitude of complex environments that will be addressed in the proposed UL 1698 standard]

1.2 These requirements also cover a complete home health care system in which a signal initiating device (both routine monitoring and medical emergency signals) may be connected directly or indirectly to receiving equipment at a residence or to continuously monitored receiving equipment at a central supervising station. The system is arranged so that a predetermined change in the status of the signal initiating circuits or devices automatically causes transmission of a signal over a communication channel to receiving equipment at a residence, to a central supervising station, or to a private telephone number.
[Note that this requirement states: “transmission of a signal over a communication channel . . . ” with no definitive safety or performance requirements in the standard for communication over cellular networks which will be addressed in the proposed UL 1698 standard]

1.3 The components of the home health care system may include signal initiating devices, control units, transmitters, and digital communicators, all located at the residence, and the receiving, processing, and displaying equipment located at the central supervising station.
[Note that this requirement states: “may include signal initiating devices, control units, transmitters, and digital communicators, all located at the residence . . . ” with no definitive safety or performance requirements in the standard for devices used outside of the residence and communication over cellular networks which will be addressed in the proposed UL1698 standard]

UL 1698 Personal Emergency Response Equipment (proposed)
[The following was excerpted from the proposed Scope for UL 1698]

Scope

Covers application, construction, and performance of equipment utilized in personal emergency response systems. The purpose of this standard is to define the means of signal initiation, transmission, notification and annunciation; level of performance; and the reliability of various types of personal emergency response systems. The standard also defines the features associated with these systems.
[This is a proposed UL standard that is currently under development and not yet published as of Mar. 29, 2016.
It is not specifically stated in the above Scope, however, the Scope will include the wide range of environments illustrated in FIG. 10 and include cellular communication and advanced locating technologies that includes GPS for: single and multilevel (aka multi-floor) personal residences, apartments, hotels, cities with high rise building, shopping malls, multistory buildings, multilevel and underground roadways and parking garages, rural areas, parks, recreation areas, traveling in vehicles, etc.]

UL 2560 Emergency Call Systems for Assisted Living and Independent Living Facilities
[Referring to FIG. 10 the solid line around the environments covered under UL 2560 represents that these environments are currently not using ECS Pendants for ECS signaling, two-way voice communication, and alarm clearing via PSTN, Internet, cellular network, or other method of communication to caregivers or a Central Station that are remotely located.]

[The following was excerpted from UL 2560]

1 Scope

1.1 These requirements cover the individual unit employed to form assisted and independent living emergency call systems (ECS) intended to provide audible and visual signaling between residents and assisted and independent living facility staff. Some examples include call initiation stations, call notification stations, and power supplies.
[Note that under the following section 40.2.1 b of UL 2560 (below) it states, “A required battery trouble call shall be transmitted to the receiver for a minimum of 7 days before the battery capacity of the transmitter has depleted to a level insufficient to maintain proper non-call operation of the transmitter.” There is also a battery life performance test under section 41.1.1 (see below) to ensure that the ECS Pedant meets this requirement. As such, by using a single low power RF transceiver and battery as in the current competitive product offerings it is not feasible to include two-way audio and/or videoconferencing capability into an ECS Pendant. The LiveCare™ ECS Pendant uses a novel dual transceiver/dual battery design and/or a novel battery management system that provides UL 2560 compliant ECS signaling and concurrent two-way audio and/or HIPAA compliant videoconferencing in the same ECS Pendant (see LiveCare™ ECS and LiveCare™ ECS Pendant, below)]

40.2.1 A primary battery is not prohibited from being used as the sole source of power for a low-power radio transmitter when all of the following conditions are met:
a) The capacity of the primary battery shall be monitored for integrity. The battery shall be monitored while loaded by:
   1) Transmission of the transmitter or
   2) A load equivalent to the load imposed by transmission.
b) A required battery trouble call shall be transmitted to the receiver for a minimum of 7 days before the battery capacity of the transmitter has depleted to a level insufficient to maintain proper non-call operation of the transmitter.
It is acceptable for the battery trouble call at the call notification station to be initially delayed up to 24 hours.
c) The battery of a transmitter shall be capable of operating the transmitter in its normal supervisory mode and placing a single emergency call per day, each call remaining for 5 minutes before it is reset, for a published manufacturer specified length of time before the battery depletion threshold specified in (b) is reached.

41 Primary Batteries Test

41.1 Life Test

41.1.1 When a primary battery is used as the main source of power for a low power radio transmitter, it shall provide power to the unit under intended ambient conditions for the manufacturers specified battery life using the normal signaling performance as described in 40.2.1(c) and then operate the transmitter for a minimum of 7 days of trouble signal. Data on battery life, including discharge curves, shall be provided for the investigation to evaluate battery performance characteristics.

UL 1069 Hospital Signaling and Nurse Call Equipment
[Referring to FIG. 10 the solid line around the environments covered under UL 1069 represents that these environments are currently not using ECS Pendants for ECS signaling, two-way voice communication, and alarm clearing via the PSTN, internet, cellular network, or other method of communication to caregivers or a Central Station that are remotely located.]

1 Scope

1.1 These requirements cover the individual units employed to form a hospital nurse call system (NCS) intended to provide audible and visual communication between patients and hospital personnel. They also cover miscellaneous signaling equipment employed in hospitals. Some examples include bedside tables, annunciators, power supplies for nurse call systems, and gas monitoring units.

[Note that under the following section 49.2.1 b of UL 1069 (below) it states, “A required battery trouble call shall be transmitted to the receiver for a minimum of 7 days before the battery capacity of the transmitter has depleted to a level insufficient to maintain proper non-call operation of the transmitter.” There is also a battery life performance test under section 50.1.1 (see below) to ensure that the ECS Pedant meets this requirement. As such, by using a single low power RF transceiver and battery as in the current competitive product offerings it is not feasible to include two-way audio and/or videoconferencing capability into an ECS Pendant. The LiveCare™ ECS Pendant uses a novel dual transceiver/dual battery design and/or a novel battery management system that provides UL 1069 compliant ECS signaling and concurrent two-way audio and HIPAA compliant videoconferencing in the same ECS Pendant (see LiveCare™ ECS and LiveCare™ ECS Pendant, below)]

49.2 Primary Batteries

49.2.1 A primary battery is not prohibited from being used as the sole source of power for a low-power radio transmitter when all of the following conditions are met:
a) The capacity of the primary battery shall be monitored for integrity. The battery shall be monitored while loaded by:
   1) Transmission of the transmitter or
   2) A load equivalent to the load imposed by transmission.
b) A required battery trouble call shall be transmitted to the receiver for a minimum of 7 days before the battery capacity of the transmitter has depleted to a level insufficient to maintain proper non-call operation of the transmitter. It is acceptable for the battery trouble call at the Primary Nurse Control Station to be initially delayed up to 4 hours. The battery trouble annunciation shall be retransmitted at intervals not exceeding four hours until the battery is replaced.
c) The battery of a transmitter shall be capable of operating the transmitter for a published manufacturer specified length of time of normal annunciating service before the battery depletion threshold specified in (b) is reached.

50 Primary Batteries Test

50 added Oct. 12, 2007 issued Oct. 12, 2007

50.1 Life Test

50.1.1 When a primary battery is used as the main source of power for a low power radio transmitter, it shall provide power to the unit under intended ambient conditions for a manufacturer's published normal signaling service battery life and then operate the product for a minimum of 5 minutes of call, followed by 7 days of trouble signal. Data on battery life, including discharge curves, shall be provided for the investigation to evaluate battery performance characteristics.

Current ECS and ECS Pendant Environments are shown in FIG. 10.

LiveCare™ ECS with Integrated Biometric Sensors and Monitoring (ECS-M)

Please refer to FIGS. 30 through 33 for the following discussion:

The LiveCare™ ECS-M incorporates novel design elements to provide both common and reconfigurable hardware and software that can provide physiological biometric monitoring as well as domestic and international compliant ECS signaling for all usage scenarios and operating environments, including:
1. Advanced multiparty two-way audio conferencing for:
   Communication with remote caregivers for ECS alarm clearing.
   Consultations with remote caregivers.
   Communication with remote family and friends.
2. Non-HIPAA compliant and/or HIPAA compliant two-way and/or multiparty videoconferencing for:
   Billable remote patient monitoring, performing audio and visual medical examinations, and medical consultations.
   Videoconferencing with remote family and friends as allowed in the particular environments.
3. Integrated biometric sensors (and wireless communication with other external biometric sensors) and associated software algorithms to monitor and retransmit physiological data to a smart phone, personal computer caregiver and/or central monitoring station. Embodiments of the ECS-M include software algorithms to analyze the central monitoring station of physiological conditions that are out of preset remotely programmable thresholds which may require user modification of physical and/or mental activity, medical intervention, or emergency medical response e.g. emergency signaling to a caregiver, e911, 911, etc.

Example of a LiveCare ECS-M is shown in FIG. 30.

Integrated Biometric Sensors and Wireless Connectivity to a Wide Range of OEM and LiveCare Biometric Sensors are shown in FIG. 31.

Integration in Assisted Living and Nurse Call Systems is shown in FIG. 32.

Integration in Assisted Living and Nurse Call Systems with Wireless Connectivity and LiveCare Biometric Sensors is shown in FIG. 33.

### Personal Medical Device

### Background and Summary

The present invention relates generally to portable devices and specifically to such devices used in the consumer and healthcare industry for remote patient communication and emergency situations.

Elderly persons are not typically technically savvy; nor are they adept at using portable devices. Poor eyesight and physical dexterity leave them unable to use most devices. The notion of using such devices oftentimes strikes the elderly with fear resulting in reluctance or refusal to use such devices. Children share many of these characteristics, and therefore can also benefit from this invention.

Seniors are constantly exposed to a barrage of emerging technologies that can overwhelm the aging brain, and are contending with diminishing manual dexterity and functionality of their nervous system and musculoskeletal physiology. The present invention has a wide range of novel features and technical advancements to facilitate simplified uniform operation that improves the quality of life and extends independent living for as long as practical. The skill sets learned in their home and other environments will eventually transition with them into assisted living facilities and/or nursing homes, hospitals, or acute care facilities without having to relearn or simply give up on what can pose daunting mental and physical learning obstacles.

The ubiquitous nature of the internet, and technologies that take advantage of it, presents opportunities to remotely engage and/or help the elderly who are oftentimes unable or unwilling to travel. Thus, there is a need for devices and systems that take advantage of modern technology, and are usable by the elderly.

The present invention is a novel wearable mobile personal emergency response system (mPERS) smart pendant for providing timely healthcare and personal services to the user. In addition to mPERS signaling, the pendant includes wireless automatic signaling in assisted living and other medical facilities, and personal residences for home healthcare and other personal services, intended to be compliant with all of the current UL, standards: UL 1637 Home Health Care Signaling Equipment (as applicable) UL 2560 Emergency Call Systems for Assisted Living and Independent Living Facilities, and UL 1069 Hospital Signaling and Nurse Call Equipment; and the forthcoming UL 1698 standard that is being developed by the UL Standards Technical Panel for Personal Emergency Response Equipment (STP 1698) UL 1698 Personal Emergency Response Equipment. The intended user of the present invention is an individual in an assisted living facility (ALE) or other medical facility, under home healthcare supervision in their residence, or a parent or child that is being cared for by family members or friends. The operation of the present invention is intended to require minimal physical dexterity, eyesight, mental acuteness, and/or specialized training to setup, operate, or interconnect with the present invention.

Some features of one embodiment of the present invention include: The device (aka mobile device, or pendant) has only one mechanical button (aka hardware button, or control button) that is used to initiate a call for urgent assistance to a central station monitoring center, ALF call notification station, ALE designated number, nurse call station, and/or caregiver; continuous automatic fall detection initiates an emergency call for assistance to a central station monitoring center, ALF call notification station, ALF designated number, nurse call station, and/or caregiver; automatic power on, power recovery, power management, and battery monitoring features with low battery status signaling to the central station monitoring center, ALF call notification station, ALF designated number, nurse call station, and/or caregiver; an LCD touch screen (aka LCD) is automatically turned on by rotating the pendant for normal viewing (see FIGS. 3A through 3D), by tapping on the pendant, by shaking the pendant, or by simply moving the pendent (in a user-sleep mode); the LCD turns off automatically and the processor(s) go to a low power mode when the pendant is rotated back to the normal resting position (aka dormant mode), suspended by the lanyard, or after a programed timeout due to inactivity in order to conserve battery capacity; large high contrast fonts and capacitive touchscreen buttons (distinguished from mechanical button) on a high brightness LCD with automatic and remotely controllable (by caregiver) brightness control that offers several advantages, including allowing the caregiver to illuminate the user's face via the LCD brightness; amplified speaker with local volume control (slider on LCD) and remotely controllable by a caregiver; wireless battery charging from any Qi compliant battery charger; wireless interface to accessories, computers, smartphones, etc. (optional Bluetooth); Remote pendant setup and control by authorized caregivers; the touch screen having icons or control components that can be remotely acted upon by a caregiver (e.g. temporarily enlarging the size of the icon, or temporarily amplifying the brightness of the icon), can facilitate the remote caregiver teaching the user how to use the present invention.

### Remote Setup

In one embodiment, the present invention can be remotely programmed or setup by a caregiver, or family member, with the following information and/or features: personal account information; emergency call phone numbers including call sequence, timeouts, automatic messages, etc; audio/video calling configuration to designated caregivers, family members, or friends for two-way audio or audio/videoconferencing; default LCD brightness and contrast controls: default video digital zoom value; default speaker volume; default display profile, font colors, font contrast, and language (English, Spanish, French, German, custom, etc.); alert types (ring tones, alert tones); individual volume controls: LCD display timeout controls; default wake up alarms, alarm sounds; display wakeup controls (tilt angle, tap and shake sensitivity, timers, etc.); fall detection profile and sensitivity; default GPS locations: ALF facility location, home location, and other locations; GPS tracking features; event logging features; pedometer features, and sensitivity controls.

### Remote Control

In one embodiment, the present invention can be remotely controlled by a caregiver, or family member, as follows:

Speaker volume: if the user expresses difficulty in healing the caregiver during a two-way audio call, they can adjust the audio volume with an on-screen touch slider, or the remote caregiver can remotely adjust the audio volume on the device during the call. The remote caregiver can also adjust the default audio volume for all calls (see “Remote Setup”).

LCD brightness: if the user expresses difficulty in seeing their LCD display during a video call, they can adjust the LCD brightness with an on-screen touch slider, or the remote caregiver can remotely adjust the LCD brightness on the pendant during the call from their application on a remote device. The remote caregiver can also adjust the default LCD brightness and contrast (see “Remote Setup”).

Video digital zoom: the remote caregiver can adjust the video digital zoom from their application to see a close up view' of the user's face, skin, eyes, etc. for general viewing or diagnostic purposes. The remote caregiver can also adjust the default video zoom value for all video calls (see Remote Setup).

Pendant Locate: remote caregiver can make the pendant vibrate and/or sound a loud beeping sound so that the pendant can be located by the user. The remote caregiver can also initiate a video call to observe the camera, view and hear sounds in the vicinity of the pendant to assist in locating the pendant.

Unattended audio or audio/video conferencing: The remote caregiver (or family member that is concerned or otherwise unable to contact the user) can initiate and automatically connect an audio or audio/videoconference (the camera, microphone, and speakers can be remotely activated) with the pendant. The pendant user does not need to answer or authorize the call (in some embodiments), or rotate, tap or shake the pendant to answer the call. In one embodiment, the user is presented with a warning on the LCD that the device is about to be remotely controlled, so that the user can override or stop said control.

### MCU Embedded Software Summary

In one embodiment, the following embedded software functionality is available in the MCU: low power MCU modes are optimized for the various scenarios described herein; power on, watchdog recovery, or recovery from discharged battery features are also incorporated; accelerometer configuration; accelerometer magnetometer (or gyro) configuration; audio CODEC configuration; cellular module configuration; GPS configuration; pressure/altitude sensor configuration; APU reset; accelerometer fall detection algorithm; accelerometer shake detection algorithm; accelerometer magnetometer (or gyro) pendant orientation/tilt detection algorithm to wake up APU; call button debounce logic to wake APU (consideration for RC network); MCU communication software for mPERS data signaling, monitoring center server acknowledgment handshake, and remediation in the event of communication failures; MCU initiate and control 2-way audio call, and remediation in the event of call failure; MCU interface to APU; valid cellular connection annunciation with bi-color LEDs; event logging in I2C FLASH memory; battery SOC and notification to server or APU data sharing; prerecorded audio annunciations.

### Other Objects and Advantages

One object of the present invention is to address signaling/communication and GPS & non-GPS/horizontal location, indoors not at home/vertical location, and accuracy/minimum # of satellites, including considerations implicated by the development of UL 1698.

As a mobile device, the location of a reportable event must be provided to the monitoring center. The location may be determined utilizing various technologies such as GPS, beacons, Wi-Fi, etc. Since the device of the present invention by nature is mobile, communications and location may not always be determined with 100% accuracy. Therefore, it is important to provide the user and call center with an indication whether cell service is available or not, an indication that a call for help is in progress, and whether or not the call was successful. In addition, since current location may not be determined accurately, the device should be capable of reporting the last known location and the time of known location to a monitoring center when a call for help is made. Due to the vagaries of mobile communications, the elapsed time between the call being initiated and terminating into the monitoring center should also be reported.

The communications link is vital. The device must ping (test connectivity) the database at least once every 24 hours. If connectivity fails, the device must indicate that it is inoperable or service is not available; the call center is placed on notice by failure to receive the requisite confirmation.

Summary of mPERS Signaling (also discussed in Detailed Description).

Upon activation or detection of a reportable event, the mPERS (mobile personal emergency response system) shall provide necessary information to the monitoring center to effectively provide needed assistance. “mPERS System” is defined as a stand-alone mobile PERS capable of transmitting all pertinent alarm data directly to the monitoring center, or a mobile PERS linked together with a backend database which relays the pertinent information to the monitoring center. Data communications must use a closed loop or ACK/NAK protocol between the device, backend and/or the monitoring center.

“Pertinent data” shall include the following fields:
a. Account Field: A data field that uniquely identifies the account or customer in need.
b. Alarm Field: A data field or fields that uniquely identify the alarm event or events triggering activation.
c. Last Known Location: Indicates the last known X-Y location.
d. Last Known Location Time: Provides the time stamp of the last known location.
e. Current Location Field: specifies the X-Y location (latitude/longitude) of the device when activated. This may be the same as last known location. If the mobile device is linked to a stationary device at a known location, i.e. customer's home, or specific room in a specific building, the location field may be filled with a keyword to indicate the customer's specific known location.

Data provided to the monitoring center shall be sufficient to give the monitoring center the ability to determine when the reportable event occurred.

Two-Way Voice Communications.

Once the monitoring center receives the signaling information from the mPERS, the monitoring center must have the ability to communicate with the user by voice for compliance with UL 1698.

Determination of Location.

X-Y location shall be determined electronically using methods such as GPS, beacons, cellular, Wi-Fi, etc. and shall be reported as Latitude and Longitude m accordance with UL 1698. In addition, if a user-predefined location is known, the location may be reported as such. For example: HOME. If determinable, more specific locations may be reported such as HOME-KITCHEN or HOME-BASEMENT. Vertical (Z axis) location can be incorporated m accordance with known techniques. Generally, location accuracy is proportional to the number of ascertainable GPS satellites, or cellular towers. Thus, it is an object of this invention to ascertain location in accordance with best known techniques.

### BRIEF DESCRIPTION OF THE DRAWINGS

FIG. 1 Depicts a block diagram in accordance with one embodiment of the present invention.

FIG. 2 Depicts a schematic diagram in accordance with one embodiment of the present invention.

FIG. 3A Depicts a user interacting with the present invention, in one embodiment.

FIG. 3B Depicts a user interacting with the present invention, in one embodiment.

FIG. 3C Depicts a user interacting with the present invention, in one embodiment.

FIG. 3D Depicts a user interacting with the present invention, in one embodiment.

FIG. 4 Depicts a block diagram in accordance with one embodiment of the present invention.

FIG. 5 Depicts a diagramatic representation of the remote device in accordance with one embodiment of the present invention.

FIG. 6 Depicts a diagramatic representation of the remote device in accordance with one embodiment of the present invention.

FIG. 7 Depicts a flow diagram in accordance with one embodiment of the present invention.

FIG. 8 Depicts a flow diagram m accordance with one embodiment of the present invention.

FIG. 9 Depicts a block diagram in accordance with one embodiment of the present invention.

FIG. 10 Depicts current ECS and ECS Pendant environments.

FIG. 11 Depicts LiveCare™ ECS and LiveCare™ ECS Pendant environments.

FIGS. 12A-12F Depict wireless charging base and example accessories.

FIG. 13 Depicts typical problematic architecture.

FIG. 14 Depicts potential problems of connecting peripherical Bluetooth device with multiple hubs in nursing homes and assisted living facilities.

FIG. 15 Depicts interfacing medical devices to the Cloud with the LiveCare™ ECS and LiveCare™ ECS Pendant.

FIG. 16 Depicts LiveCare™ ECS and LiveCare™ ECS Pendants interfacing a wide range of OEM medical sensors and medical devices via multiple Cloud Portals.

FIG. 17 Depicts example devices that interface with the LiveCare™ ECS or LiveCare™ ECS Pendants.

FIG. 18 Depicts LiveCare™ ECS and LiveCare™ ECS Pendant integration with nurse call systems; standard nurse call system and current options.

FIG. 19 Depicts LiveCare™ ECS and LiveCare™ ECS Pendant integration with medical devices and a nurse call system.

FIG. 20 Depicts LiveCare™ ECS Pendant Concept Designs.

FIG. 21 Depicts LiveCare™ ECS Pendant Concept, Skilled & Homecare.

FIG. 22 Depicts LiveCare™ ECS Pendant Concept, Skilled.

FIG. 23 Depicts LiveCare™ ECS Pendant Concept, Homecare.

FIG. 24 Depicts LiveCare™ ECS and LiveCare™ ECS Pendant integration with nurse call systems; standard nurse call system and current options.

FIG. 25 Depicts LiveCare™ ECS Pendant displayed in the orientation while suspended from the neck of the user with a necklace or lanyard.

FIG. 26 Depicts desirable location and height for wearing the LiveCare™ ECS Pendant.

FIG. 27 Depicts undesirable location and height for wearing the LiveCare™ ECS Pendant.

FIG. 28 Depicts a woman wearing graphically simulated LiveCare™ ECS Pendant with necklace.

FIG. 29 Depicts LiveCare™ ECS Pendant displayed in the orientation when held in the hand and operated by the user.

FIG. 30 Depicts an example of a LiveCare ECS-M.

FIG. 31 Depicts integrated biometric sensors and wireless connectivity to a wide range of OEM and LiveCare biometric sensors.

FIG. 32 Depicts integration in assisted living and nurse call systems.

FIG. 33 Depicts integration in assisted living and nurse call systems with wireless connectivity and LiveCare biometric sensors.

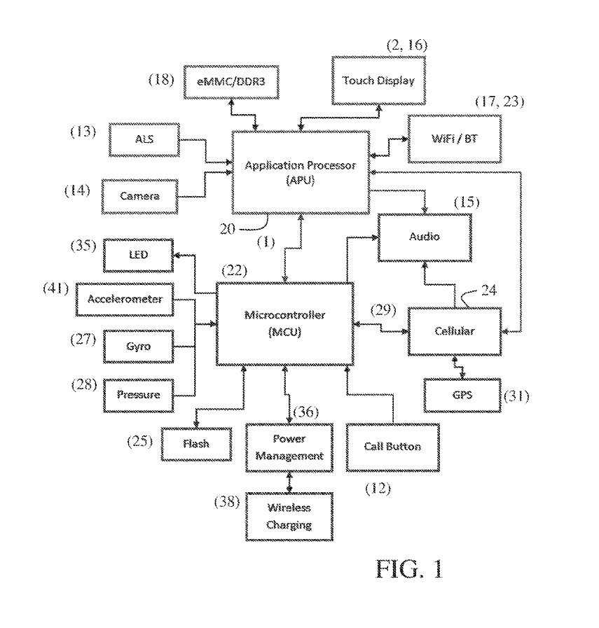

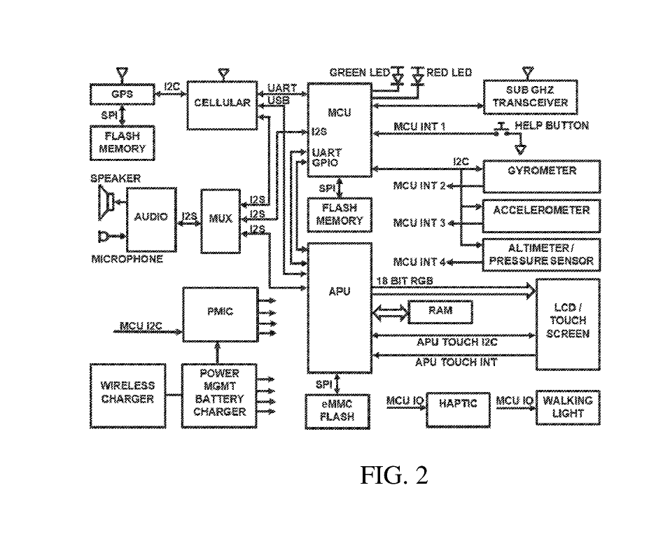

### REFERENCE NUMERALS IN DRAWINGS

The table below lists the reference numerals employed in the figures, and identifies the element designated by each numeral.
1 UART interface between the APU and MCU 1
2 Video display component 2
3 Serial display interface(s) 3
4 General purpose input/output (GPIO) interface(s) 4
5 Inter-integrated circuit (I2C) interface(s) 5
6 Inter-integrated circuit sound (I2S) interface(s) 6
7 MIPI interface(s) 7
8 PWM interface(s) 8
9 SDIO interface(s) 9
10 UART interface(s) 10
11 USE interface(s) 11
12 Call Button (aka hardware button) 12
13 Ambient light sensor (ALS) 13
14 Camera 14
15 Audio Input/Output component
16 LCD Backlight 16
17 WiFi communication module 17
18 Non-Volatile Memory 18
19 Cellular data channel 19
20 Application Processor (APU) 20
21 volatile memory 21
22 Auxiliary Microcontroller (MCU) 22
23 Bluetooth (BT) communication module 23
24 cellular module 24
25 MCU non-volatile memory 25
26 Serial peripheral interface(s) (SPI) 26
27 Gyroscope 27
28 Ambient pressure sensor 28
29 UART interface between the cellular module 24 and MCU 22 29
30 SIM card 30
31 global positioning system (GPS) component 31
32 capacitive touch panel
33 microphone 33
34 speaker 34
35 LED 35
36 Power management integrated circuit component (PMIC) 36
37 battery component 37
38 wireless charging component 38
39 mobile device 39
40 remote device 40
41 Accelerometer component 41
100 dormant mode 100 (flowchart)
101 Pre-determined event occurs 101 (flowchart)
102 Activate touch screen for pre-determined interval 102 (flowchart)
103 Present user with control component 103 (flowchart)
104 confirmation input received from user? 104 (flowchart)
105 Continue wake-up process 105 (flowchart)
106 Dormant mode, monitor interrupts 106 (flowchart)
107 Periodically ascertain and log physical location of device 107 (flowchart)
108 Periodically monitor for at least one communication channel between device and remote location 108 (flowchart)
109 Cause alert conditions locally, and at a remote location, if a communication channel between the device and the remote location ceases to be available 109 (flowchart)
110 Upon the occurrence of the pre-determined event: enabling selective remote operation and/or monitoring of the touch screen, the microphone, the speaker, the camera, or the GPS component 110 (flowchart)

### DETAILED DESCRIPTION

In one embodiment, the operating system is based on Android 6.0.1, having Android Service Managers for application access to GPIO, I2C, and serial ports, and incorporates SELinux Security Policies for GPIO, I2C, and serial ports; Application Processor (APU) 20 comprises a Qualcomm/NXP i.MX6Dual microprocessor; 8 GB of non-volatile data storage is utilized for both program space and application data storage; and a minimum of 2 GB of DDRS class volatile memory is reserved for run-time operation.

UART interface 1 exists between APU 20 and MCU 22, the data communication and protocol thereof being defined and coordinated between the MCU firmware and application software. It is intended that the processors can communicate with each other, and the various peripherals, in various ways, using various buses, in accordance with known techniques.

The following table depicts other interfaces and the various peripherals with which they communicate, in accordance with one embodiment of the invention.

| INTERFACE | PERIPHERAL |
|---|---|
| 18-bit RGB serial (3) | Video display component (2) comprising an |
| | LCD touch display |
| GPIO (4) | Call button (12), individual control and status |
| | lines |
| I2C (5) | Video display component (2) comprising an LCD |
| | touch display, ALS (13), camera (14) control |
| I2S (6) | Audio input/output (15) |
| MIPI (7) | Camera (14) data |
| PWM (8) | LCD backlight (16) |
| SDIO (9) | WiFi (17), non-volatile memory (18) |
| UART (10) | MCU (22), Bluetooth (23), development/debug |
| | console |
| USB (11) | Cellular data channel (19) |

MCU 22 has access to sufficient volatile memory for all runtime use, and sufficient non-volatile memory for program space. MCU 22 is capable of continuously monitoring the activity of all sensors and interrupts with which it interfaces, including detection of “wake up” conditions that require subsequent activity by the MCU or APU and/or their connected peripherals. MCU 22 controls cellular module 24 activities. In one embodiment, MCU 22 comprises cd Qualcomm/NXP Kinetis KL17 microcontroller, and serves as the primary point of power consumption management of the device. In one embodiment, MCU non-volatile memory 25 is intended exclusively for storing configuration information and event logging, and interfaces with the MCU via serial peripheral interface (SPI) 26.

In one embodiment, camera 14 comprises a CCD-based camera that utilizes a dual-lane MIPI interface 7 with APU 20, and has a minimum resolution of 5 megapixels. Ambient light sensor (ALS) 13 is intended for use in controlling the brightness of the Video Display, and interfaces with APU 20 via 12C 5. A 3-axis accelerometer is used tor “wake up on tilt” functions and fall detection algorithms, and interfaces with MCU 22 via I2C 5. In one embodiment, gyroscope 27 comprises a 3-axis MEMS gyroscope intended for use in “wake up on tilt” functions and fall detection algorithms, and interfaces with MCU 22 via 12C 5.

Ambient pressure sensor 28 is intended for use in altitude measurement, and interfaces with MCU 22 via I2C 5. In one embodiment, WiFi communication module 17 is 802.11a/b/g/n compliant, and utilizes and accesses APU 20 via SDIO interface 9, and Bluetooth (BT) communication module 23 comprises a BT 4.0+EDR communication module, interfaces with APU 20 via UART 1, and is integral to the WiFi module. Cellular communication module 24 is operatively connected to SIM card 30, is capable of “3G” communication, and interfaces MCU 22 via UART 29 as the primary control channel; Cellular communication module 24 interfaces APU 20 via USB as a data channel rather than the primary control channel for the cellular module. Cellular communication module 24 interfaces with global positioning system (GPS) component 31, working in conjunction with the Global Navigation Satellite System (GNSS).

In one embodiment, video display component 2 comprises a 2.8″ (diagonal) class LCD video display having a minimum resolution of 240×320 pixels, with an 18-bit RGB video interface with APU 20; capacitive touch panel 32 is overlaid on video display component 2, the combination generally referred to herein as “touch screen”. In one embodiment, call button 12 is the only hardware button externally accessible to the device user.

Audio input/output component 15 is operatively connected to microphone 33 and speaker 34, all of which are minimally capable of voice quality audio. In one embodiment, microphone 33 comprises a MEMS microphone. Audio input/output component 15 is controllable by MCU 22, and is switchable between application input/output, microcontroller input/output, Bluetooth module input/output, and cellular module input/output, all via I2S 6.

In one embodiment, a multi-color light emitting diode (LED) 35 is used communicate to the user the status of the device in various conditions. In other embodiments, multiple LEDs are used (e.g. one red and one green, or red, green, and blue). LEDs interface MCU 22 via PWM communication components.

In one embodiment, power management integrated circuit component (PMIC) 36 comprises a single-chip PMIC, the configuration of which shall be performed MCU 22; PMIC 36 interfaces MCU 22 via an I2C interface; PMIC 36 controls the order of power-up for APU 20 and all peripherals; power-up occurs following initial power-up of the device or following an indication from the MCU to wake up any portion of the device; battery component 37 comprises a rechargeable 1700 mAh lithium-based battery, charged via wireless charging component 38; a “gas gauge” function capable of determining the charge state of the battery, interfaces MCU 22 via an I2C interface.

### Pendant Idle (Aka “Dormant”, “Low Power”) Mode

In one embodiment, mobile device 39 (aka pendant) is suspended from the neck of the user by a lanyard. In the idle mode, the LCD is turned off and the processor(s) (MCU 22 in one embodiment) is/are in a low power mode. Cellular module 24 periodically pings the local cell towers, verifies if cellular service is available, and wakes up MCU 22 to provide a visual indication via a flashing LED (green in one embodiment) that cell service is available. A low current bi-color LED is flashed once per second (time interval is programmable) to conserve battery power. The bi-color LED flashes red when cellular service is not available (see “mPERS Signaling” and the proposed UL1698 guidelines). GPS component 31 periodically stores the user's current location in accordance with the proposed ULI698 guidelines (see “mPERS Signaling” and the proposed UL1698 guidelines).

Accelerometer component 41 interrupts MCU 22 if a pre-determined and/or programmable acceleration threshold is exceeded. MCU 22 wakes up and performs a fall detection assessment to determine if the user has fallen. If a fall has been detected, the MCU logs the event and initiates an emergency call to monitoring center 40 (see “mPERS Signaling”). If a fall has not been detected, the MCU logs the event and performs a shake assessment to determine if the user shook the pendant to wake up the device (aka initiate smart pendant operation). Otherwise, the MCU logs the event and returns to a low power mode. MCU 22 is interrupted if a double tap has been detected. The MCU logs the event and interrupts APU 20 to turn on the LCD and touchscreen for smart pendant operation.

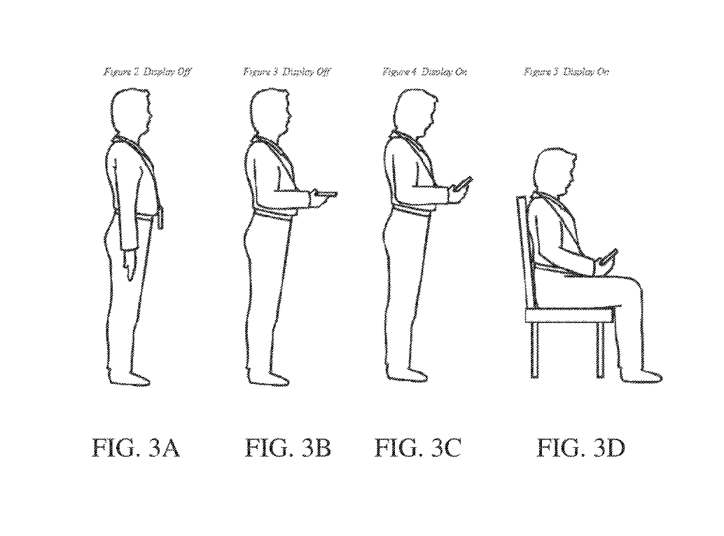

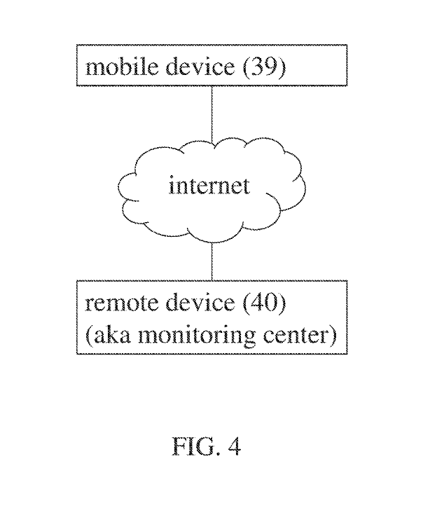

Gyroscope 27 interrupts the MCU if a pre-established tilt angle or orientation threshold is exceeded (e.g. FIGS. 3A through 3D). MCU 22 wakes up and performs a pendant orientation assessment to determine if the pendant has been positioned for using smart pendant operation (aka “active mode”). If the pendant has been positioned for small pendant operation, the MCU logs the event and interrupts APU 20 to turn on the LCD and Touchscreen for smart pendant operation. Otherwise, the MCU logs the event and returns to a low power mode.

Depressing call button 12 interrupts MCU 22 to wake up and perform an algorithm to debounce the Call Button signal in accordance with known techniques. If a Call Button push has been validated, the MCU logs the event and initiates mPERS signaling as discussed herein. Otherwise the MCU logs the event and returns to the low power mode.

### Pendant Orientation Assessment

Generally, pendant orientation assessment comprises detecting if the device is moved from a dormant mode to an active mode. In one embodiment, the active mode comprises being visible to a user positioned between a substantially standing position through a substantially siting position; the dormant mode comprising the device not being in the active mode. In one embodiment, the dormant mode comprises the device is not being held by the user, and the active mode comprises the device not being in the dormant mode.

In one embodiment, the active mode comprises the touch screen being oriented in the range of: a relatively >0 degree horizontal position (the touch screen facing upwardly and slightly towards the user), through a substantially 135 degree position (the touch screen facing slightly downwardly and towards the user; the dormant mode comprises the touch screen being oriented in the range of: a substantially >135 degree position, through a relatively 180 degree horizontal position (the touch screen facing downwardly towards the floor), through a relatively 270 degree vertical position (the touch screen facing away from the user), to a relatively 360 degree horizontal position (the touch screen facing upwardly towards the ceiling).

It should be noted that in some embodiments, the touch screen being positioned so as to be viewable by the user contemplates the user not lying in bed. Alternatively, a user-sleep mode (i.e. distinguished from a device sleep mode) can be invoked by the user wherein the device “wakes up” (the touch screen is activated) upon movement.

In the sleep mode, it is contemplated that the device is placed within arms-reach of a user lying in bed and is activated if the user grabs the device. Thus, the device might be relatively horizontal and downwardly facing as the user is lying in bed holding the device above them.

### Smart Pendant Operation

As depicted in E7ig. 7, the device is maintained in a dormant mode 100 until a pre-determined event 101 occurs; upon the occurrence of the pre-determined event, the touch screen is temporarily activated 102 for a pre-determined interval; the touch screen is deactivated and the device resumes the dormant mode after the pre-determined interval unless a confirmation input is received from a user 104, in which case the wake up process is continued 105; the confirmation input received from the user comprises presenting the user with a control component 103 whereby the user confirms the pre-determined event has occurred. In one embodiment, the control component is a hardware button. In another embodiment, the control component is a software button.

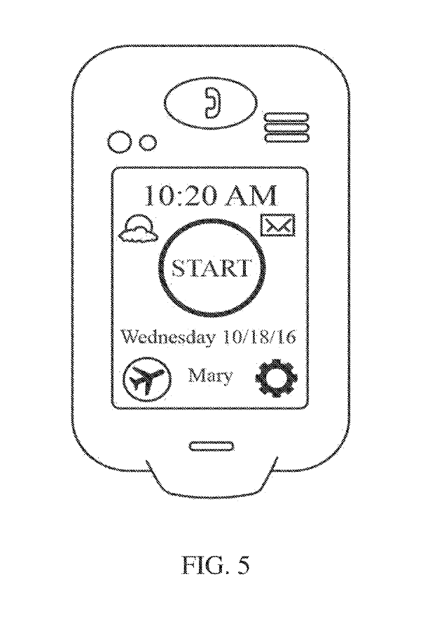

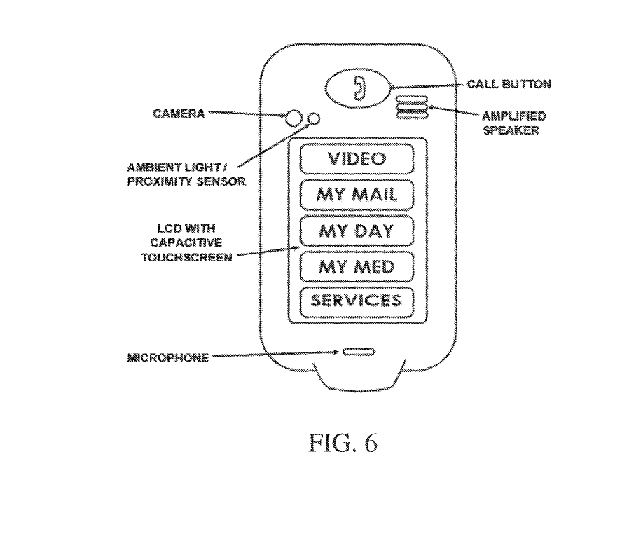

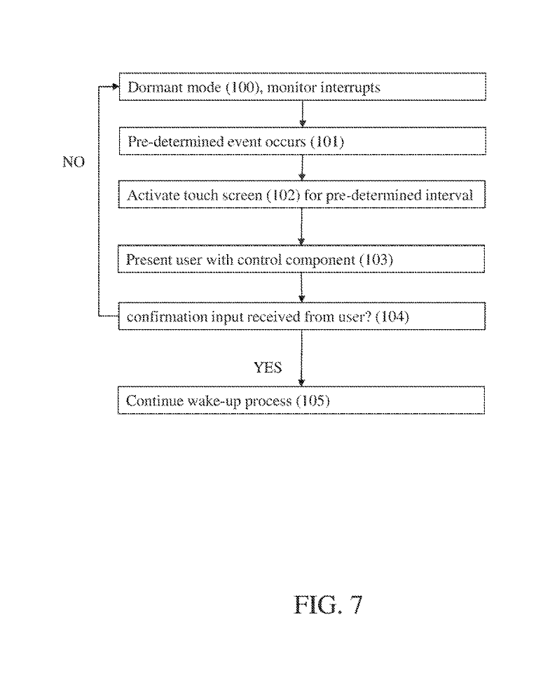

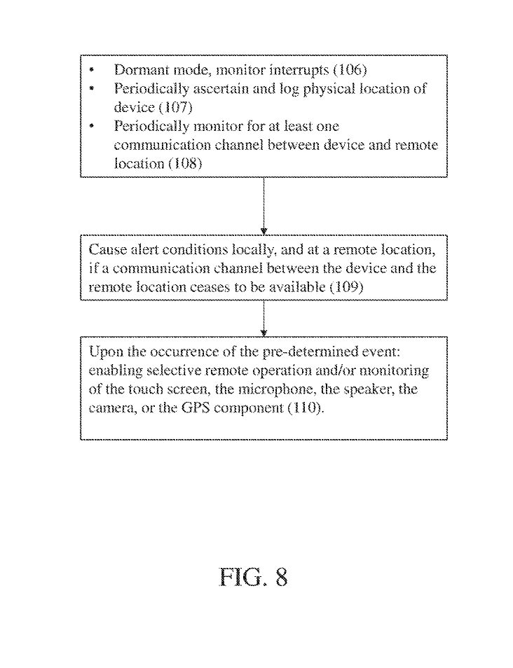

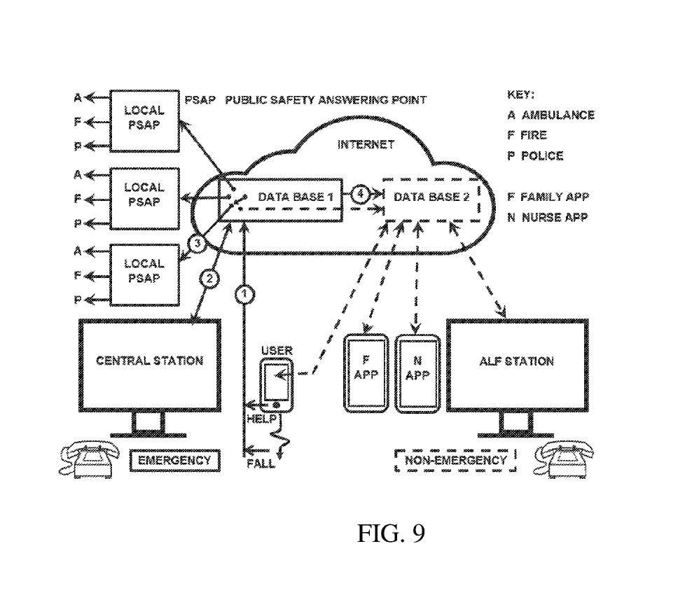

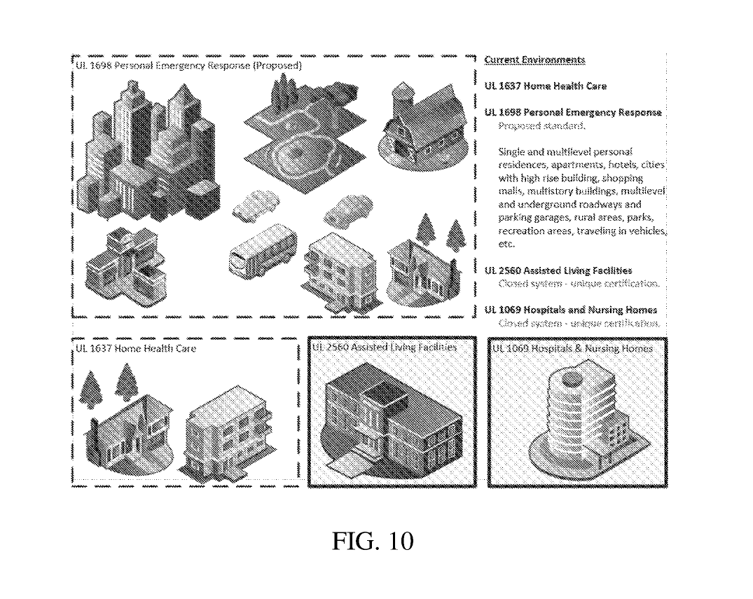

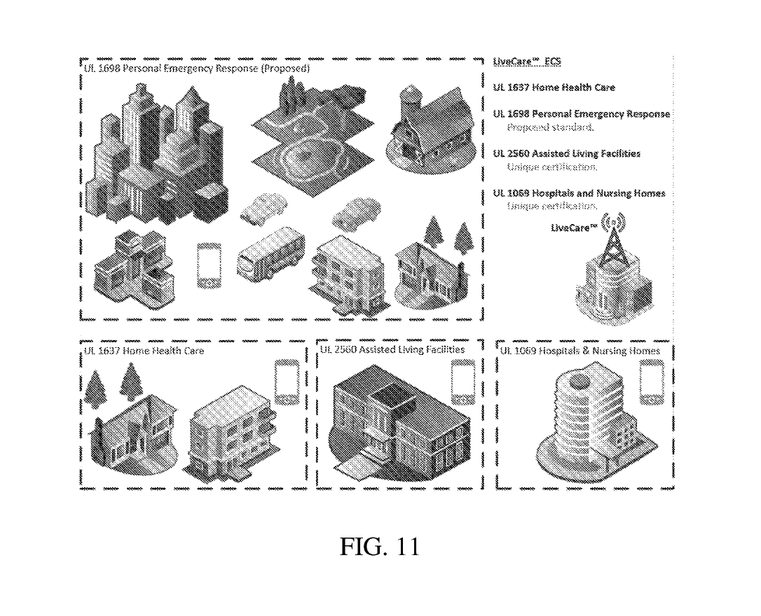

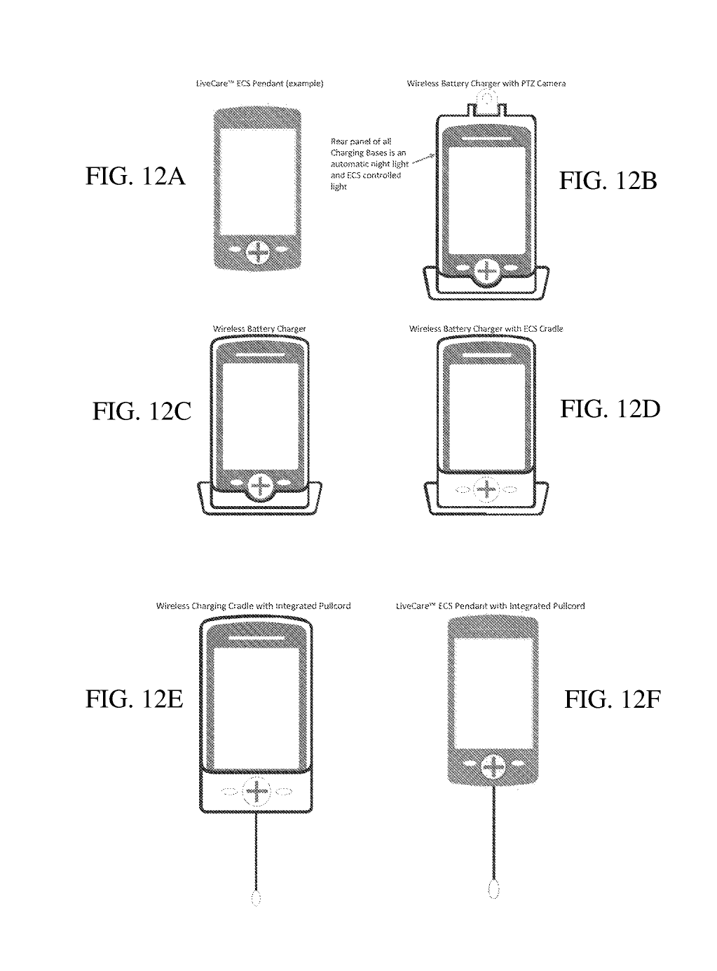

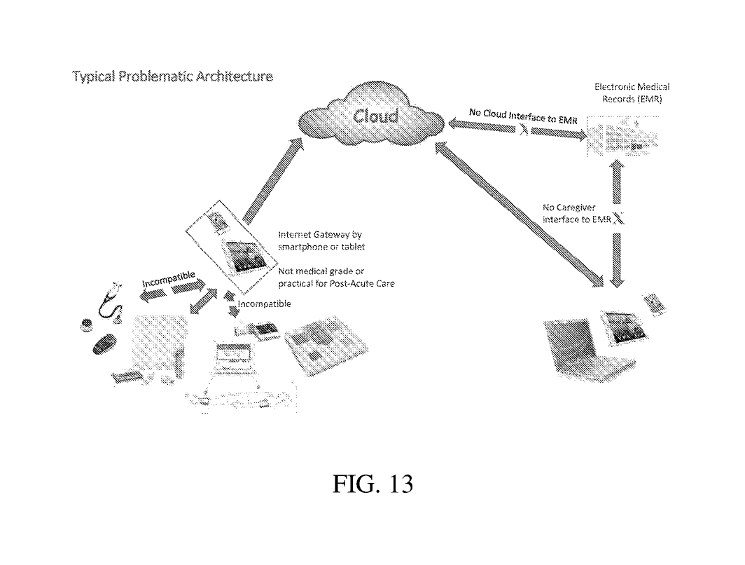

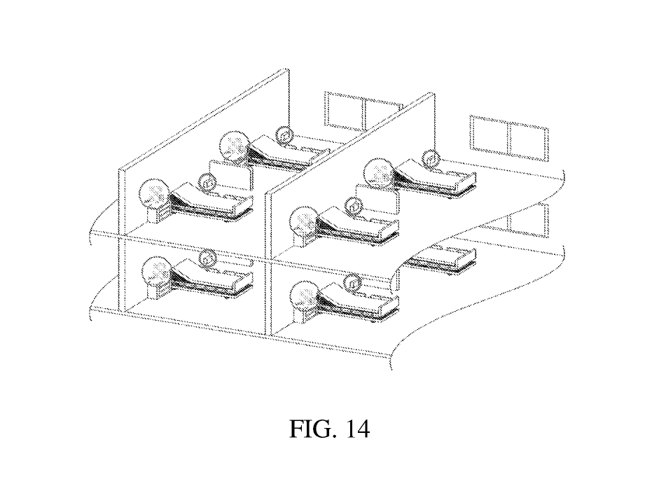

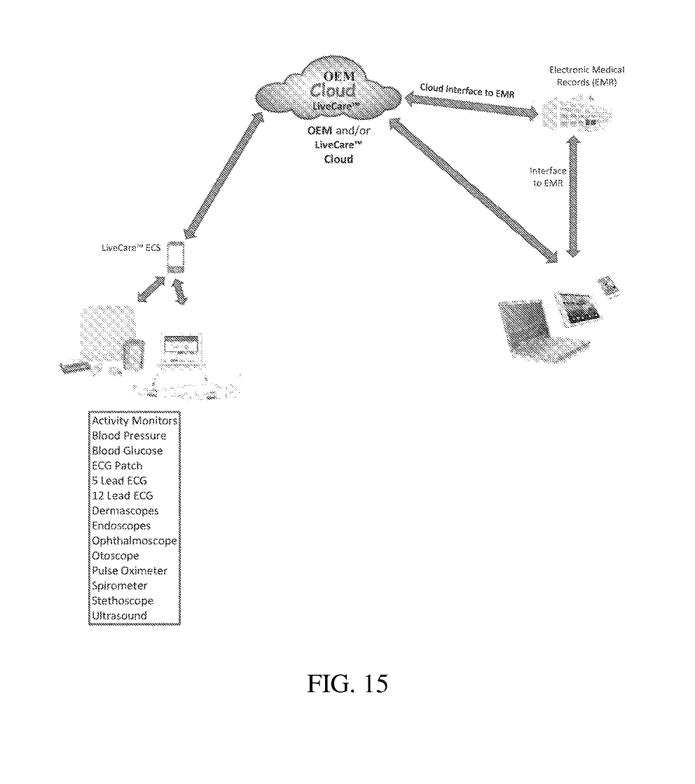

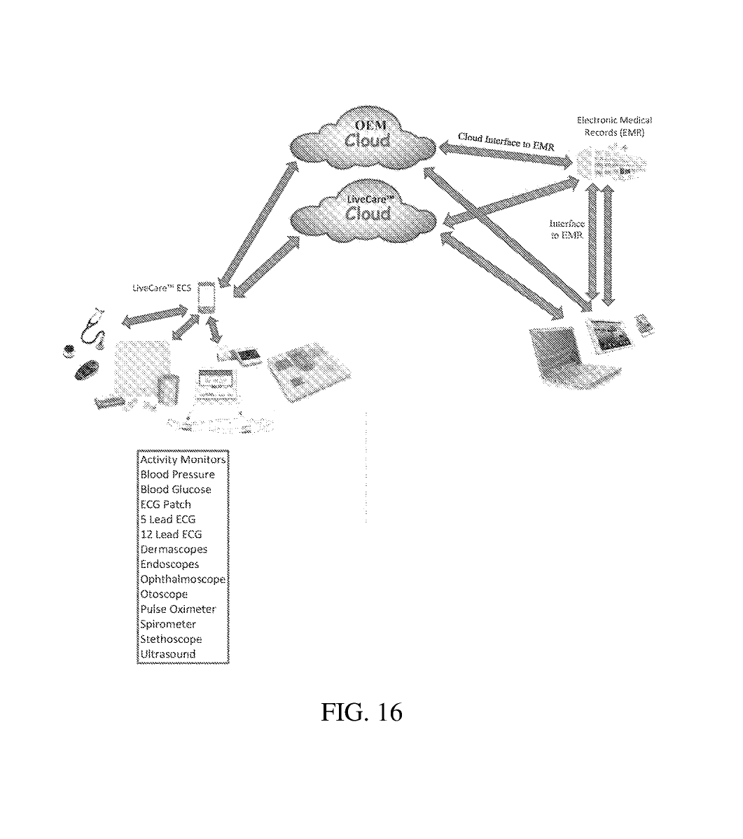

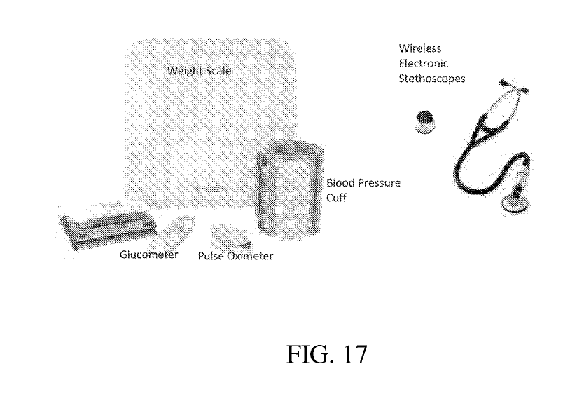

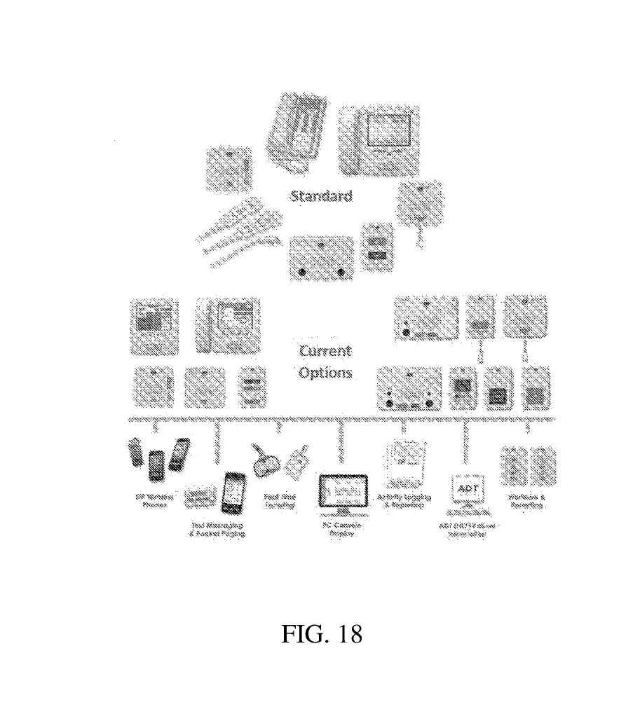

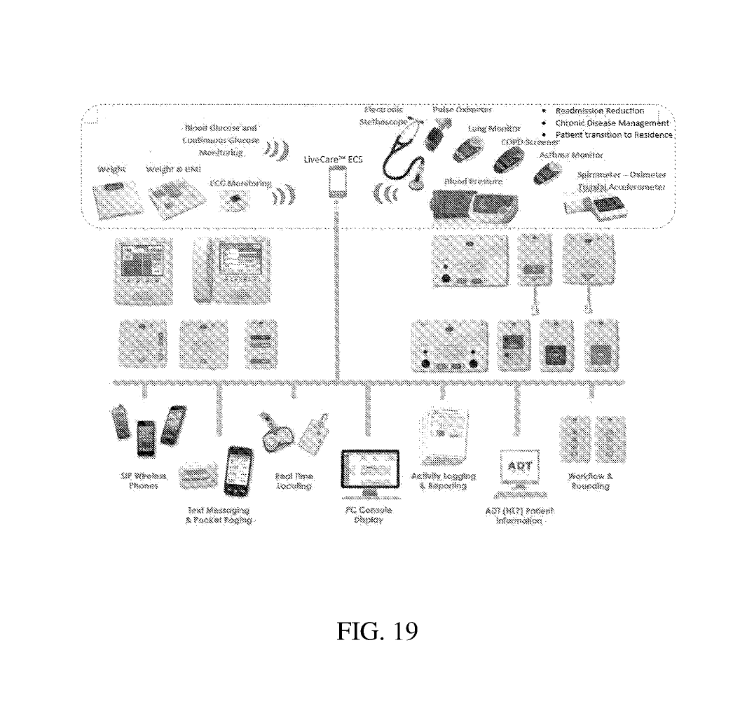

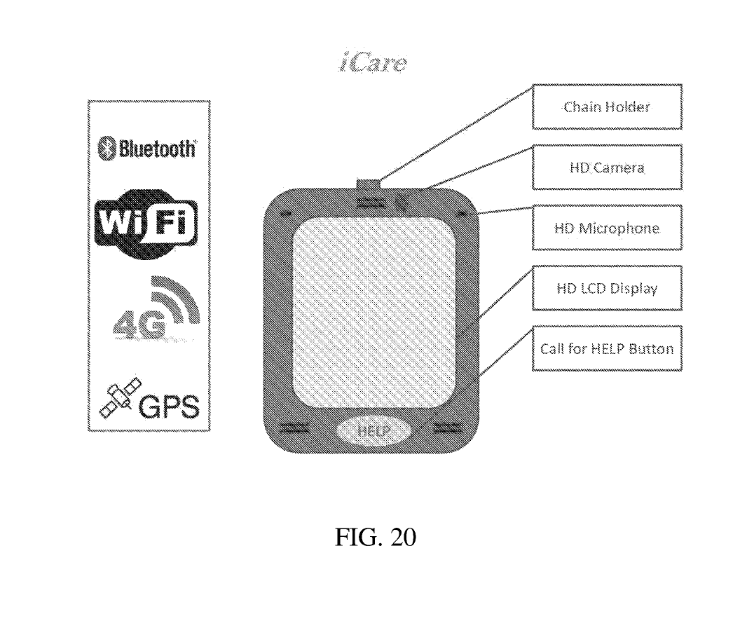

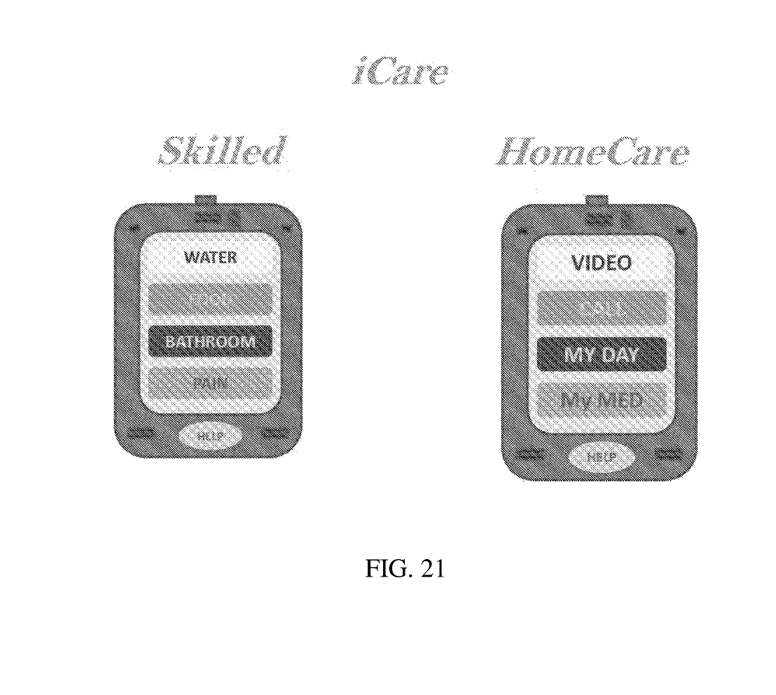

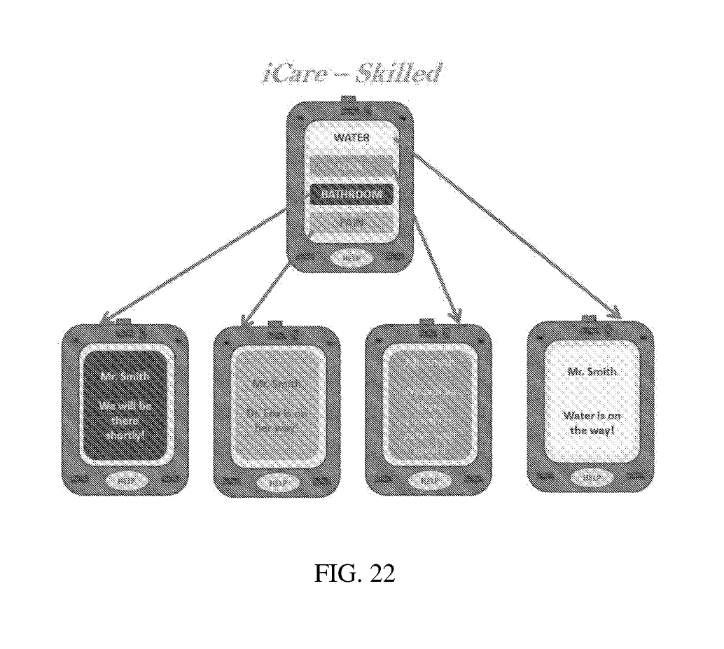

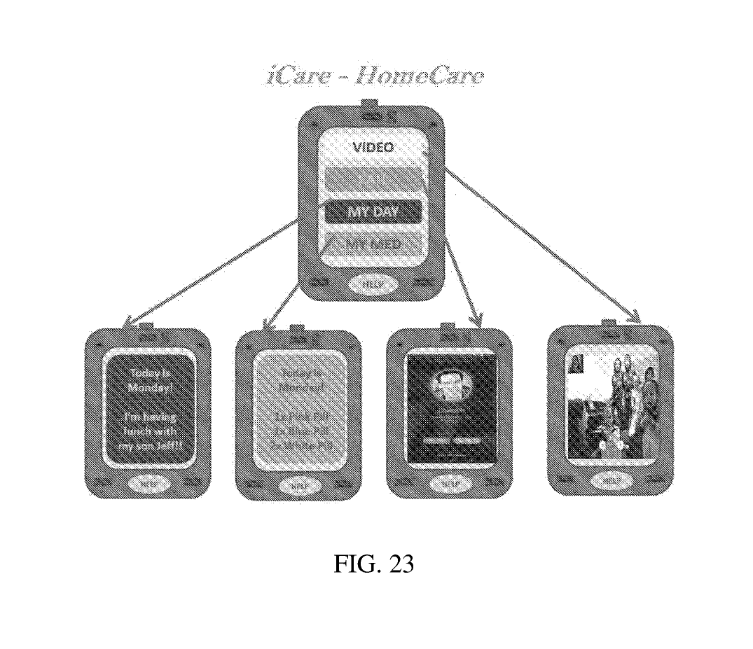

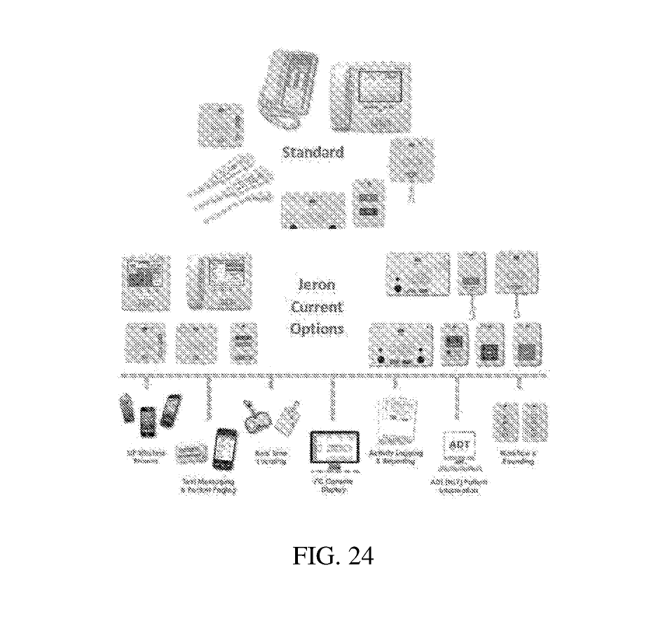

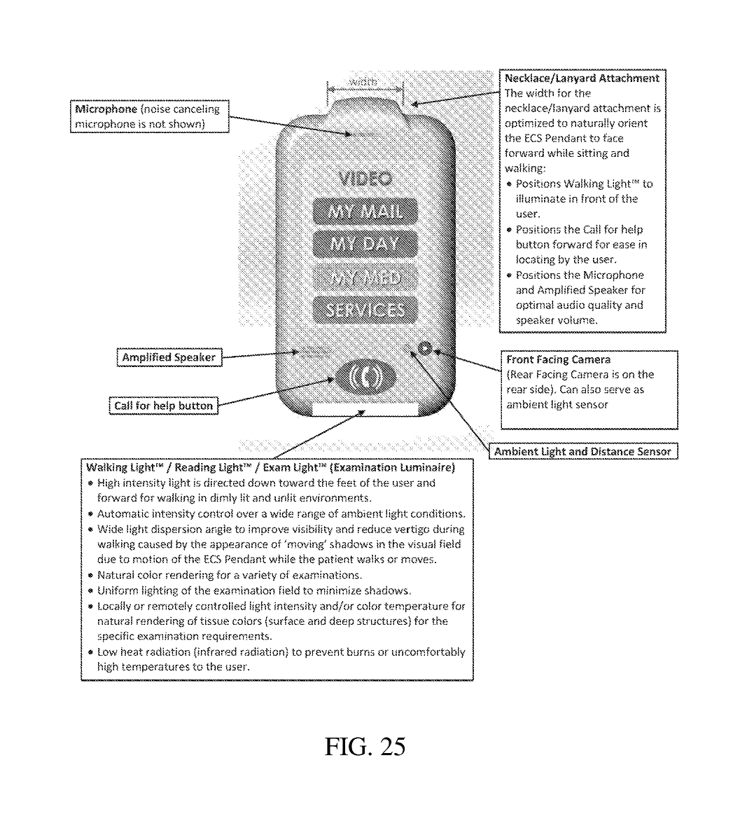

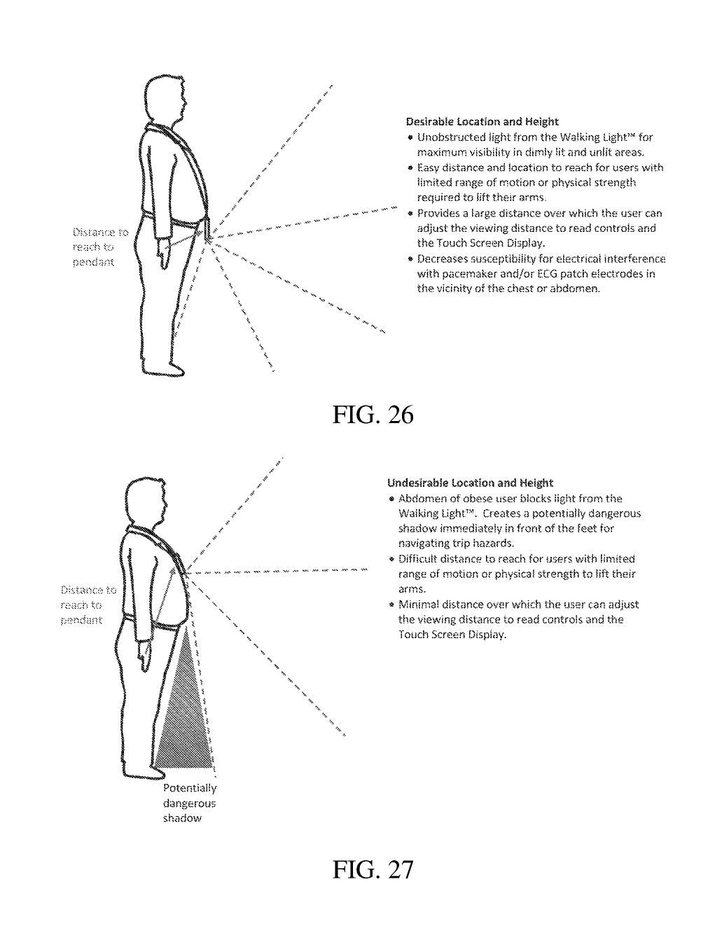

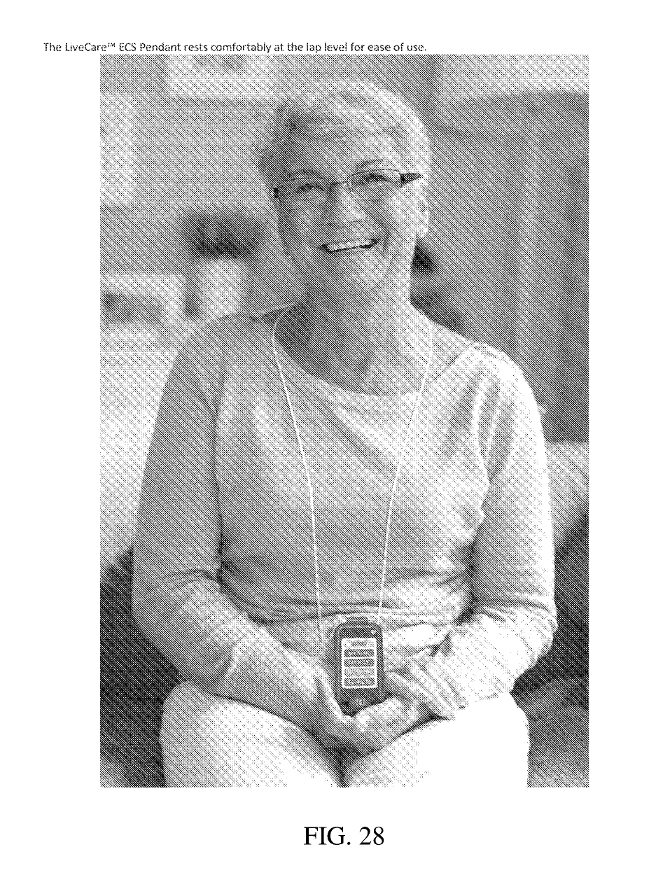

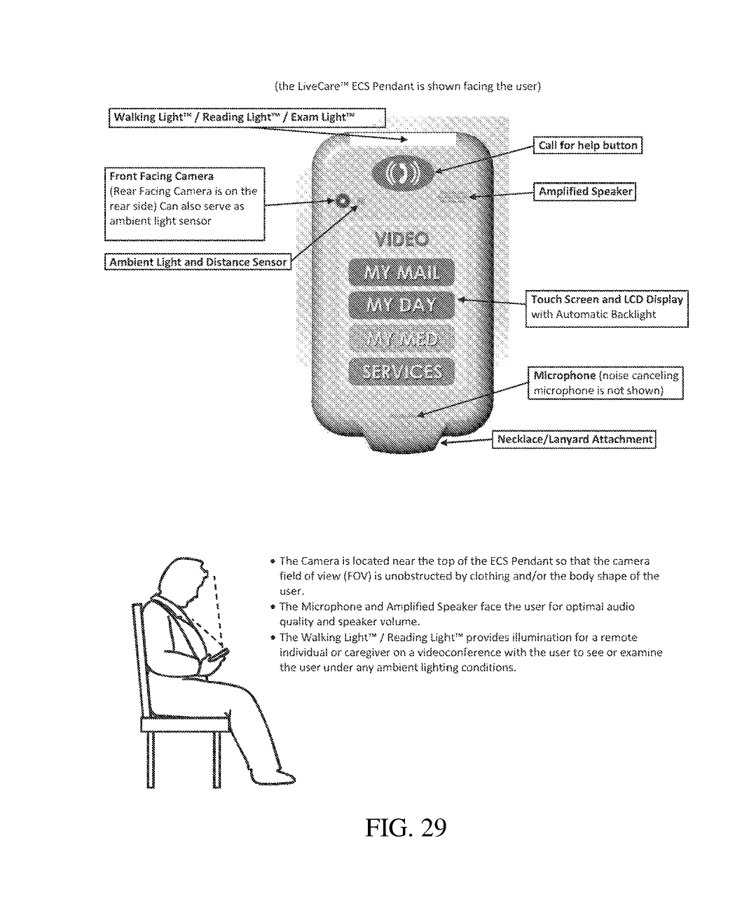

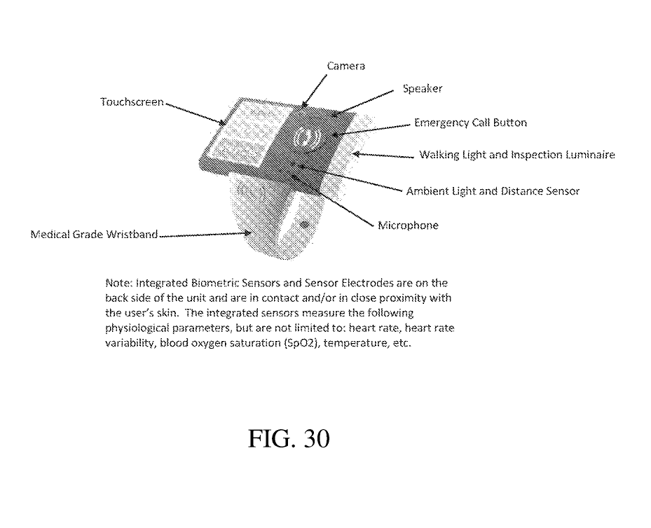

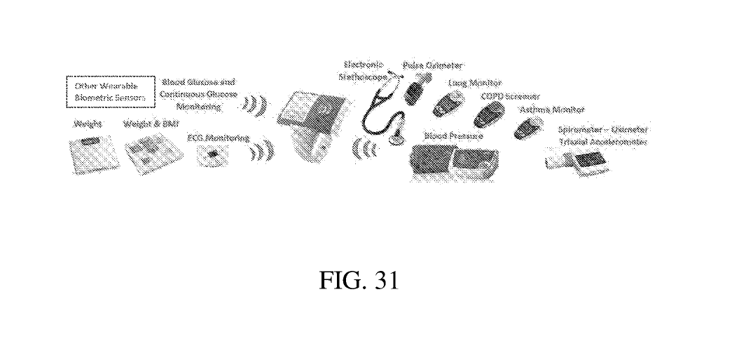

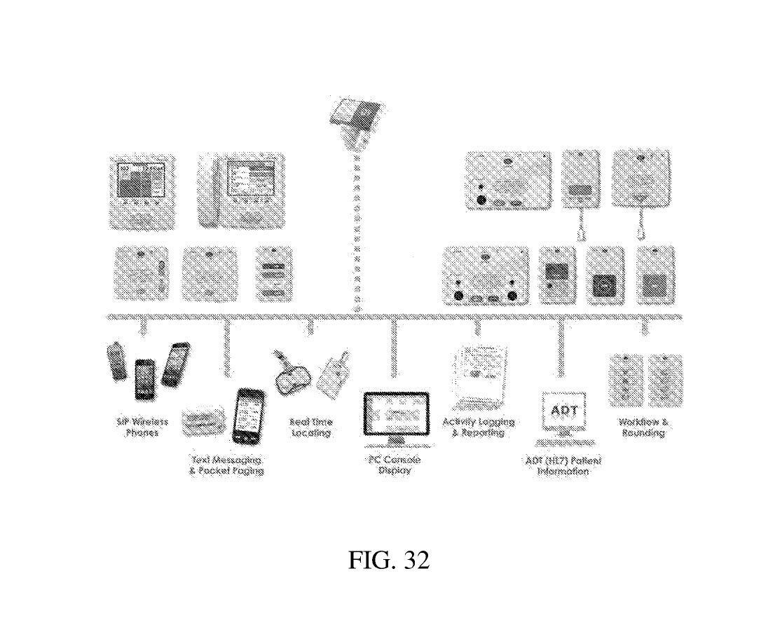

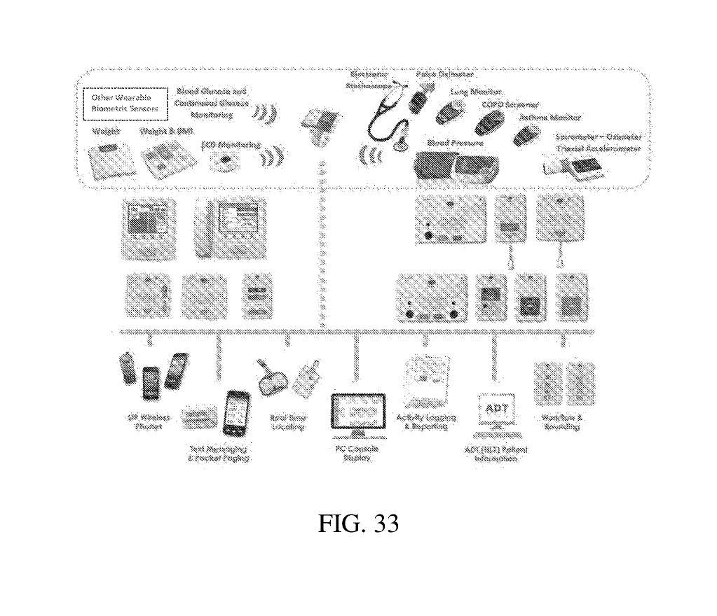

In one embodiment, upon detection of a pre-determined event as described herein, (e.g. the device being shaken, the touch screen being positioned so as to be viewable by the user, fall detection, touch screen double tapped by the user, control button pushed by the user), a high contrast “Start Screen” (e.g. FIG. 5) is displayed for 10 seconds (this interval being programmable). If the user does not touch the “Start” button the LCD turns off and the MCU and APU return to low power modes to conserve battery life. All features of the Stall Screen are programmable to customize or unclutter the display.

It should be noted that in some embodiments, a fall detection event does not require user authentication/confirmation; the advantage being that an unconscious user will not be able to confirm the event. Additionally, some embodiments contemplate the control button being pushed in a panic state of mind which does not necessitate authentication. Otherwise, the start screen is only displayed for a brief time to allow the user to decide if they want to use the smart pendant features. This prevents the processors and LCD display from staying on for a prolonged time, thereby draining the battery (e.g. if the display is unintentionally turned on while moving, sitting or lying down, etc).

The brief interval can be utilized by the user to quickly check: the time of day, if messages are waiting, the day of the week, date, current local weather outside, the user's name (also for mentally challenged users), engaging active mode to interact with the settings menu, changing the contrast to a “light” mode to provide a LCD brightness level flashlight or reading light.

In one embodiment, an “airplane mode” can be activated. In one embodiment, any of the screen icons can be hidden or deactivated to prevent accidental use.

mPERS Signaling

If a fall has been detected, or the user presses call button 12, (some embodiment require authentication while others do not) MCU 22 initiates mPERS (mobile personal emergency response system) signaling comprising:

1. MCU 22 logs the time and type of event (fall detected or user pressed the Call Button).

2. MCU 22 signals the monitoring center backend servers via the cellular module with the following:
a. Account Field: a data, field that uniquely identifies the account or customer in need.
b. Alarm Field: a data field or fields that uniquely identify the alarm event or events triggering activation.
c. Last Known GPS Location: indicates the last known GPS latitude/longitude (X-Y) location.
Note: for all of the GPS locations, the location may be the cell tower CELL-LOCATE location from the cellular tower(s) if the GPS location was not available. Location data obtained from CELL-LOCATE services must be identified due to the inherent inaccuracy of the data.
d. Last Known GPS Location Time: provides the time stamp of the last known GPS location.
e. Current GPS Location Field: specifies the X-Y location of the device when activated. This may be the same as Last Known Location.
f. The MCU vibrates the pendant and plays a prerecorded tone and audio message that a call for help is in progress.

3. The monitoring center backend server must communicate an acknowledgment and timestamp that the data was received.

4. The MCU logs the acknowledgement received from the monitoring center backend server, plays a prerecorded audio message that help is on the way and/or a two-way audio call will be initiated.

5. The MCU initiates a two-way audio call with the monitoring center.

6. If the monitoring center server does not acknowledge the MCU signaling within a programmable time limit the MCU will attempt to retransmit the request. If the MCU retransmitted request is not acknowledged by the monitoring center server, the MCU will enter a prescribed fallback signaling mode (with consideration for Wi-Fi signaling). Similarly, if the two-way audio call is not completed, the MCU wall enter a prescribed fallback two-way audio calling mode (with consideration tor a two-way audio call via Wi-Fi. Also see “Two-Way Voice Communications”, herein).

In one embodiment, a portable and wearable device comprises: touch screen 2; microphone 33; speaker 34; camera 14; hardware button 12; GPS component 31; and processing and memory sufficient to perform the steps of: maintaining the device in a dormant mode until a pre-determined event occurs 106: while in the dormant mode: periodically ascertaining and logging the physical location of the device 107: periodically monitoring for at least one communication channel between device and remote location 108, and causing alert conditions locally (e.g. LED flashes, screen icon appears, sound vibration), and at a remote location (personnel are alerted and protocol initiated to contact user), if a communication channel (e.g. wifi, cellular, RF) between the device and the remote location ceases to be available during a pre-established periodic interval 109; upon the occurrence of the pre-determined event: enabling selective remote operation (cause noise, vibration, flashing LED or screen, audio annunciation) and/or monitoring (remote person looks through camera, listens from microphone) of the touch screen, the microphone, the speaker, the camera, or the GPS component 110.

What is claimed is:

1. A portable and wearable device comprising:
a touch screen; a microphone; a speaker; a camera; a hardware button; a GPS component;
and processing and memory sufficient to perform the steps of:
maintaining the device in a dormant mode until a pre-determined event occurs;
while in the dormant mode:
periodically ascertaining and logging the physical location of the device;
and causing alert conditions locally, and at a remote location, if a communication channel between the device and the remote location ceases to be available during a pre-established periodic interval;
upon the occurrence of the pre-determined event:
enabling selective remote operation and/or monitoring of the touch screen, the microphone, the speaker, the camera, or the GPS component.

2. The device of claim 1 further comprising:
the touch screen brightness being remotely controllable by another besides the user.

3. The device of claim 1 further comprising:
the touch screen having icons or control components that can be remotely acted upon by another besides the user.

4. The device of claim 3 further comprising:
the touch screen having icons or control components that can be remotely acted upon by another besides the user further comprising:
temporarily enlarging the size of the icon.

5. The device of claim 3 further comprising:
the touch screen having icons or control components that can be remotely acted upon by another besides the user further comprising:
temporarily amplifying the brightness of the icon.

6. The device of claim 1 further comprising:
the microphone being remotely controllable by another besides the user.

7. The device of claim 6 further comprising:
the microphone being remotely controllable by another besides the user further comprising:
adjusting the gain, filtering, compression, and noise reduction.

8. The device of claim 1 further comprising:
the speaker being remotely controllable by another besides the user.

9. The device of claim 8 further comprising:
the speaker being remotely controllable by another besides the user further comprising:
adjusting the equalization, filtering, compression, and noise reduction.

10. The device of claim 1 further comprising:
the upon the occurrence of the pre-determined event further comprising:
temporarily activating the touch screen for a pre-determined interval;
resuming the dormant mode after the pre-determined interval unless a confirmation input is received from the user.

11. The device of claim 10 further comprising:
the confirmation input received from the user further comprising:
presenting the user with a control component whereby the user confirms the pre-determined event has occurred.

12. The device of claim 11 further comprising:
the control component being the hardware button.

13. The device of claim 11 further comprising:
the control component being a software button.

14. The device of claim 1 further comprising:
the pre-determined event comprising:
the device being shaken.

15. The device of claim 1 further comprising:
the pre-determined event comprising:
fall detection.

16. The device of claim 1 further comprising:
the pre-determined event comprising:
the touch screen double tapped by the user.

17. The device of claim 1 further comprising:
the pre-determined event comprising:
the hardware button pushed by the user.

18. The device of claim 1 further comprising:
the pre-determined event comprising:
the touch screen being positioned so as to be viewable by the user.

19. The device of claim 18 further comprising:
the touch screen being positioned so as to be viewable by the user further comprising:
activating the touch screen when the device is moved from the dormant mode to an active mode.

20. The device of claim 19 further comprising:
the active mode comprising the touch screen being visible to a user positioned between a substantially standing position through a substantially siting position;
the dormant mode comprising the device not being in the active mode.

21. The device of claim 19 further comprising:
the dormant mode comprising the device is not being held by the user;

22. The device of claim 19 further comprising:
the active mode comprising the device not being in the dormant mode.
the active mode comprising the touch screen being oriented in the range of:
a relatively >0 degree horizontal position (the touch screen facing upwardly and slightly towards the user); through a substantially degree position (the touch screen facing slightly downwardly and towards the user;
the dormant mode comprising the touch screen being oriented in the range of:
substantially >135 degree position, through a relatively 180 degree horizontal position (the touch screen facing downwardly towards the floor); through a relatively 270 degree vertical position (the touch screen facing away from the user); to a relatively 360 degree horizontal position (the touch screen facing upwardly towards the ceiling).
